(19) United States
(12) Patent Application Publication
(10) Pub. No.: US 2012/0027647 A1
(43) Pub. Date: Feb. 2, 2012

(54) Stimulus indicator employing stimulus sensitive metals and gels

(76) Inventors: Rel S. Ambrozy, Arlington, VA (US); Jade Litcher, Raleigh, NC (US); Raymond C. Jones, Leesburg, VA (US); Chao Zhu, Denville, NJ (US); Bani H. Cipriano, Vernon, NJ (US); Srinivasa R. Raghavan, Silver Spring, MD (US); Jae-Ho Lee, Germantown, MD (US)

(21) Appl. No.: 12/801,637

(22) Filed: Jun. 17, 2010

Related U.S. Application Data
(63) Continuation-in-part of application No. 12/042,528, filed on Mar. 5, 2008.
Application No. 12/042,528 is a continuation-in-part of application No. 11/954,520, filed on Dec. 12, 2007.
Application No. 11/954,520 is a continuation-in-part of application No. 11/580,241, filed on Oct. 13, 2006, now Pat. No. 8,077,554.
Application No. 11/580,241 is a continuation-in-part of application No. 11/486,969, filed on Jul. 14, 2006, now Pat. No. 7,940,605.
Application No. 11/486,969 is a continuation-in-part of application No. 11/414,254, filed on May 1, 2006.
(60) Provisional application No. 61/213,547, filed on Jun. 18, 2009.
(60) Provisional application No. 60/904,881, filed on Mar. 5, 2007.
(60) Provisional application No. 60/874,248, filed on Dec. 12, 2006.
(60) Provisional application No. 60/725,648, filed on Oct. 13, 2005.
(60) Provisional application No. 60/725,649, filed on Oct. 13, 2005.
(60) Provisional application No. 60/698,984, filed on Jul. 14, 2005.
(60) Provisional application No. 60/675,882, filed on Apr. 29, 2005.

(51) Int. Cl. G01N 21/78

(52) U.S. Cl. 422/401

(57) ABSTRACT

The present invention relates, for example, to a stimulus-indicating device. More particularly, the present invention includes an apparatus for evidencing when a stimulus sensitive product has been exposed to a designated or predetermined stimulus for a certain period of time, and the invention further may include a method for manufacturing aspects of that apparatus.

### RELATED APPLICATIONS

This application is related to and claims the benefit under 35 U.S.C. §119, of U.S. provisional patent application Ser. No. 61/213,547 filed Jun. 18, 2009, which is hereby incorporated by reference in its entirety; and

This application is a continuation-in-part and claims the benefit under 35 U.S.C. §120, of U.S. patent application Ser. No. 12/042,528 filed Mar. 5, 2008, entitled “Stimulus Indicating Device Employing Polymer Gels” which is related to and claims the benefit under 35 U.S.C. §119, of U.S. provisional patent application Ser. No. 60/904,881 filed Mar. 5, 2007, which is hereby incorporated by reference in its entirety; and

this application is a continuation-in-part and claims the benefit under 35 U.S.C. §120, of U.S. patent application Ser. No. 11/954,520 filed Dec. 12, 2007, entitled “Stimulus Indicating Device Employing Polymer Gels” which is related to and claims the benefit under 35 U.S.C. §119, of U.S. provisional patent application Ser. No. 60/874,248 filed Dec. 12, 2006, which is hereby incorporated by reference in its entirety; and

this application is a continuation-in-part and claims the benefit under 35 U.S.C. §120, of U.S. patent application Ser. No. 11/580,241 filed Oct. 13, 2006, entitled “Stimulus Indicating Device Employing Polymer Gels” which is related to and claims the benefit under 35 U.S.C. §119, of both U.S. provisional patent application Ser. No. 60/725,648, and U.S. provisional patent application serial number 60/725,649, both filed Oct. 13, 2005, which are all hereby incorporated by reference in their entirety; and

this application is a continuation-in-part, and claims the benefit under 35 U.S.C. §120, of U.S. patent application Ser. No. 11/486,969, filed Jul. 14, 2006, entitled “Stimulus Indicating Device Employing Polymer Gels” which is related to and claims the benefit under 35 U.S.C. §119, of U.S. provisional patent application Ser. No. 60/698,984, filed Jul. 14, 2005, which are all hereby incorporated by reference in their entirety; and

this application is a continuation-in-part, and claims the benefit under 35 U.S.C. §120, of U.S. patent application Ser. No. 11/414,254, filed May1, 2006, entitled “Stimulus Indicating Device Employing Polymer Gels,” which is related to and claims the benefit under 35 U.S.C. §119, of U.S. provisional patent application No. 60/675,882, filed Apr. 29, 2005, which are all hereby incorporated by reference in their entirety.

### FIELD OF THE INVENTION

The present invention relates to a stimulus-indicating device. More particularly, the present invention relates to an apparatus for evidencing when a stimulus sensitive product has been exposed to a designated or predetermined stimulus for a certain period of time, and the invention relates to a method for manufacturing aspects of that apparatus.

### RELATED PRIOR ART

It is well known in the art that the useful life of a perishable product is a function of its cumulative exposure to a harmful stimulus over a period of time. The types of stimuli that advance the degradation of stimulus-sensitive products over time include not only temperature, but also light, pH, humidity, electromagnetic radiation, visible light, radiation, solvent composition, ionic strength, etc.

The useful life of a temperature sensitive product is a function of its cumulative time-temperature exposure—a combination of the temperature to which a product is exposed and the duration of the exposure. For stimulus sensitive products, degradation generally occurs faster at a higher stimulus (i.e., temperature) that at lower stimulus (i.e., temperature). For example, often a temperature-perishable product will typically have a longer useful life if it is exposed to lower temperatures than if it is exposed to higher temperatures. In particular, pre-packaged chicken will spoil if it is exposed to a temperature of 40-41° F. or above for an extended period of time. However, exposure to high temperatures is not always the cause of the problem because certain stimulus sensitive products will degrade sooner at a lower stimulus (especially freezing temperatures) than at a higher stimulus. For example, a malaria vaccine will degrade faster below 2° C. than if stored in the range of 3° C. to 7° C. Thus the rate of degradation is often stimulus and product specific.

Stimulus perishable products susceptible to degradation due to cumulative time-stimulus exposure include, but are not limited to, food, food additives, chemicals, biological materials, drugs, cosmetics, photographic supplies and vaccines. Many manufacturers mark their products with printed expiration dates in an attempt to provide an indication of when the useful life of a perishable product lapses. These dates, however, are only estimates and may be unreliable because they are based on assumptions about the stimulus history of the product that may not be true with respect to the particular unit or product in the package on which the expiration date appears. Specifically, manufacturers compute expiration dates by assuming that the product will be kept within a specified stimulus range during the product's useful life. The manufacturer cannot always predict or control, however, the stimulus exposure of a product through each step of the supply chain that delivers the product to the consumer. If the product is actually exposed to stimulus higher than those on which the expiration date is based, the perishable product may degrade or spoil before the printed expiration date. When this happens, the expiration date may mislead the consumer into believing that the perishable product is still usable when, in fact, its useful life has lapsed.

Marking a stimulus sensitive product with an expiration date is useful nonetheless, because often a visual inspection of the perishable product does not warn a potential user that the exposure of the product to a harmful stimulus has caused it to degrade or spoil. Although there are certain time-stimulus indicators currently available, most are focused on temperature, and not on the other types of stimuli. Additionally, many of these time-temperature indicators require the active agents to be kept separate from one another until the indicator is attached to the product it is monitoring. If the active ingredients or agents are not kept separate they will begin to interact prematurely, thereby giving a premature indication of spoilage. As a result, these types of indicators require manual activation. But manual activation is not always feasible when the indicator is being used with a product that is mass-produced in high-volume.

It is also well known that certain polymer gels exhibit reversible phase transition in that they reversibly swell and collapse (i.e., expand and shrink) upon exposure to and removal of predetermined stimuli. By way of example only, a swollen stimulus sensitive gel might be clear and non-opaque when it is kept within a stimulus range that is non-harmful to the product to which it is attached. But upon exposure to a harmful stimulus (i.e., its predetermined stimulus or its trigger stimulus such as a warm temperature), it can be made to undergo its phase transition and shrink, thereby expelling its liquid or constituent parts and thus turn opaque. Typically, once the gel has undergone its phase transition and collapsed or shrunk in volume and thus turn opaque, that shrunken stimulus sensitive gel can be made to expand or swell again by removing the predetermined stimulus (i.e., decrease the temperature of the shrunken stimulus sensitive gel to or past the temperature that caused it to collapse or shrink) and allowing it to reabsorb the previously expelled liquid or constituent parts. Accordingly, it is necessary to develop indicating devices with irreversibility built into the stimulus sensitive or stimulus indicating or stimulus reactive operation of the indicator. Such irreversibility would provide a permanent indication of exposure to a predetermined stimulus thereby causing the stimulus sensitive gel to remain opaque, regardless of whether the predetermined stimulus is later removed.

Thus, there is a need for an indicator that permanently indicates when a stimulus sensitive product has been exposed to a deleterious stimulus extreme (i.e., a predetermined stimulus) for a predetermined amount of time. There is also a need for a time-stimulus indicator that does not contain active agents that will begin to interact prior to being attached to the product being monitored, thereby resulting in false indications of spoilage. Furthermore, there is a need for a stimulus indicator that preferably does not require manual activation, although manual activation may be a desirable feature in some instances.

### SUMMARY OF THE INVENTION

The present invention is directed to a stimulus indicator device, which substantially overcomes one or more of the above-mentioned problems arising from limitations and disadvantages of the related art.

To achieve these and other advantages and in accordance with the purpose of the invention, as embodied and broadly described, and as discussed herein and shown the accompanying Figures, the embodiments discussed herein employ a stimulus sensitive metal and/or gel that each undergo its own phase transition upon exposure to a predetermined stimulus, and in doing so permanently indicates exposure to a predetermined stimulus.

The preferred embodiment discussed herein employs a metal known as a shape memory metal or super elastic metal to provide the indication of exposure to a predetermined stimulus. For example and as well known in the art, super elastic metals react to certain predetermined stimulus by expanding when exposed to a temperatures that is warmer than the temperature at which it was structurally manipulated. By way of example only, if a stimulus indicating device contained a super elastic metal that had been crumpled (preferably crumpled along a single tangent (e.g., like an accordion)) so as to be smaller in size than in its expanded state, and in its crumpled state revealed an indicator spot positioned below an indicator window, when the crumpled super elastic metal was exposed to a warmer temperature, it would expand and become uncrumpled, and in doing so it would at least partially if not fully cover the indicator spot.

Another metal that could be used in a stimulus indicating device is known in the art as Nitinal or Nickel-Titanium. As with the super elastic metal discussed above, and as well known in the art, Nitinal also reacts to certain predetermined stimulus. For example, when it is first bent or crumpled under pressure, and is then subsequently exposed to a warmer temperature, it expands and becomes at least partially if not fully uncrumpled. By way of example only, if a stimulus indicating device contained Nitinal that had been crumpled preferably crumpled along a single tangent (e.g., like an accordion) so as to be smaller in size than in its expanded state, and in its crumpled state revealed an indicator spot positioned below an indicator window, when the crumpled Nitinal was exposed to a warmer temperature, it would expand and become uncrumpled, and in doing so it would at least partially if not fully cover the indicator spot.

Because of these properties, these super elastic metals, including Nitinal, could be used to either expose or hide an indicator spot as taught in this and prior-related applications, so as to provide an indication of exposure to a predetermined stimulus.

In alternative embodiments, one of ordinary skill will appreciate and understand that if the stimulus sensitive deice employs a stimulus sensitive gel that is expanded or swollen at the beginning of its use before it undergoes its phase transition, the stimulus sensitive gel will be preferably clear or transparent, and thus allow the indicator spot to be viewed through the stimulus sensitive gel as well as through the indicator window. This clear or transparent appearance of the expanded or swollen stimulus sensitive gel can be achieved in any number of ways. For example, the stimulus sensitive gel could be manufactured so as to contain a dye that is of such concentration in the stimulus sensitive gel that when the stimulus sensitive gel is in its collapsed or shrunken state the stimulus sensitive gel is opaque due the dye contained in the stimulus sensitive gel concentrating in a single area and thus at least partially if not completely blocking the view or observation of any object below it (for example, an indication spot). But when that same stimulus sensitive gel containing dye is in its expanded or swollen state, it would be transparent or clear enough so that an object below it such as the indicator spot would be visible because the concentration of the stimulus sensitive gel containing dye would be such that in the gel's expanded or swollen state the stimulus sensitive gel would appear clear or transparent.

Alternatively and more preferably, the stimulus sensitive gel could be manufactured to be free of any dye and would achieve the same purpose and result so long as the stimulus sensitive gel being used was of such density that when it reached its at least partially and preferably fully collapsed or shrunken state, it would partially if not completely block the view of any object below it such as “an indication spot,” because the stimulus sensitive gel became concentrated over the indicator spot. Such a stimulus sensitive gel would also preferably need to be clear or transparent in its expanded or swollen state. Although the expanded or swollen stimulus sensitive gel is preferably clear or transparent prior to exposure to its predetermined stimulus, it could be less than absolutely clear and transparent; but as one of ordinary skill in the art would appreciate the less clear and less transparent this embodiment of the stimulus sensitive gel becomes, the more likely it is to block the indicator spot, and thereby give a false indication of exposure to a predetermined stimulus.

In operation, the stimulus indicating device would initially contain for example, an expanded or swollen stimulus sensitive gel. Once that stimulus indicating device containing the expanded or swollen stimulus sensitive gel is exposed to a detrimental or predetermined stimulus, the stimulus sensitive gel will collapse or shrink. And as the stimulus sensitive gel collapses or shrinks, it expels its liquid (and/or constituent parts), and simultaneously becomes at least partially opaque and at least partially if not fully blocks the view of the indicator spot below it which was being viewed by the user when the stimulus sensitive gel was in its expanded or swollen state. In essence, the now at least partially opaque stimulus sensitive gel will at least partially cover the indicator spot and prevent it from being viewed by the user. And because the expelled liquid (and/or constituent parts) are not able to be reabsorbed by the at least partially collapsed or shrunken stimulus sensitive gel as explained herein, the stimulus sensitive gel remains permanently collapsed or shrunken, thereby providing a permanent indication of exposure to that predetermined stimulus.

The opposite embodiment is also contemplated within the scope of this invention. Specifically, the stimulus sensitive gel could start out collapsed or shrunken and would thus be opaque and preferably completely block the indicator spot below it from being viewed by the user. In this embodiment, not seeing the indicator spot would indicate to the user of the stimulus indicating device that the object to which it was attached was still viable because it has not been exposed to a deleterious stimulus; whereas seeing the indictor spot prior to exposure to the predetermined stimulus would give a false indication that the indicator (and the product attached to it) had been exposed to a predetermined stimulus. But upon exposure to its predetermined stimulus the stimulus sensitive gel would permanently expand or swell and become partially, if not completely transparent or clear so that the indicator spot would be at least somewhat, if not fully visible to the user; thereby indicating that the object to which it was attached was potentially no longer viable because it has not been exposed to a deleterious stimulus.

By way of example only and as disclosed herein and in prior applications, a stimulus sensitive gel can be of the “Upper Critical Solution Temperature” or UCST type or of the “Lower Critical Solution Temperature” or LCST type gel. As one of ordinary skill in the art will appreciate, a UCST type stimulus sensitive gel will be used when one wishes to have an initially shrunken and opaque stimulus sensitive gel expand or swell when it is heated beyond a predetermined stimulus, and thereby reveal an indicator spot that was previously not visible to a user of the stimulus indicating device because it was preferably completely covered by the previously opaque stimulus sensitive gel. A UCST type stimulus sensitive gel could also be used when it is desired to have an initially swollen or expanded stimulus sensitive gel that is initially visually clear or transparent collapse or shrink when it is cooled beyond a predetermined stimulus, so as to become at least partially opaque and at least partially if not preferably completely block an indicator spot below it from being viewed by the user.

Alternatively, an LCST type stimulus sensitive gel will be used when one wishes to have an initially collapsed or shrunken stimulus sensitive gel that is consequently opaque or non-transparent expand or swell when it is cooled beyond a predetermined stimulus, so as to become at least partially clear or transparent and thereby at least partially visually reveal an indicator spot located below it to the user of the temperature indicating device. An LCST type stimulus sensitive gel could also be used when it is desired to have an initially expanded or swollen stimulus sensitive gel that is thus clear or transparent, collapse or shrink when it is heated beyond a predetermined stimulus, so as to become at least partially opaque or non-transparent and thereby visually block the indicator spot located below the stimulus sensitive gel from being seen or viewed by the user of the stimulus indicating device.

It should be noted that the predetermined temperature stimulus discussed herein that causes the stimulus sensitive gel to undergo its phase transition is only one example of a predetermined stimulus or trigger stimulus that will cause the stimulus sensitive gel to undergo its phase transition. As one of ordinary skill in the gel art understands, for example, the swollen stimulus sensitive gel of an alternative embodiment could trigger or undergo its phase transition upon exposure to a predetermined stimulus such as a predetermined pH level, or the swollen stimulus sensitive gel of this alternative embodiment could trigger or undergo its phase transition upon exposure to a predetermined level of electromagnetic radiation.

Single Compartment with Metal

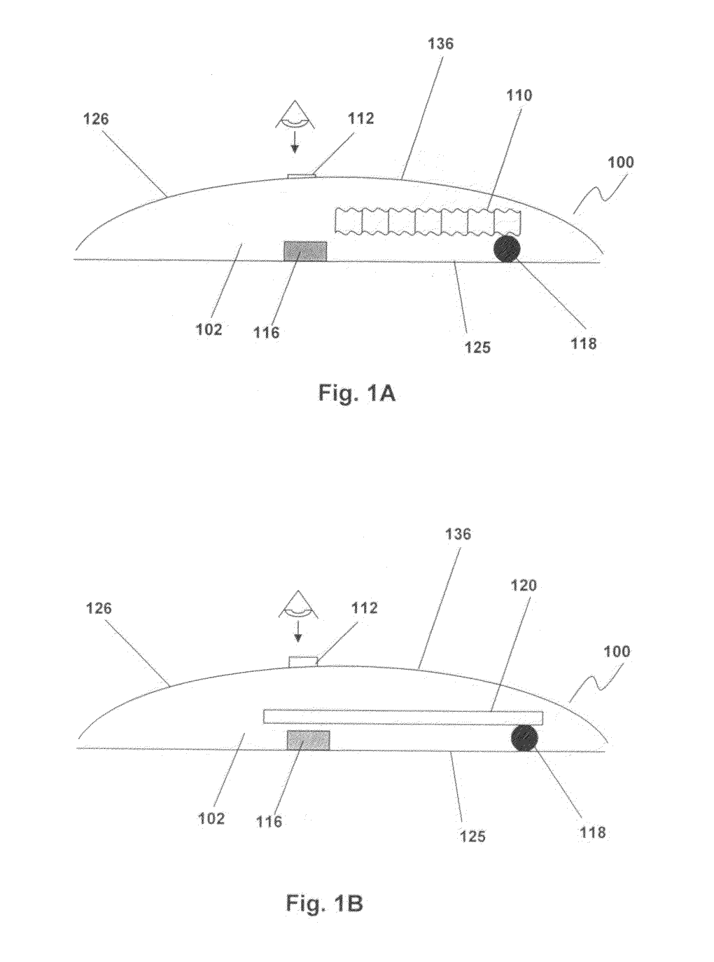

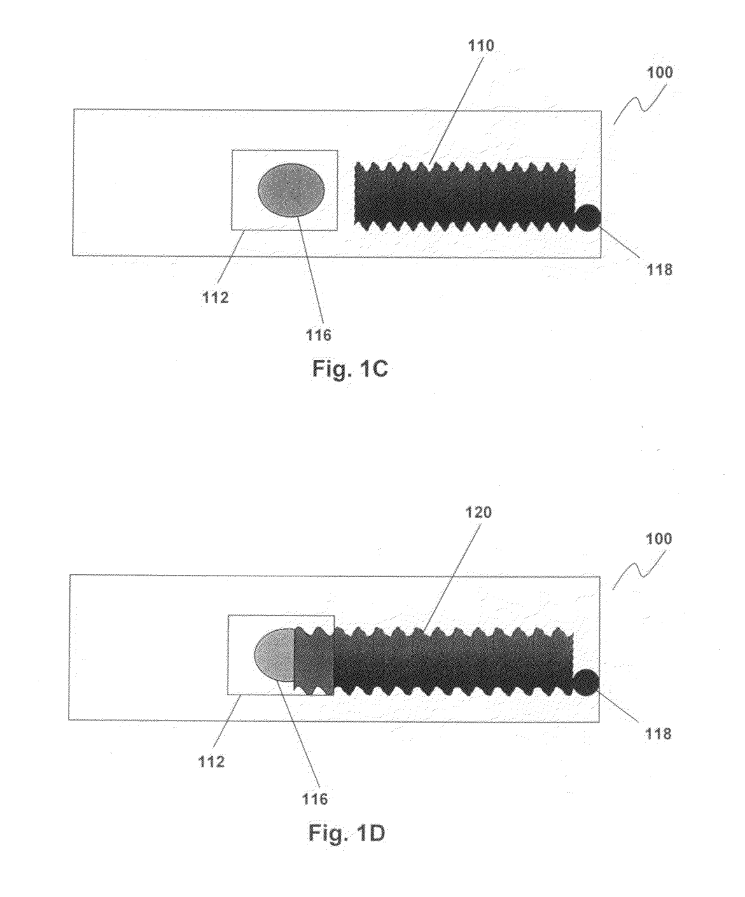

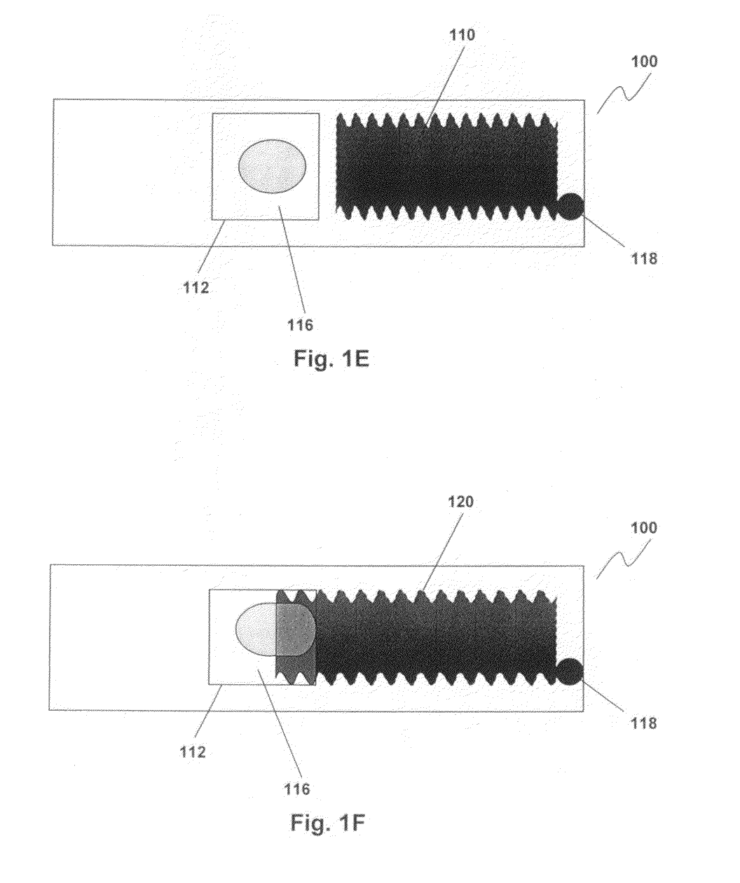

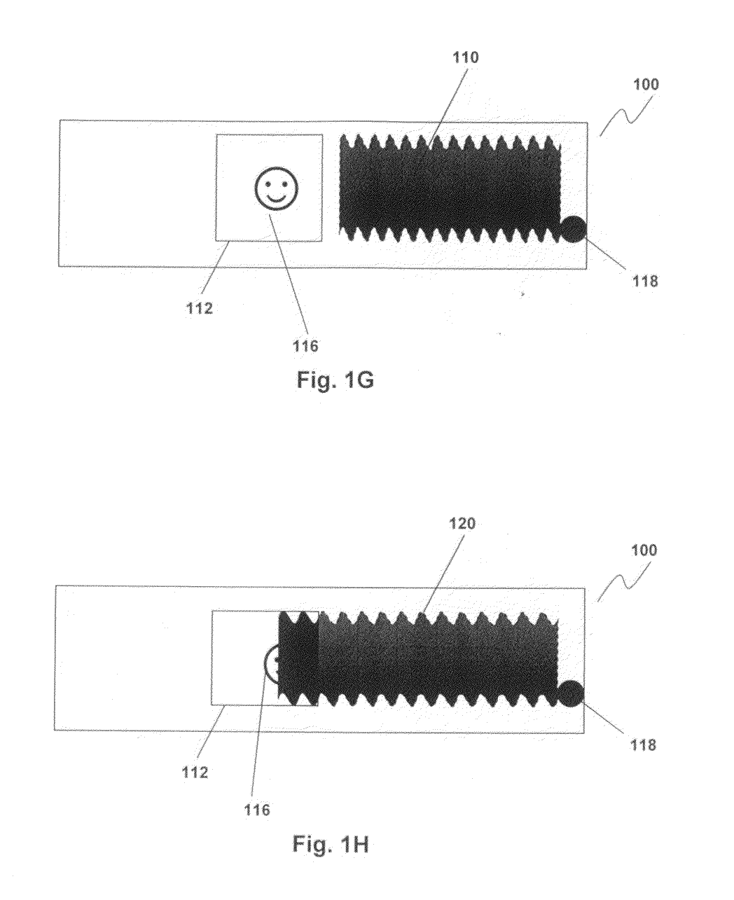

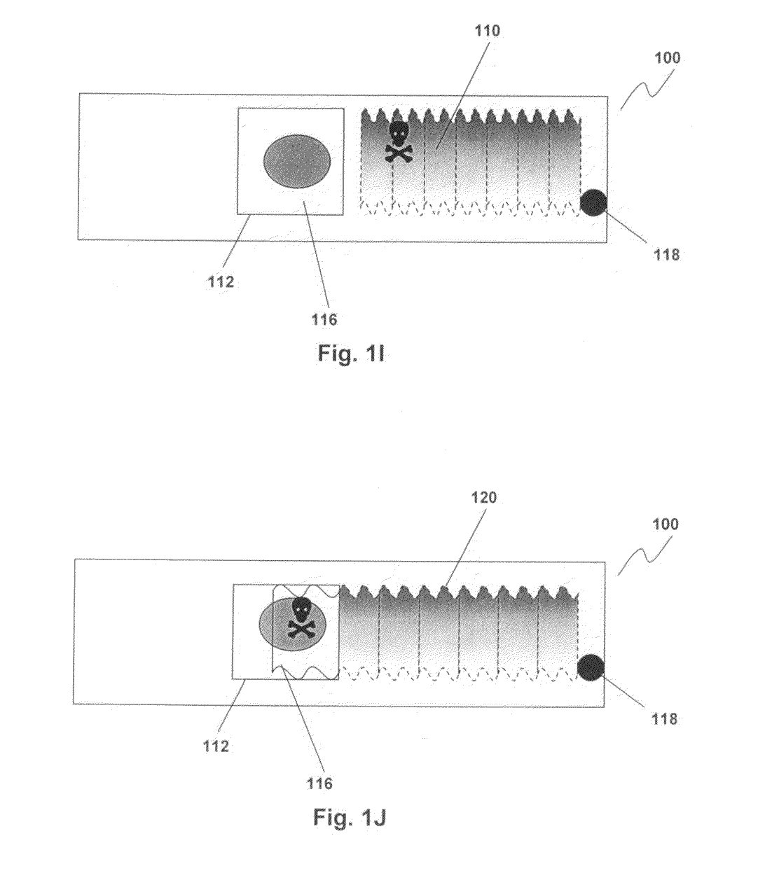

To achieve these and other advantages and in accordance with the purpose of the invention, as embodied and broadly described, and as shown in FIG. 1A and FIG. 1B, this preferred embodiment of the invention is a single compartment device containing a stimulus sensitive metal that undergoes its phase transition upon exposure to a predetermined stimulus, and containing an indicator spot located below an indicator window.

For purposes of disclosing this preferred embodiment and by way of example only, the stimulus sensitive metal in this preferred embodiment is initially collapsed or crumpled so as to expose an indicator spot visible through an indicator window; and which permanently expands or uncrumples upon exposure to its predetermined stimulus so as to be at least partially visually block the indicator spot located below the indicator window from being viewed by a user of the stimulus indicating device. An indicator window is provided through which the change in view of the indicator spot can be seen as a result of the previously collapsed or crumpled stimulus sensitive metal undergoing its phase transition in reaction to a predetermined stimulus (i.e., the length of the stimulus sensitive metal changes by expanding or uncrumpling in reaction to the predetermined stimulus) and thus at least partially if not fully blocks the view of the indicator spot below it. This results in the user of the stimulus indicating device not being able to view or observe the indicator spot through the indicator window. By way of example only, as the stimulus sensitive metal expands or uncrumples in reaction to the predetermined stimulus, it at least partially and preferably fully hides the indicator spot contained in the first compartment because the expanded or uncrumpled stimulus sensitive metal covers that indicator spot.

Notably, this preferred embodiment of this invention does not collapse or crumple when the predetermined stimulus is removed (i.e., the expanded or uncrumpled stimulus sensitive metal of this alternative embodiment will not collapse or crumple back to or near its original size when the predetermined stimulus is removed) because the operation of that stimulus sensitive metal does not function in a hysteresis pattern (i.e., it does not provide for reversibility so long as the now expanded or uncrumpled stimulus sensitive metal is not forcibly collapsed or crumpled), therefore, the now expanded stimulus sensitive metal will not collapse or crumple back to its original size, even when the predetermined stimulus is removed (by way of example only, if the collapsed or crumpled stimulus sensitive gel expanded or uncrumpled when it was exposed to a warmer temperature, it would not return to its prior collapsed or crumpled state, even if the temperature of the then expanded or uncrumpled stimulus sensitive metal was to subsequently return to the colder temperature at which it was originally in its collapsed or crumpled state), unless it was simultaneously exposed to a compressive force. Thus, the now expanded or uncrumpled stimulus sensitive metal will remain expanded or uncrumpled.

By way of example only, if the collapsed or crumpled stimulus sensitive metal of this alternative embodiment expanded or uncrumpled in response to a predetermined stimulus of a temperature rising above 10° C., and thus at least partially if not fully blocks the indicator spot, that now expanded or uncrumpled stimulus sensitive metal will not collapse or crumple back to or near its original volume or size, and consequently will not re-expose the indicator sport even when the temperature of the shrunken stimulus sensitive gel decreases back to a lower temperature (i.e., 8° C. or lower), unless it was simultaneously exposed to a compressive force.

The single compartment of this preferred embodiment containing the stimulus sensitive gel is formed by the backing layer on the bottom of the device and an upper layer on the top of the stimulus indicating device. The top layer of the stimulus indicating device is formed by at least the indicator window and the top portion of the top layer. Both the backing layer and the upper layer should be constructed of a strong, resilient leak-proof material, such as plastic or other polymer material, so as to provide for the twisting or bending that might occur during transportation of or application to the stimulus sensitive product without tearing, breaking or leaking. The backing layer and the upper layer may also be made of a material that preferably allows them to be joined and sealed together, such as by heat stamping or other suitable means. The backing layer and the upper layer can both approximate the length and width of the compartment, although variations in these dimensions are within the scope of the present invention. The upper layer can preferably be made of a clear material, such as plastic, so that the user of the stimulus indicating device can view at least some portion of the backing material or indicator spot through the indicator window. The upper layer can also be able to accept paint or ink so as to allow for coloring or concealing at least some portion of the first compartment.

Although at least some portion of the upper layer can also accept paint or ink for coloring, it is preferable that the indicator window portion of the upper layer remain free from ink or coloring so that the user of the stimulus indicating device can observe through the indicator window the change in color or shape that occurs in the first compartment, as explained herein. The backing layer should also be able to accept paste, glue or other suitable adhesive on the surface not facing the first compartment, so as to allow it to be attached to a stimulus sensitive product.

Preferably the stimulus sensitive metal is attached at an attachment point that is preferably located away from the location of the indicator window and indicator spot, so that when the stimulus sensitive metal in the alternative embodiment expands or uncrumples, it expands or uncrumples towards the indicator spot, and at least partially if not fully obscures that indicator spot. This way, the stimulus sensitive metal is secured to one location and cannot float or move within the first compartment and accidentally reveal the indicator spot when it should be at least partially covering it.

Single Compartment with Silica

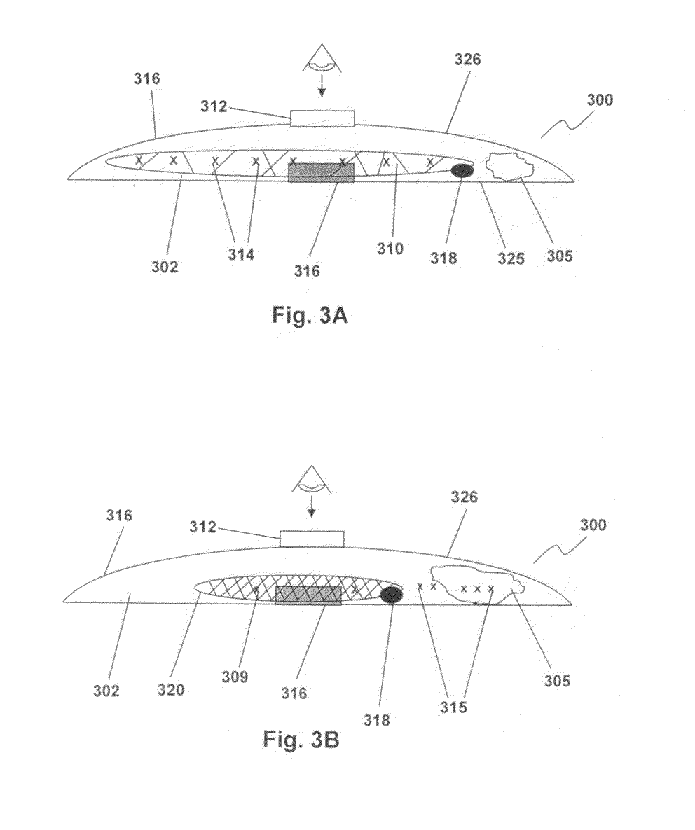

To achieve these and other advantages and in accordance with the purpose of the invention, as embodied and broadly described, and as shown in FIG. 3A and FIG. 3B, an alternative embodiment of the invention is a single compartment device, with the single or first compartment containing a stimulus sensitive gel. Moreover, this single compartment device could either contain an absorbent material, such as hygroscopic silica or an equivalent absorbent material, such as paper, that has an affinity for and permanently binds to the liquid and/or constituent parts expelled from the stimulus sensitive gel (such as water, sodium polyacrylate or a polyacrylamide derivatives).

For purposes of disclosing this alternative embodiment and by way of example only, the stimulus sensitive gel aspect of this preferred embodiment is initially expanded or swollen, so as to be preferably fully transparent or clear so as to allow the user to view the indicator spot. Then upon exposure to its predetermined stimulus, the stimulus sensitive gel would at least partially, and preferably fully obscure the indicator spot when it permanently collapses or shrinks upon exposure to its predetermined stimulus. As the stimulus sensitive gel undergoes its phase transition in response to a predetermined stimulus, and thus collapses or shrinks, the transparency of the stimulus sensitive gel changes from clear to more opaque. This change in transparency is visible through an indicator window. Specifically, as the swollen stimulus sensitive gel collapses or shrinks in response to the predetermined stimulus, the stimulus sensitive gel becomes less transparent and more opaque so as to at least partially hide and/or obscure the indicator spot. By way of example only, as the stimulus sensitive gel collapses or shrinks so as to become at least partially opaque or less than transparent, it at least partially obscures the indicator spot.

In one embodiment of this alternative embodiment, as the stimulus sensitive gel collapses or shrinks in response to the predetermined stimulus and thus becomes more opaque (i.e., less than transparent), a liquid (and/or constituent parts) within the stimulus sensitive gel is/are expelled into the first compartment and is/are then absorbed and permanently trapped or held by the absorbent material. Trapping and/or binding the expelled liquid and/or constituent parts in the absorbent material results in a constant volume of freely available expelled liquid and constituent parts as well as stimulus sensitive gel in the single compartment from that point forward. And because the shrunken stimulus sensitive gel can not access the expelled liquid and/or constituent parts absorbed by the absorbent material, the shrunken stimulus sensitive gel is prevented from undergoing its reverse phase transition and re-expanding or re-swelling to its original or near original volume when the predetermined stimulus is removed. Consequently the stimulus sensitive gel in its at least partially shrunken and less than transparent state will permanently at least partially, if not fully, obscure the indicator spot from view by the user of the stimulus indicating device.

The absorbent material should be selected to ensure that it has an affinity for the liquid and/or constituent parts expelled from the swollen stimulus sensitive gel as the swollen stimulus sensitive gel undergoes its phase transition. Moreover, the absorbent material should permanently bind to and trap the expelled liquid and/or constituent parts. By way of example only, if the expelled liquid were water, the absorbent material could be a silica gel. Because some or all of the volume of expelled liquid available to interact with the collapsed or shrunken gel is fixed or constant due to the expelled liquid being bound to and/or trapped by the absorbent material, the collapsed or shrunken gel is permanently prevented from re-expanding and re-exposing or again revealing the indicator spot, even when the predetermined stimulus condition is removed. In this way the stimulus indicating device will permanently show that it, and the stimulus sensitive product attached to it, had been exposed to a deleterious predetermined stimulus.

The single compartment of this preferred embodiment containing the stimulus sensitive gel is formed by the backing layer on the bottom of the device and an upper layer on the top of the stimulus indicating device. The top layer of the stimulus indicating device is formed by at least the indicator window and the top portion of the top layer. Both the backing layer and the upper layer should be constructed of a strong, resilient leak-proof material, such as plastic or other polymer material, so as to provide for the twisting or bending that might occur during transportation of or application to the stimulus sensitive product without tearing, breaking or leaking. The backing layer and the upper layer may also be made of a material that preferably allows them to be joined and sealed together, such as by heat stamping or other suitable means. The backing layer and the upper layer can both approximate the length and width of the compartment, although variations in these dimensions are within the scope of the present invention. The upper layer can preferably be made of a clear material, such as plastic, so that the user of the stimulus indicating device can view at least some portion of the backing material or indicator spot through the indication window. The upper layer can also be able to accept paint or ink so as to allow for coloring or concealing at least some portion of the first compartment.

Although at least some portion of the upper layer can also accept paint or ink for coloring, it is preferable that the indicator window portion of the upper layer remain free from ink or coloring so that the user of the stimulus indicating device can observe through the indicator window the change in color or shape that occurs in the first compartment as explained herein. The backing layer should also be able to accept paste, glue or other suitable adhesive on the surface not facing the first compartment, so as to allow it to be attached to a stimulus sensitive product.

Preferably the stimulus sensitive gel is attached at an attachment point that is preferably located close to the location of the indicator window and indicator spot, so that when the stimulus sensitive gel in this embodiment collapses or shrinks, it moves towards and at least partially covers the indicator spot. This way, the stimulus sensitive gel is secured to one location and cannot float or move within the first compartment and accidentally reveal the indicator spot when it should be at least partially covering it.

Gel with Permeable Membrane

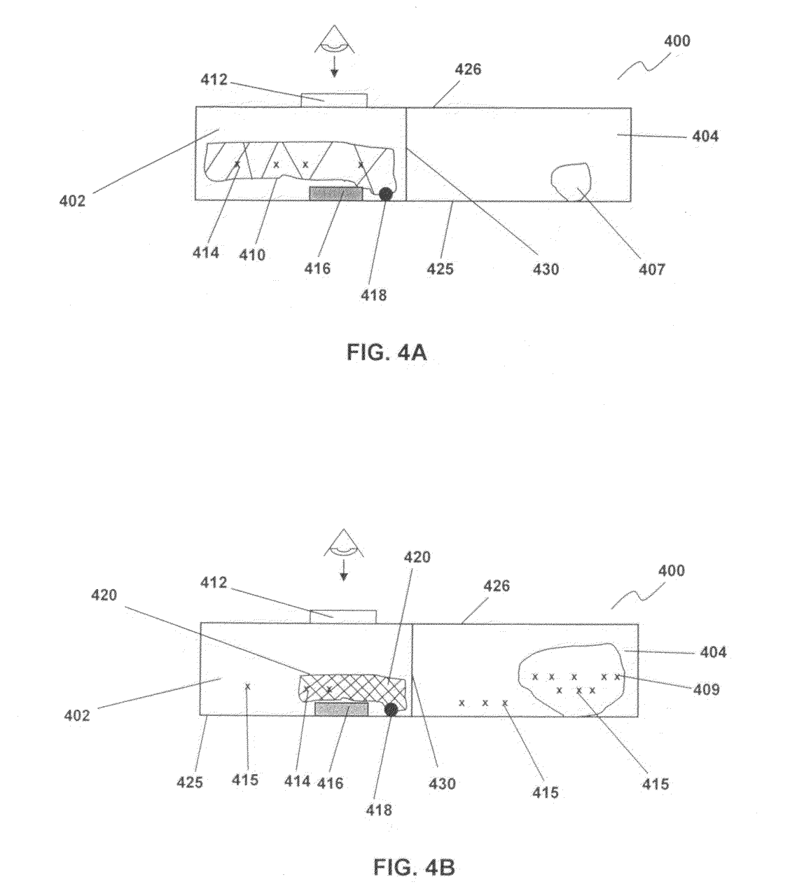

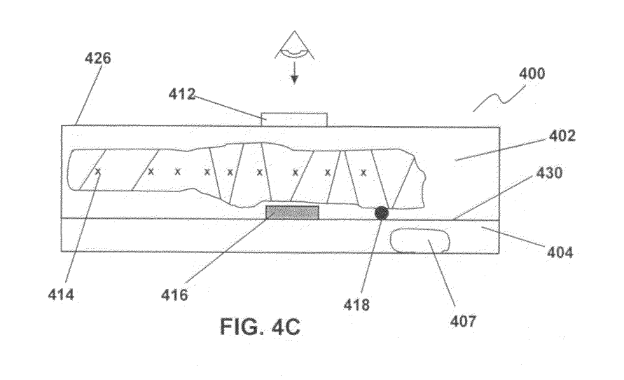

To achieve these and other advantages and in accordance with the purpose of the invention, as embodied and broadly described and as shown in FIG. 4A and FIG. 4B, an alternative embodiment of the invention is a multi-compartment device that includes at least a first compartment and a second compartment that are separated by a permeable membrane, which allows a liquid to pass through it in both directions. The first compartment contains an indicator spot, a stimulus sensitive gel and a display portion or indicator window that allows the user of the stimulus sensitive device to see a change in color or form due to the stimulus sensitive gel covering an indicator spot upon exposure to a predetermined stimulus, such exposure causing the stimulus sensitive gel to undergo its phase transition. As a result of the stimulus sensitive gel reacting to the predetermined stimulus, it undergoes its phase transition, causing the volume of the stimulus sensitive gel to change in that it collapses or shrinks and causes the stimulus sensitive gel to become at least partially opaque and at least partially cover the indicator spot, or alternatively the stimulus sensitive gel expands or swells causing the stimulus sensitive gel to become more clear and transparent and thereby at least partially revealing the indicator spot.

For purposes of disclosing this alternative embodiment and by way of example only, the stimulus sensitive gel aspect of this alternative embodiment is initially expanded or swollen, so as to be preferably fully transparent or clear so as to allow the user to view the indicator spot. Then upon exposure to its predetermined stimulus, the stimulus sensitive gel would at least partially (and preferably fully) obscure the indicator spot when it permanently collapses or shrinks upon exposure to its predetermined stimulus. As the stimulus sensitive gel undergoes its phase transition in response to a predetermined stimulus, and thus collapses or shrinks, the transparency of the stimulus sensitive gel changes from clear to more opaque. This change in transparency is visible through an indicator window. Specifically, as the swollen stimulus sensitive gel collapses or shrinks in response to the predetermined stimulus, the stimulus sensitive gel becomes less transparent and more opaque so as to at least partially hide and/or obscure the indicator spot, and this change in being able to view the indicator spot is due to the changing of the transparency of the stimulus sensitive gel. By way of example only, as the stimulus sensitive gel collapses or shrinks so as to become at least partially opaque or less than transparent, it at least partially if not fully obscures the indicator spot.

As the stimulus sensitive gel collapses or shrinks in response to the predetermined stimulus and thus becomes more opaque (i.e., less than transparent), a liquid (and/or constituent parts) within the stimulus sensitive gel is/are expelled into the first compartment, and pass into the second compartment though the permeable membrane that separates the at least two compartments.

Because the permeable membrane separating the at least two compartments allows the expelled liquid and/or constituent parts to pass in both directions, the expelled liquid and/or constituent parts could subsequently pass back into the first compartment. And when the predetermined stimulus is removed, the shrunken stimulus sensitive gel would then have the ability to reabsorb the previously expelled liquid once the predetermined stimulus is removed, thereby expanding or swelling to its original or near original volume, and thus regaining its at least partial transparency. In doing so, the now re-swollen and at least partial transparent stimulus sensitive gel could allow the indicator spot to be at least partially revealed or viewed by the user. Accordingly, the second compartment in this alternative embodiment preferably contains an absorbent material that has an affinity for the expelled liquid and/or constituent parts (as described herein or as understood in the art), so as to permanently bind to and trap the expelled liquid and/or constituent parts in the second compartment. By way of example only, if the expelled liquid were water, the absorbent material could be a silica gel or it could be paper.

Trapping the expelled liquid in the second compartment with the absorbent material results in a constant or fixed volume of liquid and gel in the first compartment from that point forward. Because the volume of liquid and gel in the first compartment is fixed due to the expelled liquid and/or constituent parts being trapped in the second compartment by the absorbent material, the collapsed or shrunken stimulus sensitive gel is permanently prevented from re-expanding and becoming at least partially transparent or at least partially clear; so as to prevent the stimulus sensitive gel from allowing the indicator spot to become visible even when the predetermined stimulus condition is removed. In this way the stimulus indicating device will permanently show that it, and the stimulus sensitive product attached to it, had been exposed to a deleterious predetermined stimulus. Consequently the stimulus sensitive gel in its at least partially shrunken and less than transparent state will permanently at least partially, if not fully, obscure the indicator spot from view by the user of the stimulus indicating device.

The at least two compartments of this alternative embodiment is formed by the backing layer on the bottom of the device and an upper layer on the top of the stimulus indicating device. The top layer of the stimulus indicating device is formed by at least the indicator window and the top portion of the top layer. Both the backing layer and the upper layer should be constructed of a strong, resilient leak-proof material, such as plastic or other polymer material, so as to provide for the twisting or bending that might occur during transportation of or application to the stimulus sensitive product without tearing, breaking or leaking. The backing layer and the upper layer may also be made of a material that preferably allows them to be joined and sealed together, such as by heat stamping or other suitable means. The backing layer and the upper layer can both approximate the length and width of the compartment, although variations in these dimensions are within the scope of the present invention. The upper layer can preferably be made of a clear material, such as plastic, so that the user of the stimulus indicating device can view at least some portion of the backing material or indicator spot through the indicator window. The upper layer can also be able to accept paint or ink so as to allow for coloring or concealing at least some portion of the first compartment.

Although at least some portion of the upper layer can also accept paint or ink for coloring, it is preferable that the indicator window portion of the upper layer remain free from ink or coloring so that the user of the stimulus indicating device can observe through the indicator window the change in color or shape that occurs in the first compartment as explained herein. The backing layer should also be able to accept paste, glue or other suitable adhesive on the surface not facing the first compartment, so as to allow it to be attached to a stimulus sensitive product.

Preferably the stimulus sensitive gel is attached at an attachment point that is preferably located close to the location of the indicator window and indicator spot, so that when the stimulus sensitive gel in this embodiment collapses, it collapses towards, and at least partially covers the indicator spot. This way, the stimulus sensitive gel is secured to one location and cannot float or move within the first compartment and accidentally reveal the indicator spot when it should be at least partially covering it.

Gel with Semi-Permeable Membrane

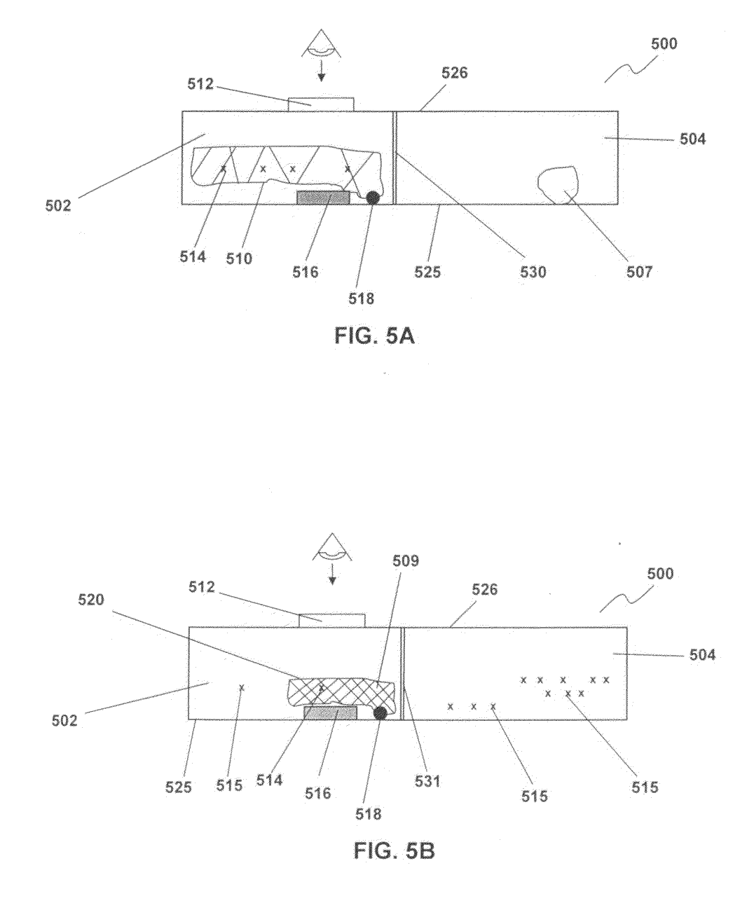

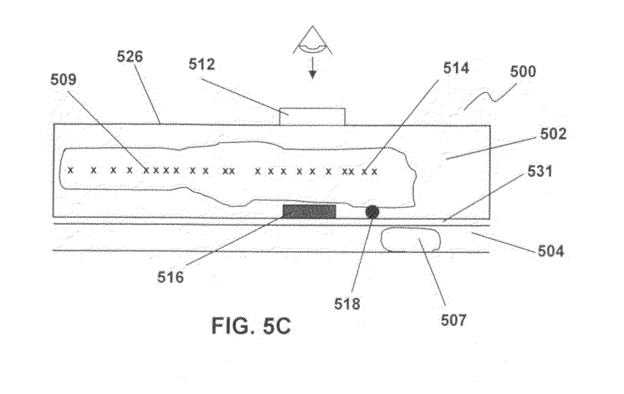

To achieve these and other advantages and in accordance with the purpose of the invention, as embodied and broadly described and as shown in FIG. 5A and FIG. 5B, another alternative embodiment of the invention is a multi-compartment device that includes at least a first compartment and a second compartment that are separated by a semi-permeable membrane, which allows a liquid to pass through it in only one direction. The first compartment contains an indicator spot, a stimulus sensitive gel and a display portion or indicator window that allows the user of the stimulus sensitive device to see a change in color or form due to the stimulus sensitive covering an indicator spot upon exposure to a predetermined stimulus, such exposure causing the stimulus sensitive gel to undergo its phase transition. As a result of the stimulus sensitive gel reacting to the predetermined stimulus, it undergoes its phase transition, causing the volume of the stimulus sensitive gel to change in that it collapses or shrinks and causes the stimulus sensitive gel to become at least partially opaque and at least partially cover the indicator spot, or alternatively the stimulus sensitive gel expands or swells causing the stimulus sensitive gel to become more clear and transparent and thereby at least partially revealing the indicator spot.

For purposes of disclosing this alternative embodiment and by way of example only, the stimulus sensitive gel aspect of this alternative embodiment is initially expanded or swollen, so as to be preferably fully transparent or clear so as to allow the user to view the indicator spot. Then upon exposure to its predetermined stimulus, the stimulus sensitive gel would at least partially (and preferably fully) obscure the indicator spot when it permanently collapses or shrinks upon exposure to its predetermined stimulus. As the stimulus sensitive gel undergoes its phase transition in response to a predetermined stimulus, and thus collapses or shrinks, the transparency of the stimulus sensitive gel changes from clear to more opaque. This change in transparency is visible through an indicator window. Specifically, as the swollen stimulus sensitive gel collapses or shrinks in response to the predetermined stimulus, the stimulus sensitive gel becomes less transparent and more opaque so as to at least partially hide and/or obscure the indicator spot, and this change in being able to view the indicator spot is due to the changing of the transparency of the stimulus sensitive gel. By way of example only, as the stimulus sensitive gel collapses or shrinks so as to become at least partially opaque or less than transparent, it at least partially obscures the indicator spot.

As the stimulus sensitive gel collapses or shrinks in response to the predetermined stimulus and thus becomes more opaque (i.e., less than transparent), a liquid (and/or constituent parts) within the stimulus sensitive gel is/are expelled into the first compartment, and then pass into the second compartment through the semi-permeable membrane that separates the at least two compartments.

Because the semi-permeable membrane separating the at least two compartments allows the expelled liquid and/or constituent parts to pass in one direction, the expelled liquid and/or constituent parts are trapped outside the first compartment, preferably in the second compartment, resulting in a constant volume of liquid and gel in the first compartment from that point forward.

Trapping the expelled liquid in the second compartment results in a constant or fixed volume of liquid and gel in the first compartment from that point forward. Because the volume of liquid and gel in the first compartment is fixed due to the expelled liquid and/or constituent parts being trapped in the second compartment by the semi-permeable membrane, the collapsed or shrunken stimulus sensitive gel is permanently prevented from re-expanding and becoming at least partially transparent or at least partially clear; so as to prevent the stimulus sensitive gel from allowing the indicator spot to become visible even when the predetermined stimulus condition is removed. In this way the stimulus indicating device will permanently show that it, and the stimulus sensitive product attached to it, had been exposed to a deleterious predetermined stimulus. Consequently the stimulus sensitive gel in its at least partially shrunken and less than transparent state will permanently at least partially, if not fully, obscure the indicator spot from view by the user of the stimulus indicating device.

Alternatively, the second compartment could also contain an absorbent material that has an affinity for the expelled liquid (as described herein or as understood in the art), so as to permanently bind to and trap the expelled liquid and/or constituent parts in the second compartment. By way of example only, if the expelled liquid were water, the absorbent material could be a silica gel or it could be paper.

The at least two compartments of this alternative embodiment is formed by the backing layer on the bottom of the device and an upper layer on the top of the stimulus indicating device. The top layer of the stimulus indicating device is formed by at least the indicator window and the top portion of the top layer. Both the backing layer and the upper layer should be constructed of a strong, resilient leak-proof material, such as plastic or other polymer material, so as to provide for the twisting or bending that might occur during transportation of or application to the stimulus sensitive product without tearing, breaking or leaking. The backing layer and the upper layer may also be made of a material that preferably allows them to be joined and sealed together, such as by heat stamping or other suitable means. The backing layer and the upper layer can both approximate the length and width of the compartment, although variations in these dimensions are within the scope of the present invention. The upper layer can preferably be made of a clear material, such as plastic, so that the user of the stimulus indicating device can view at least some portion of the backing material or indicator spot through the indicator window. The upper layer can also be able to accept paint or ink so as to allow for coloring or concealing at least some portion of the first compartment.

Although at least some portion of the upper layer can also accept paint or ink for coloring, it is preferable that the indicator window portion of the upper layer remain free from ink or coloring so that the user of the stimulus indicating device can observe through the indicator window the change in color or shape that occurs in the first compartment as explained herein. The backing layer should also be able to accept paste, glue or other suitable adhesive on the surface not facing the first compartment, so as to allow it to be attached to a stimulus sensitive product.

Preferably the stimulus sensitive gel is attached at an attachment point that is preferably located close to the location of the indicator window and indicator spot, so that when the stimulus sensitive gel in this embodiment collapses, it collapses towards, and at least partially covers the indicator spot. This way, the stimulus sensitive gel is secured to one location and cannot float or move within the first compartment and accidentally reveal the indicator spot when it should be at least partially covering it.

Cold-Side Gel with Neck Portion

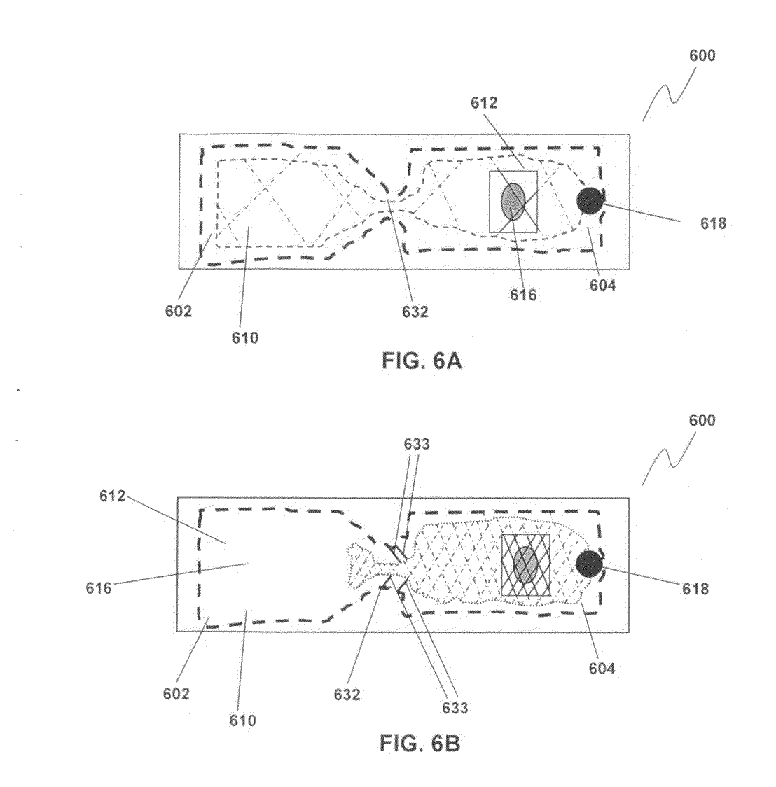

To achieve these and other advantages and in accordance with the purpose of the invention, as embodied and broadly described and as shown in FIG. 6A and FIG. 6B, another alternative embodiment of the invention is a multi-compartment device that includes at least a first compartment and a second compartment that are separated by a constricting portion or neck portion. By way of example only, this constricting portion is described herein and in prior applications as a nozzle portion, a neck portion, a constricting portion, or any combination thereof. Prior to exposure to a predetermined stimulus, in an embodiment such as described herein, a stimulus sensitive gel could be contained in either: i) only the first compartment; ii) only the second compartment; or iii) both the first compartment and the second compartment. This type of stimulus sensitive gel, and its location in the first, second or both compartments is dependant on the application of the stimulus indicator device. For purposes of illustration only, the embodiment described herein, prior to exposure to the predetermined stimulus, will contain the stimulus sensitive gel in both the first and second compartments.

For purposes of disclosing this alternative embodiment and by way of example only, the stimulus sensitive gel aspect of this alternative embodiment is initially expanded or swollen, so as to be preferably fully transparent or clear so as to allow the indicator spot, which is located in the second compartment below the indicator window, to be viewed by the user. Then upon exposure to its predetermined stimulus, the stimulus sensitive gel would at least partially, and preferably fully, obscure the indicator spot when it collapses or shrinks into the second compartment. Alternatively the stimulus sensitive gel could also expand or swell upon being exposed to its predetermined stimulus, thereby absorbing the surrounding liquid as it expands and swells, which in turn causes the stimulus sensitive gel to become more clear and transparent and thereby at least partially reveal the indicator spot.

For purposes of describing this alternative embodiment, as the swollen stimulus sensitive gel collapses or shrinks in response to the predetermined stimulus, a liquid (and/or constituent parts) within the stimulus sensitive gel is/are expelled throughout the at least first compartment and second compartment. As the stimulus sensitive gel collapses or shrinks, it at least partially if not fully withdraws from the first compartment and moves into the at least second compartment containing an indicator spot, which is preferably located below the indicator window. As the stimulus sensitive gel withdraws from the first compartment, it also passes through the constricting or neck portion that connects the first compartment and second compartment. As the stimulus sensitive gel collects in the second compartment, it becomes more opaque and less transparent; thereby at least partially blocking the indicator spot from the view of the user. For example, as the stimulus sensitive gel undergoes its phase transition in response to a predetermined stimulus, and thus collapses or shrinks, the transparency of the stimulus sensitive gel changes from clear to more opaque. This change in transparency is visible through an indicator window. Specifically, as the swollen stimulus sensitive gel collapses or shrinks in response to the predetermined stimulus, the stimulus sensitive gel becomes less transparent and more opaque so as to at least partially hide and/or obscure the indicator spot, and this change in being able to view the indicator spot

Because of the shape of the constricting or neck portion, once the stimulus sensitive gel has begun to collect inside the second compartment, the constricting or neck portion will permanently prevent the stimulus sensitive gel from re-expanding, and thereby becoming clear or transparent again and revealing the indicator spot when the predetermined stimulus is removed. In this way the stimulus indicating device will be at least partially permanently covered so as to evidence that the stimulus indicating device, and the stimulus sensitive product attached to it, had been exposed to a deleterious predetermined stimulus.

In a more particular version of this embodiment, the neck portion has angled ribs or teeth that allow the collapsing or shrinking gel to move into the second compartment but aid the neck portion in preventing the gel from moving back into the first compartment. These angled ribs or teeth operate on the same principle used by a snake or shark when it feeds—its teeth are angled backward so that the food (in regard to the present invention, the collapsing or shrinking stimulus sensitive gel) may move easily in the desired direction; but is prevented from moving in the opposite direction.

The at least two compartments of this alternative embodiment is formed by the backing layer on the bottom of the device and an upper layer on the top of the stimulus indicating device. The top layer of the stimulus indicating device is formed by at least the indicator window and the top portion of the top layer. Both the backing layer and the upper layer should be constructed of a strong, resilient leak-proof material, such as plastic or other polymer material, so as to provide for the twisting or bending that might occur during transportation of or application to the stimulus sensitive product without tearing, breaking or leaking. The backing layer and the upper layer may also be made of a material that preferably allows them to be joined and sealed together, such as by heat stamping or other suitable means. The backing layer and the upper layer can both approximate the length and width of the compartment, although variations in these dimensions are within the scope of the present invention. The upper layer can preferably be made of a clear material, such as plastic, so that the user of the stimulus indicating device can view at least some portion of the backing material or indicator spot through the indicator window. The upper layer can also be able to accept paint or ink so as to allow for coloring or concealing at least some portion of the first compartment.

Although at least some portion of the upper layer can also accept paint or ink for coloring, it is preferable that the indicator window portion of the upper layer remain free from ink or coloring so that the user of the stimulus indicating device can observe through the indicator window the change in color or shape that occurs in the first compartment as explained herein. The backing layer should also be able to accept paste, glue or other suitable adhesive on the surface not facing the first compartment, so as to allow it to be attached to a stimulus sensitive product.

Preferably the stimulus sensitive gel is attached at an attachment point that is preferably located close to the location of the indicator window and indicator spot, so that when the stimulus sensitive gel in this embodiment collapses, it collapses towards, and at least partially covers the indicator spot. This way, the stimulus sensitive gel is secured to one location and cannot float or move within the first compartment and accidentally reveal the indicator spot when it should be at least partially covering it.

Single Compartment with Non-Reversible Gel

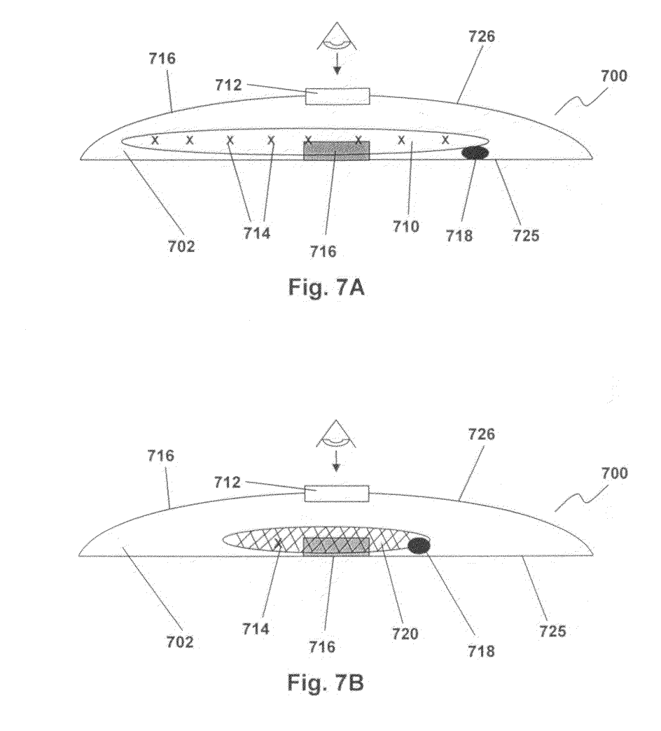

To achieve these and other advantages and in accordance with the purpose of the invention, as embodied and broadly described, and as shown in FIG. 7A and FIG. 7B, this alternative embodiment of the invention is a single compartment device containing a stimulus sensitive gel that undergoes its phase transition upon exposure to a predetermined stimulus, and containing an indicator spot located below an indicator window.

For purposes of disclosing this alternative embodiment and by way of example only, the stimulus sensitive gel in this alternative embodiment is initially expanded or swollen so as to be visually clear or transparent; and permanently collapses or shrinks upon exposure to its predetermined stimulus so as to be at least partially opaque or non-transparent so as to visually block the indicator spot located below the indicator window from being viewed by a user of the stimulus indicating device. An indicator window is provided through which the change in transparency of the stimulus sensitive gel can be seen as a result of the swollen stimulus-sensitive gel undergoing its phase transition in reaction to a predetermined stimulus (i.e., the volume of the stimulus sensitive gel changes by collapsing or shrinking in reaction to the predetermined stimulus and thus changes the transparency of the stimulus sensitive gel from somewhat clear to at least partially if not fully opaque). Specifically, as the swollen stimulus sensitive gel collapses or shrinks in response to the predetermined stimulus and becomes at least partially and more preferably fully opaque or non-transparent, the indicator spot contained in the first compartment becomes at least partially and preferably fully hidden or covered. This results in the user of the stimulus indicating device not being able to view or observe the indicator spot through the indicator window. By way of example only, as the stimulus sensitive gel collapses or shrinks it at least partially and preferably fully hides the indicator spot contained in the first compartment because the stimulus sensitive gel becomes opaque. As the stimulus sensitive gel collapses or shrinks in response to the predetermined stimulus, the polymer gels crosslink and in a sense becomes tangled, thereby causing the stimulus sensitive gel as a whole to become permanently less clear or less transparent and more opaque.

Notably, this alternative embodiment of this invention does not follow the typical reversibility pattern of a stimulus sensitive gel (i.e., the collapsed or shrunken stimulus sensitive gel of this alternative embodiment will not expand or swell back to or near its original volume when the predetermined stimulus is removed) because so long as the shrunken stimulus sensitive gel is maintained in a system that is closed to tangible substances (i.e., the shrunken stimulus sensitive gel and the liquid surrounding it are contained in a sealed compartment that prevents any liquids or constituent parts (and/or constituent parts) from passing into or out of that sealed compartment), but is open to intangible stimuli (i.e., the sealed compartment allows stimuli that cause a given stimulus sensitive gel to undergo a phase transition to pass in and out of the sealed compartment), the shrunken stimulus sensitive gel will not expand or swell back to its original size, even when the predetermined stimulus is removed (by way of example only, even if the subsequent temperature of the shrunken stimulus sensitive gel far exceeds the temperature at which the same stimulus sensitive gel collapsed or shrunk in reaction to that predetermined stimulus when it was swollen).

By way of example only, if the swollen stimulus sensitive gel of this alternative embodiment collapses or shrinks in response to a predetermined stimulus of a temperature dropping below 2° C., and thus becomes at least partially opaque and less than clearly transparent, that shrunken and now at least partially opaque stimulus sensitive gel will not expand or swell back to or near its original volume or size, and consequently will not return to its previously clear or transparent or nearly clear and transparent form even when the temperature of the shrunken stimulus sensitive gel is increased to ambient temperature (25° C. or 77° F.) or higher.

Because of the structure of the stimulus sensitive gel in the inventive stimulus indicating device in this alternative embodiment, the shrunken stimulus sensitive gel remains collapsed or shrunken, and thus at least partially (or preferably fully) opaque so long as the system remains closed (i.e., no liquid or constituent parts are withdrawn from the first compartment nor are they inserted into the first compartment). Thus, the collapsed or shrunken and thus at least partially opaque or less than transparent gel is unable to expand or swell, and thus return to its clear or transparent form when the predetermined trigger stimulus (by way of example only, the temperature of the stimulus sensitive gel goes below 2° C.) is removed. Accordingly, the indicator spot that is visible before the swollen stimulus sensitive gel collapses or shrinks and becomes less than transparent or opaque, is now permanently less than visible (if not invisible) due to the shrunken and at least opaque stimulus sensitive gel being permanently collapsed or shrunken in volume, and thus being permanently less than transparent or at least somewhat opaque. It will be appreciated that the embodiment discussed herein teaching the stimulus sensitive gel as containing acetone and water as constituent parts is illustrative only, and those constituent parts could be replaced by any other fluids and/or constituent parts that work for the same purpose, such as mixtures of ethanol and water, or mixtures of water and other non-polar solvents, polar solvents, etc.

The single compartment of this alternative embodiment containing the stimulus sensitive gel is formed by the backing layer on the bottom of the device and an upper layer on the top of the stimulus indicating device. The top layer of the stimulus indicating device is formed by at least the indicator window and the top portion of the top layer. Both the backing layer and the upper layer should be constructed of a strong, resilient leak-proof material, such as plastic or other polymer material, so as to provide for the twisting or bending that might occur during transportation of or application to the stimulus sensitive product without tearing, breaking or leaking. The backing layer and the upper layer may also be made of a material that preferably allows them to be joined and sealed together, such as by heat stamping or other suitable means. The backing layer and the upper layer can both approximate the length and width of the compartment, although variations in these dimensions are within the scope of the present invention. The upper layer can preferably be made of a clear material, such as plastic, so that the user of the stimulus indicating device can view at least some portion of the backing material or indicator spot through the indicator window. The upper layer can also be able to accept paint or ink so as to allow for coloring or concealing at least some portion of the first compartment.

Although at least some portion of the upper layer can also accept paint or ink for coloring, it is preferable that the indicator window portion of the upper layer remain free from ink or coloring so that the user of the stimulus indicating device can observe through the indicator window the change in color or shape that occurs in the first compartment, as explained herein. The backing layer should also be able to accept paste, glue or other suitable adhesive on the surface not facing the first compartment, so as to allow it to be attached to a stimulus sensitive product.

Preferably the stimulus sensitive gel is attached at an attachment point that is preferably located close to the location of the indicator window and indicator spot, so that when the stimulus sensitive gel in the alternative embodiment collapses, it collapses towards, and at least partially obscures the indicator spot. This way, the stimulus sensitive gel is secured to one location and cannot float or move within the first compartment and accidentally reveal the indicator spot when it should be at least partially covering it.

In accordance with the purpose of the invention, as embodied and broadly described, another embodiment of the invention is a device that indicates when a stimulus sensitive product has potentially or conclusively undergone a physical change in response to exposure to a predetermined stimulus extreme.

In accordance with the purpose of the invention, as embodied and broadly described, another embodiment of the invention is a device that indicates when a stimulus sensitive product has potentially or conclusively undergone a physical change in response to exposure to a predetermined stimulus extreme over a predetermined period of time.

In accordance with the purpose of the invention, as embodied and broadly described, other embodiments of the invention are methods to manufacture stimulus sensitive gels that indicates exposure to a predetermined stimulus extreme.

It is to be understood that both the general descriptions above and the detailed descriptions below are exemplary and are intended to provide further explanation of the inventions as claimed. As such it is understood that any and/or all of the aspects or portions of the various and alternative embodiments described herein or described in prior applications are able to be combined, mixed and matched, etc., so that although a certain embodiment is not described herein, it is understood to be included in this or previous disclosures.

### BRIEF DESCRIPTION OF THE DRAWINGS

The foregoing and other objects, aspects and advantages will be better understood from the following detailed description of various embodiments of the invention with reference to the drawings in which:

### Stimulus Sensitive Metal

FIG. 1A is a side cross-sectional view of an embodiment of the invention before exposure to a predetermined trigger stimulus;

FIG. 1B is a side cross-sectional view of the embodiment in FIG. 1A after exposure to a predetermined trigger stimulus.

FIG. 1C is a side cross-sectional view of an embodiment of the invention before exposure to a predetermined trigger stimulus;

FIG. 1D is a side cross-sectional view of the embodiment in FIG. 1C after exposure to a predetermined trigger stimulus.

FIG. 1E is a side cross-sectional view of an embodiment of the invention before exposure to a predetermined trigger stimulus;

FIG. 1F is a side cross-sectional view of the embodiment in FIG. 1E after exposure to a predetermined trigger stimulus.

FIG. 1G is a side cross-sectional view of an embodiment of the invention before exposure to a predetermined trigger stimulus;

FIG. 1H is a side cross-sectional view of the embodiment in FIG. 1G after exposure to a predetermined trigger stimulus.

FIG. 1I is a side cross-sectional view of an embodiment of the invention before exposure to a predetermined trigger stimulus;

FIG. 1J is a side cross-sectional view of the embodiment in FIG. 1I after exposure to a predetermined trigger stimulus.

### Indicator Spot Configurations

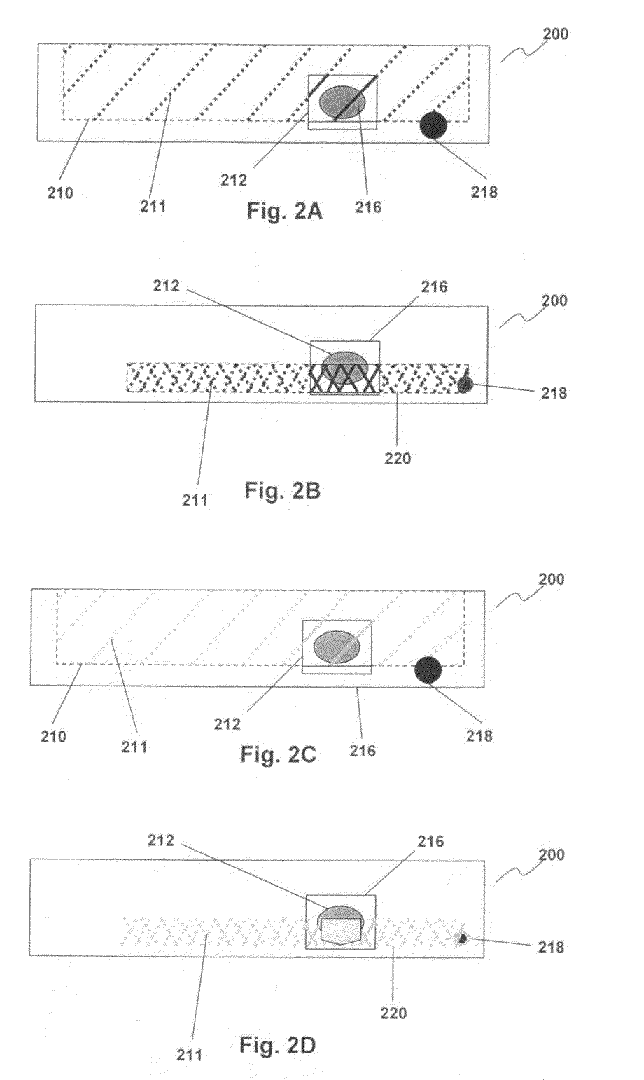

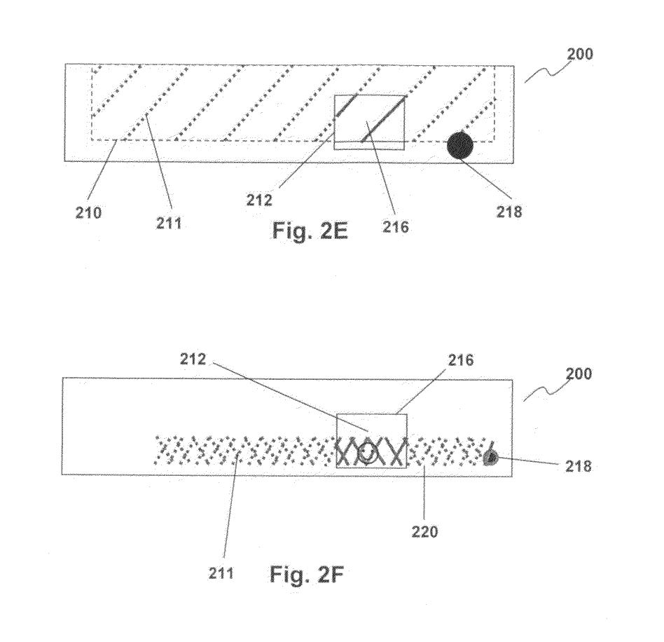

FIG. 2A is a top view of an embodiment of the invention before exposure to a predetermined trigger stimulus.

FIG. 2B is a top view of the embodiment in FIG. 2A after exposure to a predetermined trigger stimulus.

FIG. 2C is a top view of an alternate embodiment of the invention before exposure to a predetermined trigger stimulus.

FIG. 2D is a top view of the alternate embodiment in FIG. 2C after exposure to a predetermined trigger stimulus.

FIG. 2E is a top view of an alternate embodiment of the invention before exposure to a predetermined trigger stimulus.

FIG. 2F is a top view of the alternate embodiment in FIG. 2E after exposure to a predetermined trigger stimulus.

Gel with Silica

FIG. 3A is a side cross-sectional view of an embodiment of the invention before exposure to a predetermined trigger stimulus.

FIG. 3B is a side cross-sectional view of the embodiment in FIG. 3A after exposure to a predetermined trigger stimulus.

Gel with Permeable Membrane

FIG. 4A is a side cross-sectional view of an embodiment of the invention before exposure to a predetermined trigger stimulus.

FIG. 4B is a side cross-sectional view of the embodiment in FIG. 4A after exposure to a predetermined trigger stimulus.

FIG. 4C is a side view of an additional embodiment of the invention before exposure to a predetermined trigger stimulus.

Gel with a Semi-Permeable Membrane

FIG. 5A is a side cross-sectional view of an embodiment of the invention before exposure to a predetermined trigger stimulus.

FIG. 5B is a side cross-sectional view of the embodiment in FIG. 5A after exposure to a predetermined trigger stimulus.

FIG. 5C is a side view of an additional embodiment of the invention before exposure to a predetermined trigger stimulus.

Gel with Neck Portion

FIG. 6A is a top view of an embodiment of the invention before exposure to a predetermined trigger stimulus.

FIG. 6B is a top view of the embodiment in FIG. 6A after exposure to a predetermined trigger stimulus.

### Concentration Sensitive Gel

FIG. 7A is a side cross-sectional view of an embodiment of the invention before exposure to a predetermined trigger stimulus.

FIG. 7B is a side cross-sectional view of the embodiment in FIG. 7A after exposure to a predetermined trigger stimulus.

### DETAILED DESCRIPTION OF EMBODIMENTS OF THE INVENTION

This invention pertains to stimulus indicating devices that employ a stimulus sensitive portion that responds to a specific predetermined stimulus so as to result in a permanent indication of exposure to a deleterious predetermined stimulus. One type of stimulus sensitive portion is a stimulus sensitive metal, and a second type of stimulus sensitive portion is a stimulus sensitive gel. Each are described in turn below.

It is well known that certain types of metal have elastic properties in that if they are bent, they will revert back to their initial shape without any external impetus. Moreover, there are a type of super elastic metals, known as Nitinal that will retain their bent or collapsed shape until they are exposed to a predetermined stimulus, such as a change in temperature. For example, when a certain type of stimulus sensitive metal that is initially in a collapsed or crumpled state is exposed to a predetermined trigger stimulus, such as a change in temperature or a temperature extreme, it undergoes its phase transition and expands or uncrumples due to the operation of the superelastic metal. It is also well known that when the predetermined stimulus is removed, the now expanded or uncrumpled metal will not undergo the reverse phase transition and collapse or crumple unless the stimulus sensitive metal is returned to the original temperature and an external force is applied to the stimulus sensitive metal.

It is also well known that certain types of stimulus sensitive gels undergo expansion or swelling as well as collapsing or shrinking that is dictated by equilibrium thermodynamics. Therefore, a swollen stimulus sensitive gel that collapses or shrinks when undergoing its phase transition in reaction to a predetermined trigger stimulus will expand or swell back to its original volume if that predetermined trigger stimulus is removed. For example, when a swollen stimulus sensitive gel is exposed to a predetermined trigger stimulus, such as a temperature extreme, it undergoes its phase transition and collapses or shrinks in volume due to the expulsion or leaking of the fluid contained in the gel. It is also well known that when the predetermined trigger stimulus is removed, the stimulus sensitive gel will undergo the reverse phase transition and collect or absorb the previously expelled liquid, thereby expanding or swelling in volume. It is also well known that the reverse is true—a shrunken stimulus sensitive gel that expands or swells when undergoing its phase transition in reaction to a predetermined trigger stimulus will collapse or shrink back to its original volume if that predetermined trigger stimulus is removed. For example, when a certain type of shrunken stimulus sensitive gel is exposed to a predetermined trigger stimulus, such as a change in temperature or a temperature extreme, it undergoes its phase transition and expands or swells in volume due to the collection or absorption of the fluid surrounding the shrunken stimulus sensitive gel. It is also well known that when the predetermined stimulus is removed, the now expanded or swollen stimulus sensitive gel will undergo the reverse phase transition and expel the previously collected liquid, thereby collapsing or shrinking in volume.

Thus, the problem with the known stimulus sensitive gels is that they are reversible. Accordingly, it is necessary to develop stimulus indicating devices employing such stimulus sensitive gels that are irreversible. Disclosed herein are embodiments that ensure an irreversible, reliable visual indication of a stimulus sensitive gel that undergoes a phase transition in response to a predetermined stimulus, and either permanently remain in that transitioned state, or permanently indicates that exposure to a predetermined stimulus occurred. The predetermined trigger stimulus could be exposure of the stimulus sensitive gel to a certain temperature, or it could be exposure of the stimulus sensitive gel to other stimuli such as light, pH, humidity, radiation, electromagnetic radiation, visible light, radiation, solvent composition, ionic strength, etc. For sake of clarity this application will focus on exposure of the stimulus sensitive gel to a predetermined temperature stimulus.

### Metal Only

In accordance with the purpose of the invention, as embodied and broadly described herein and in conjunction with FIG. 1A and FIG. 1B as well as FIG. 1C through FIG. 1J, the preferred embodiment of the inventive stimulus indicating device preferably has a single compartment containing an initially collapsed or crumpled stimulus sensitive metal 110, and indicator spot 116.

The single or first compartment 102 is formed by the backing layer 125 on the bottom of the stimulus indicating device 100 and an upper layer 126 on the top of the stimulus indicating device 100. The top layer 126 of the stimulus indicating device 100 is formed by at least the indicator window 112 and the top portion 108 of the top layer 126. The indicator spot 116 can be viewed through an indicator window 112 located in the top layer 126 of the stimulus indicating device 100 because the collapsed or crumpled stimulus sensitive metal 110 is positioned away from the indicator spot 116 and so the indicator spot 116 is visible through the indicator window 112.

Prior to being exposed to a predetermined trigger stimulus, the collapsed or crumpled stimulus sensitive metal 110 has not yet undergone a phase transition and preferably allows the entire indicator spot 116 to be visible to the user. The indicator spot 116 is positioned below the indicator window 112, and is preferably completely visible through the indicator window 112 prior to the stimulus indicating device 100 being exposed to the predetermined stimulus because the crumpled stimulus sensitive metal 110, and as shown in FIG. 1A, the crumpled stimulus sensitive metal 110 is preferably completely removed from the area of the indicator spot so that in its collapsed or crumpled state it does not at all cover or block the view of the indicator spot 116.

As discussed herein, this preferred embodiment of the stimulus indicating device 100 contains a stimulus sensitive metal 110 and 120 described herein in regard to FIG. 1A and FIG. 1B. As the stimulus sensitive metal is exposed to a predetermined stimulus, by way of example only a certain temperature, and it undergoes its phase transition by expanding or uncrumpling in size, it at least partially if not fully covers the indicator spot 116 previously visible through the display portion or indicator window 112.

Upon exposure of the stimulus sensitive product to its predetermined phase transition stimulus, such as temperature, the crumpled stimulus sensitive metal 110 would undergo its phase transition and expand or uncrumple so as to become the uncrumpled stimulus sensitive metal 120 as shown in FIG. 1B, due to the operation of the superelastic metal. As the crumpled stimulus sensitive metal expands or uncrumples, it at least partially and preferably wholly covers the indicator spot 116 previously visible through the indicator window 112, so that the indicator spot 116 is at least partially if not preferably fully hidden from the view of the user through the indicator window 112. The more the collapsed or crumpled stimulus sensitive metal 110 expands or uncrumples the more it covers the indicator spot 116, and the more it becomes like the uncrumpled stimulus sensitive metal 120 in FIG. 1B. Such partial or preferably full coverage of the indicator spot 116 by the expansion or uncrumpling of the crumpled stimulus sensitive metal 110 to become the uncrumpled stimulus sensitive metal 120 is the same for all variations of this embodiment discussed herein.

It should be noted that it is not necessary for the crumpled stimulus sensitive metal 110 to expand or uncrumple entirely in order for the indicator spot 116 to be less visible to the user. Instead, if even a portion of the indicator spot 116 is covered from the view of the user through the indicator window 112, it is enough to signal to the user that the product attached to the stimulus indicating device 100 had been exposed to a potentially harmful stimulus. More specifically, although the increase in size of the crumpled stimulus sensitive metal 110 in all of the embodiments of the stimulus indicating device 100 discussed herein containing a stimulus sensitive gel can be by any amount so long as it is registerable, preferably the increase in length or size of the crumpled stimulus sensitive metal 110 would be between at least a 1/10 increase in length or size in original area, and up to a 500 times increase in length or size. In regard to all embodiments of the stimulus indicating device 100 discussed herein as they pertain to the increase in the length or size of the crumpled stimulus sensitive metal 110 being “registerable” what is meant is that the change in length or size of the crumpled stimulus sensitive metal 110 is large enough to block the view of the indicator spot 116. By way of example only, the increasing length or size of the crumpled stimulus sensitive metal 110 would provide an indication of exposure to a predetermined stimulus because it blocks the view of the indicator spot 116 (e.g., an indicator spot 116 that is the same color as the stimulus sensitive metal 110 and 120, or is a glyph, such as a happy face ( [symbol] ) when it expands and becomes the uncrumpled stimulus sensitive metal 120, and thereby at least partially and preferably fully covers or blocks the indicator spot 116 from the view of the user through the indicator window 112, and thus indicates to the user that the product had been exposed to a predetermined stimulus.

In regard to all the embodiments of the stimulus indicating device discussed herein being “irreversible” and “permanent,” what is meant is that once the stimulus indicating device provides an indication of exposure to an adverse stimulus extreme (which is also referred to herein as a predetermined stimulus), that indication of exposure does not change, even though the adverse stimulus extreme or predetermined stimulus might be removed in the future.

Both the backing layer 125 and the upper layer 126 may be constructed of a strong, resilient leak-proof material, such as plastic or other polymer material, so as to provide for the twisting or bending that might occur during transportation of or application to the stimulus sensitive product without tearing, breaking or leaking. The backing layer 125 and the upper layer 126 may also be made of a material that preferably allows them to be joined and sealed together, such as by heat stamping or other suitable means. The backing layer 125 and the upper layer 126 can both approximate the length and width of the first compartment 102, although variations in these dimensions are within the scope of the present invention. The upper layer 126 can preferably be made of a clear material, such as plastic, so that the user of the stimulus indicating device 100 can view at least some portion of the backing material or color changing absorbent material 107. The upper layer 126 can also be able to accept paint or ink so as to allow for coloring or concealing at least some portion of the first compartment 102.

Although some portion of the upper layer 126 can also accept paint or ink for coloring, it is preferable that the indicator window 112 portion of the upper layer 126 remain free from ink or coloring so that the user of the stimulus indicating device 100 can observe the first compartment 102 through the indicator window 112 as explained herein.

This preferred embodiment of the stimulus indicating device 100 as disclosed herein and in conjunction with FIG. 1A and FIG. 1B, can be combined in conjunction with the embodiments shown in FIG. 1C through FIG. 1D to disclose to the user of the stimulus indicating device 100 that the product to which it is attached had been exposed to a predetermined stimulus. More particularly, as shown in FIG. 1C and FIG. 1D in conjunction with FIG. 1A and FIG. 1B, by coloring the stimulus sensitive metal 110 and 120 a different color than the indicator spot 116, the expanded stimulus sensitive metal 120 can hide that indicator spot 116 from the view of the user after being exposed to the predetermined trigger stimulus.

By way of example only, the collapsed or crumpled stimulus sensitive metal 110 may be colored a specific color, such as red, and the indicator spot 116 is colored green. When the stimulus indicating device 100 is viewed pre-phase transition through the indicator window 112, it informs the user (perhaps in conjunction with a legend or color key) that the product attached to the stimulus indicating device 100 had not been exposed to a potentially harmful stimulus. But as shown in FIG. 1D in conjunction with FIG. 1A and FIG. 1B, upon exposure to the predetermined stimulus, the red colored collapsed or crumpled stimulus sensitive metal 110 will undergo its phase transition and expand or uncrumple so as to become like the expanded or uncrumpled stimulus sensitive metal 120 which covers at least a portion of the green indicator spot 116. In this way the user is warned that the product attached to the stimulus indicating device 100 had been exposed to a potentially harmful stimulus.

In an alternate embodiment shown in FIG. 1E and FIG. 1F in conjunction with FIG. 1A and FIG. 1B, the expanded or uncrumpled stimulus sensitive metal 120 need not be so thick that the color appears solid, but instead could be thin enough so that the color of the expanded or uncrumpled stimulus sensitive metal 120 in combination with the color of the indicator spot 116 could result in a third color. By way of example only, if the expanded or uncrumpled stimulus sensitive metal 120 were colored red, and the indicator spot 116 were colored yellow, and if the expanded or uncrumpled stimulus sensitive metal 120 were thin enough, the combination of the two colors would result in the creation of a third color—orange. Thus, even though the stimulus indicating device 100 could potentially show: i) yellow prior exposure to the predetermined stimulus; ii) only orange after exposure to the predetermined stimulus; and/or iii) three colors simultaneously (i.e., the red of the expanded or uncrumpled stimulus sensitive metal 120 that did not cover the indicator spot 116, the yellow of the portion of the indicator spot 116 that was not covered by the uncrumpled stimulus sensitive metal 120, and the orange resulting from the combination of the red of the expanded or uncrumpled stimulus sensitive metal 120 that layed on top of the yellow indicator spot 116), such potential colors are irrelevant because the stimulus indicating device 100 would definitively indicate that the stimulus sensitive product to which it is attached had been exposed to a predetermined stimulus.

In an alternative embodiment of the present invention, as shown in FIG. 1G and FIG. 1H in conjunction with FIG. 1A and FIG. 1B, the expanded or uncrumpled stimulus sensitive metal 120 can be colored the same color as the indicator spot 116. Thus, the visual impression through the indicator window 112 of the expanded or uncrumpled stimulus sensitive metal 120 in combination with the indicator spot 116 simply needs to appear uniform in color so that the indicator spot 116 cannot be discerned through the expanded or uncrumpled stimulus sensitive metal 120. Because in this alternate embodiment of the preferred embodiment, the expanded or uncrumpled stimulus sensitive metal 120 and the indicator spot 116 are the same color, as shown in FIG. 1G the indicator spot 116 is preferably a design or glyph (by way of example only, an “ [symbol] ” or a happy face) that, once covered due to the expanded or uncrumpled stimulus sensitive metal 120 covering the indicator spot 116, the stimulus indicating device 100 will warn the user that the product attached to it had been exposed to a potentially harmful stimulus because the indication that the stimulus sensitive product was still viable (e.g., an “ [symbol] ” or a happy face) would no longer be visible.

In an alternative embodiment of the present invention, as shown in FIG. 1I and FIG. 1J in conjunction with FIG. 1A and FIG. 1B, the expanded or uncrumpled stimulus sensitive metal 120 could have a design or glyph 140 (by way of example only, a “skull and cross bones”) imprinted or painted on the portion of the stimulus sensitive metal 110 and 120. Initially, the design or glyph 140 is not visible to the user of the stimulus indicating device 100 because the stimulus sensitive metal is collapsed and the design 140 is hidden below the top portion 108 of the top layer 126. But upon exposure to the predetermined stimulus the design 140 is subsequently visible through the indicator window 116 after the previously collapsed or crumpled stimulus sensitive metal 110 is expanded or uncrumpled because it had been exposed to a deleterious or predetermined stimulus. Because the expanded or uncrumpled stimulus sensitive metal 120 covers the indicator spot 112 and now allows the design or glyph 140 to be seen through the indicator window 116, it indicates that the product attached to the stimulus indicating device 100 had been exposed to a harmful stimulus.

Preferably, the stimulus sensitive metal 110 and 120 would be fixed or secured at the attachment point 118, or at more than one attachment point if desired. The stimulus sensitive metal 110 and 120 may be fixed to the attachment point 118 with a suitable epoxy, glue, or it could be heat stamped upon creation of the stimulus indicating device 100. The attachment point 118 is preferably positioned at a point away from the indicator spot 116 and indicator window 112. Attaching the stimulus sensitive metal 110 and 120 to the attachment point 118 helps to ensure that as the crumpled stimulus sensitive metal 110 expands or uncrumples in a desired direction—preferably away from the attachment point 118, and toward the indicator spot 116 and toward the indicator window 112, the indicator spot 116 is at least partially if not fully covered upon exposure to a predetermined stimulus. Securing or fixing the stimulus sensitive metal 110 and 120 to the attachment point 118 prevents the stimulus sensitive metal 110 and 120 from floating or moving within the compartment and revealing the indicator spot 116 after the now uncrumpled stimulus sensitive metal 120 had undergone its phase transition, thereby preventing a false indication that the product attached to the stimulus indicator device 100 had not been exposed to a predetermined stimulus.

All embodiments discussed herein of the stimulus indicating device 100 containing the crumpled stimulus sensitive metal 110 and the uncrumpled stimulus sensitive metal 120 may be based on any type of stimulus sensitive metal that undergoes a phase transition upon exposure of the stimulus sensitive gel to a predetermined stimulus. The preferred types of stimulus sensitive metals include compositions made of Nickel-Titanium, which are commonly referred to as Niten or Nitenal, and/or their derivatives, such as Austenite and/or Martensite. Such stimulus sensitive metals are well known in the literature, such as in the publications offered by NDC (Nitinol Devices Corporation) located at 4733 Westinghouse Drive, Fremont, Calif. 94539, (510-623-6996), www.nitinol.com. Such publications include “Thermal Actuation With Shape Memory Alloys” by Dieter Stoeckel of Raychem Corporation (1989); as well as “Wide Hysteresis Shape Memory Alloys Based on the Ni—Ti—Nb System”, by K. N. Melton, J. L. Proft, T. W. Duerig, published by MRS Int'l Mtg on Adv. Mats. Vol. 9 copyrighted 1989 by the Materials Research Society, which are incorporated herein by reference.

By way of example only, it is known in the art that when the predetermined stimulus is temperature, the direction of the change in the stimulus sensitive metal 110 and 120 discussed herein can be selected so as to correlate to a specific situation. For example, one of ordinary skill will appreciate and understand that if the stimulus sensitive metal in this embodiment is collapsed or crumpled at the beginning of its use as it undergoes its phase transition, it will expand or uncrumple, thereby causing a change in indication or color in the stimulus indicator 100. Alternatively, the stimulus sensitive metal could start out expanded or uncrumpled, but upon exposure to its predetermined stimulus it would permanently collapse or crumple and cause a change in color or indication in the stimulus indicator 100.

It is important to note that the change in volume of the stimulus sensitive metal be tailored to the application in which the stimulus indicator is being used. For example, a change in the size of the stimulus sensitive metal 110 and 120, can be insignificant or it can be dramatic. If the desired visual indication is the result of the expanded or uncrumpled stimulus sensitive metal 110 completely expanding or uncrumpling over and thereby visually blocking the indicator spot 116 from view via the indicator window 112, then a large change in volume is preferred.

### Silica Only

In accordance with the purpose of the invention, as embodied and broadly described herein and in conjunction with FIG. 3A and FIG. 3B as well as FIG. 2A through FIG. 2F, this alternative embodiment of the inventive stimulus indicating device 300 preferably has a single compartment containing the swollen stimulus sensitive gel 310, and indicator spot 316 and absorbent material 305. Although this embodiment is described in terms of the stimulus sensitive gel preferably being initially swollen and preferably fully transparent (as the stimulus sensitive gel collapses or shrinks it becomes more opaque and at least partially blocks the view of an indicator spot below it), one of ordinary skill in the art would appreciate that the same invention can be achieved with an initially shrunken stimulus sensitive gel that is initially visually opaque but that expands or swells upon exposure to a predetermined stimulus so as to become at least partially if not fully transparent and reveal an indicator spot.

The single or first compartment 302 is formed by the backing layer 325 on the bottom of the stimulus indicating device 300 and an upper layer 326 on the top of the stimulus indicating device 300. The top layer 326 of the stimulus indicating device 300 is formed by at least the indicator window 312 and the top portion 308 of the top layer 326. The indicator spot 316 can be viewed through an indicator window 312 located in the top layer 326 of the stimulus indicating device 300 and then through the initially swollen and therefore preferably fully transparent stimulus sensitive gel 310.

As shown in FIG. 3A, prior to being exposed to a predetermined trigger stimulus, the swollen stimulus sensitive gel 310 has not yet undergone a phase transition and preferably allows the entire indicator spot 316 to be visible to the user. The indicator spot 316 is positioned below the indicator window 312, and is preferably completely visible through both the indicator window 312 and the swollen stimulus sensitive gel 310 prior to the stimulus indicating device 300 being exposed to the predetermined stimulus because the swollen stimulus sensitive gel 310 is swollen with a clear liquid and is therefore clear and transparent.

The swollen stimulus sensitive gel 310 contains fluid 314; which allows the swollen stimulus sensitive gel 310 to maintain its expanded or swollen volume, and consequently its visually transparent or clear appearance. When the swollen stimulus sensitive gel 310 is exposed to a predetermined stimulus, however, it undergoes its phase transition and the fluid 314 contained in the swollen stimulus sensitive gel 310 is expelled from the swollen stimulus sensitive gel 310 and enters the first compartment 302.

As discussed herein, this alternative embodiment of the stimulus indicating device 300 contains a stimulus sensitive gel 310 and 320 described herein in regard to FIG. 3A and FIG. 3B. As the stimulus sensitive gel is exposed to a predetermined stimulus, by way of example only a certain temperature, and it undergoes its phase transition by collapsing or shrinking in volume, it not only at least partially if not fully covers the indicator spot 316 previously visible through the display portion or indicator window 312 and through the previously transparent swollen stimulus sensitive gel 310, but it also expels the fluid 314 (by way of example only, water that can be trapped by absorbent material) from within the matrix of the swollen stimulus sensitive gel 310 and into the single compartment 302 of the stimulus indicator 300.

Upon exposure of the stimulus sensitive product to its predetermined phase transition stimulus, such as temperature, the swollen stimulus sensitive gel 310 would undergo its phase transition and collapse or shrink to become the shrunken stimulus sensitive gel 320 due to the loss of the fluid 314 contained in its matrix. As the swollen stimulus sensitive gel collapses or shrinks, it at least partially and preferably wholly covers and obscures the view of the indicator spot 316 previously visible through the indicator window 316, so that the indicator spot 312 is at least partially if not preferably fully hidden from the view of the user through the indicator window 312. The more the swollen stimulus sensitive gel 310 collapses or shrinks the more it collapses and covers and visually obscures or obfuscates the indicator spot 316, and the more it becomes like the collapsed or shrunken stimulus sensitive gel 320 in FIG. 3B. Such partial or preferably full covering or obfuscation of the indicator spot 316 by the collapse or shrinking of the swollen stimulus sensitive gel 310 to become the collapsed or shrunken stimulus sensitive gel 320 is the same for all variations of this embodiment discussed herein.

The swollen stimulus sensitive gel 310 can be made to undergo its phase transition when it is exposed to the proper or predetermined stimulus, such as and by way of example only, when it is heated or cooled to a designated temperature, depending on whether the polymer gel was of the LCST or UCST type. Regardless, as the swollen stimulus sensitive gel 310 collapses or shrinks, the fluid 314 (or other liquid or mixture) contained in the matrix of the swollen stimulus sensitive gel 310, is expelled. Consequently, as shown in FIG. 3A and FIG. 3B, the expelled liquid 315 would be absorbed by a suitable absorbent material 305 such as hygroscopic silica or another absorbent material that permanently binds to the expelled fluid 315 expelled from the swollen stimulus sensitive gel 310. The collapsing or shrinking of the swollen stimulus sensitive gel 310 (caused by the loss of the liquid 314 contained in the matrix of the swollen stimulus sensitive gel 310 when the swollen stimulus sensitive gel 310 undergoes its phase transition), thereby resulting in the shrunken stimulus sensitive gel 320 preferably collecting over the indicator spot 316 of the stimulus indicating device 300, would at least partially and preferably completely hide the colored indicator spot 316 previously visible through the indicator window 312 and through the swollen stimulus sensitive gel 310, thereby indicating to the user of the stimulus sensitive product that the product had been exposed to a harmful stimulus, such as an extreme temperature.

As one of ordinary skill in the art understands, stimulus sensitive gels, such as LCST and UCST, are opaque in not only their native pre-manufactured form, but also in their manufactured molded but unswollen form or state, It is only upon swelling with a clear liquid or fluid that the stimulus sensitive gels become transparent. Preferably the stimulus sensitive gel 310 and 320 would be undyed and thus transparent or “invisible” to the user of the stimulus indicating device 300 when the stimulus sensitive gel was initially in its expanded state 310, but as the swollen stimulus indicating gel 310 begins to collapse or shrink, the opaque quality of the shrunken stimulus sensitive gel 320 concentrates over the indicator spot 312 so as to at least partially if not completely block the view of the indicator spot 312 below it, thereby indicating to the user of the stimulus sensitive product that the product had been exposed to a harmful stimulus, such as an extreme temperature.

Preferably the stimulus sensitive gel 310 and 320 is manufactured so as to be free of coloring or dye particles. But in an alternative embodiment the stimulus sensitive gel 310 and 320 could contain colorant 311 that could be by way of example only, dye particles. Importantly, the colorant 311 would preferably be incorporated into the matrix of the stimulus sensitive gel 310 and 320. By incorporating the colorant 311 into the matrix of the stimulus sensitive gel 310 and 320, that colorant 311 could be used to enhance or accentuate the visual impact of the swollen stimulus gel 310 as it expelled the fluid 314 and becomes the shrunken stimulus sensitive gel 320. Because the colorant 311 is preferably incorporated into the matrix of the stimulus sensitive gel 310 and 320, it is not expelled from the swollen stimulus sensitive gel 310 when the swollen stimulus sensitive gel 310 collapses and becomes the shrunken stimulus sensitive gel 320. Instead, because the colorant 311 is incorporated into the matrix of the stimulus sensitive gel 310 and 320, as the swollen stimulus sensitive gel 310 shrinks and collapses the colorant 311 becomes concentrated within the stimulus sensitive gel 310 and 320 so as to make the shrunken stimulus sensitive gel 320 even more opaque and able to block, even partially, the view of the indicator spot 316.

Referring again to FIG. 3A and FIG. 3B, after exposure to the predetermined stimulus the shrunken stimulus sensitive gel 320 would remain permanently in its collapsed or shrunken state, even if the predetermined stimulus, such as temperature, were removed because the shrunken stimulus sensitive gel 320 would not come back into contact with the expelled fluid 315 because the expelled fluid 315 had been bound to and/or trapped by the absorbent material 305, thereby permanently preventing the shrunken stimulus sensitive gel 320 from expanding back to its original volume once the predetermined stimulus had been removed. Thus, the shrunken stimulus sensitive gel 320 is permanently prevented from expanding back to original volume because either the absorbent material 305 has a stronger affinity for the expelled fluid 314 than the shrunken stimulus sensitive gel 320, or because the absorbent material would not physically touch the shrunken or collapsed stimulus sensitive gel 320. Either way the absorbent material 305, which is for example a silica gel such as hygroscopic silica 305 or an equivalent absorbent material that has an affinity for and permanently and irreversibly bonds to and traps the expelled fluid 315, which would be expelled from the swollen stimulus sensitive 310 as it collapsed or shrunk. By permanently trapping the expelled fluid 315 in the absorbent material 305, the shrunken stimulus sensitive gel 320 would be permanently prevented from expanding or swelling and re-covering the indicator spot 316, even when the predetermined stimulus condition is removed.

It should be noted that the predetermined temperature discussed herein that causes the swollen stimulus sensitive gel 310 to undergo its phase transition is only one example of a predetermined stimulus or trigger stimulus that will cause the inventive stimulus sensitive gel 310 and 320 to undergo its phase transition. For example, the swollen stimulus sensitive gel 310 of this alternative embodiment could trigger or undergo its phase transition upon exposure to a predetermined stimulus such as a predetermined pH level, or the swollen stimulus sensitive gel 310 of this alternative embodiment could trigger or undergo its phase transition upon exposure to a predetermined level of electromagnetic radiation.

As the expelled fluid 315 leaves the swollen stimulus sensitive gel 310, the swollen stimulus sensitive gel 310 collapses or shrinks in volume, so as to result in the shrunken stimulus gel 320 shown in FIG. 3B. As shown in FIG. 3B, as the swollen stimulus sensitive gel 310 collapses or shrinks in volume, it preferably moves towards the attachment point 318, and in a direction toward the indicator spot 316 and indicator window 312. Thus, by decreasing the volume of the swollen stimulus sensitive gel 310 to result in the shrunken stimulus sensitive gel 320, the indicator spot 316 becomes preferably fully covered and not visible to the user through the indicator window 312 because of the shrunken stimulus sensitive gel 320 hiding the indicator spot 316 from the user through the indicator window 312.

It should be noted that it is not necessary for the swollen stimulus sensitive gel 310 to collapse or shrink entirely, in order for the indicator spot 316 to be less visible to the user. Instead, if even a portion of the indicator spot 316 is covered from the view of the user through the indicator window 312, it is enough to signal to the user that the product attached to the stimulus indicating device 300 had been exposed to a potentially harmful stimulus. More specifically, although the decrease in volume of the swollen stimulus sensitive gel 310 in all of the embodiments of the stimulus indicating device 300 discussed herein containing a stimulus sensitive gel can be by any amount so long as it is registerable, preferably the decrease in volume of the swollen stimulus sensitive gel 310 would be between at least a 1/10 reduction in original volume, and up to a 500 times decrease in original volume. In regard to all embodiments of the stimulus indicating device 300 discussed herein as they pertain to the decrease in the volume being “registerable” what is meant is that the volume change of the swollen stimulus sensitive gel 310 expels enough liquid 314 from the swollen stimulus sensitive gel 310 so as to cause the swollen stimulus sensitive gel 310 to collapse or shrink enough so that it becomes opaque enough to block the view of the indicator spot 316.

By way of example only, the indicator spot 316 (e.g., an indicator spot 316 that is the same color as the stimulus sensitive gel 310 and 320 but is a glyph, such as a happy face “ [symbol] ”) would be visible through the indicator window 312 and through the swollen stimulus sensitive gel 310 because of the transparency of the swollen stimulus sensitive gel 310 due to the unexpelled fluid 314 contained in the swollen stimulus sensitive gel 310. As the fluid 314 is expelled there is an increase in the opacity of an undyed collapsed or shrunken stimulus sensitive gel 320 that serves to provide an indication of exposure because it blocks the view of the indicator spot 316 (e.g., an indicator spot 316 that is the same color as the stimulus sensitive gel 310 and 320 but is a glyph, such as a happy face ( [symbol] ), which is at least partially and preferably fully covered from the view of the user through the indicator window 312, and indicates to the user that the product had been exposed to a predetermined stimulus.

Alternatively, the collapsing of a swollen stimulus sensitive gel 310 that contains colorant 311 also obscures the view of the indicator spot 316 because the shrinking or collapsing swollen stimulus sensitive gel 310 cause the colorant 311 to concentrate over the indicator spot 316 thereby resulting in a registerable change in color (e.g., as shown in FIG. 2A and FIG. 2B, a change in color from a first color to a second color).

Of course, one of ordinary skill in the art understands the reverse is true, such that a shrunken stimulus sensitive gel 320 is employed that initially hides or obscures the indicator spot 316, but upon exposure to a predetermined stimulus the shrunken stimulus sensitive gel 320 absorbs water and expands or swells enough so as to become the swollen stimulus sensitive gel 310 so that it reveals at least a portion or enough of the indicator spot 316 so that a registerable indication or change in color (e.g., revealing the glyph of the indicator spot 316, or a change in color from a first color to a second color, respectively) occurs in the stimulus indicating device 300, and is visible via the indicator window 312.

In regard to all the embodiments of the stimulus indicating device discussed herein being “irreversible” and “permanent,” what is meant is that once the stimulus indicating device provides an indication of exposure to an adverse stimulus extreme (which is also referred to herein as a predetermined stimulus), that indication of exposure does not change, even though the adverse stimulus extreme or predetermined stimulus might be removed in the future.

Both the backing layer 325 and the upper layer 326 may be constructed of a strong, resilient leak-proof material, such as plastic or other polymer material, so as to provide for the twisting or bending that might occur during transportation of or application to the stimulus sensitive product without tearing, breaking or leaking. The backing layer 325 and the upper layer 326 may also be made of a material that preferably allows them to be joined and sealed together, such as by heat stamping or other suitable means. The backing layer 325 and the upper layer 326 can both approximate the length and width of the first compartment 302, although variations in these dimensions are within the scope of the present invention. The upper layer 326 can preferably be made of a clear material, such as plastic, so that the user of the stimulus indicating device 300 can view at least some portion of the backing material or indicator spot 116. The upper layer 326 can also be able to accept paint or ink so as to allow for coloring or concealing at least some portion of the first compartment 302.

Although some portion of the upper layer 326 can also accept paint or ink for coloring, it is preferable that the indicator window 312 portion of the upper layer 326 remain free from ink or coloring so that the user of the stimulus indicating device 300 can observe the first compartment 302 through the indicator window 312 as explained herein.

The stimulus sensitive gel 310 and 320 employed by the alternative variations of this embodiment, as shown in FIG. 3A and FIG. 3B, is preferably manufactured so as to not contain a dye or colorant because although a swollen stimulus sensitive gel 310 is transparent, when it expels its fluid and becomes a shrunken stimulus sensitive gel 320, it becomes visually cloudy or opaque. Thus, when the swollen stimulus sensitive gel 310 collapses or shrinks in response to the predetermined stimulus, by even a partial amount, the change or decrease in volume will result in the stimulus indicating device 300 changing, at least partially, from transparent to at least partially cloudy or opaque, because the stimulus sensitive gels discussed herein naturally become more cloudy or opaque and non-transparent as they shrink or collapse by even a partial amount.

Although it is preferred that the stimulus sensitive gel 310 and 320 is manufactured to not contain a colorant 311 an alternative embodiment of the stimulus sensitive gel 310 and 320 could contain a colorant 311 such as dye particles, it is preferred that the dye particles or colorant be different from the color of the indicator spot 316. In this way the color of the stimulus sensitive gel 310 and 320 in both its swollen and collapsed state, is different from the color of the indicator spot 316. Thus, when the swollen stimulus sensitive gel 310 collapses or shrinks in response to the predetermined stimulus, by even a partial amount, the change or decrease in volume will result in the stimulus indicating device 300 changing, at least partially, from a first color to a second color, wherein the color change is visible to the user of the stimulus indicating device 300 through the indicator window 312. It should be noted that if the stimulus sensitive gel 310 and 320 does contain a colorant 311, when the stimulus sensitive gel is in its swollen state (i.e., the swollen stimulus sensitive gel 310), the concentration of colorant 311 contained in the swollen stimulus sensitive gel 310 should be either: i) minimal enough so that the swollen stimulus sensitive gel 310 preferably still appears transparent; or ii) of such a concentration that while it provides a minimal hue or coloring to the swollen stimulus sensitive 310, that hue or coloring is not so intense so as to obscure the user from viewing the coloring or shape of the indicator spot through the swollen stimulus sensitive gel 310. Regardless, as the swollen stimulus sensitive gel 310 does begin to shrink and expel its fluid, the colorant 311 (because its particles are embedded in the matrix of the stimulus sensitive gel) are not expelled from the gel matrix. Instead, the colorant 311 would concentrate over the indicator spot 316 as the swollen stimulus sensitive gel 310 shrank or collapsed, so as to aid in the covering and/or blocking the view of the indicator spot 316.

Although the preferred version of this alternative embodiment contains a stimulus sensitive gel 310 and 320 that lacks any dye or colorant, alternative versions of the stimulus sensitive gel 310 and 320 of this alternative embodiment of the stimulus indicating device 300 can be colored and can be combined in conjunction with all the embodiments shown in FIG. 2A through FIG. 2J to disclose to the user of the stimulus indicating device 300 that the product to which it is attached had been exposed to a predetermined stimulus.

More particularly, as shown in FIG. 2A and FIG. 2B in conjunction with FIG. 3A and FIG. 3B, by coloring the stimulus sensitive gel 210 and 220 a different color than the indicator spot 216 as well as making the swollen stimulus sensitive gel 210 transparent enough so as to allow the indicator spot 216 to be viewed by the user through the swollen stimulus sensitive gel 210, the shrunken stimulus sensitive gel 220 can hide that indicator spot 216 from the view of the user after being exposed to the predetermined trigger stimulus. By way of example only, as shown in FIG. 2A and FIG. 2B in conjunction with FIG. 3A and FIG. 3B, the swollen stimulus sensitive gel 210 may contain a suitable colorant 211, such as dye particles or color additive such as red. When that red colored swollen stimulus sensitive gel 210 is viewed pre-phase transition through the indicator window 212, such as in FIG. 2A, it is so transparent that the user of the stimulus indicating device sees right through the swollen stimulus sensitive gel 210 containing the red colorant 211 because the colorant 211 is so diffused within the swollen stimulus sensitive gel 210 that the user does not even see the red coloring, but instead only sees the indicator spot. As discussed herein, that indicator spot could be colored (e.g., colored green) or it could contain a glyph (e.g., a “ [symbol] ” or happy face) that informs the user (perhaps in conjunction with a legend or color key) that the product attached to the stimulus indicating device 200 had not been exposed to a potentially harmful stimulus. But as shown in FIG. 2A and FIG. 2B in conjunction with FIG. 3A and FIG. 3B, because the colorant 311 contained in the swollen stimulus sensitive gel 210 is a different color than the indicator spot 216 (which by way of example only could be colored green), once the swollen stimulus sensitive gel 210 undergoes its phase transition and collapses or shrinks even partially, the indicator spot 216 is at least partially covered by the colored but at least partially collapsed or shrunken stimulus sensitive gel 220. In this way the user is warned that the product attached to the stimulus indicating device 200 had been exposed to a potentially harmful stimulus.

In an alternate embodiment shown in FIG. 2C and FIG. 2D in conjunction with FIG. 3A and FIG. 3B, if the swollen stimulus sensitive gel 210 is thin enough, when the swollen stimulus sensitive gel 210 is positioned over the indicator spot 216, the color of the swollen stimulus sensitive gel 210 in combination with the color of the indicator spot 216 could result in a third color. By way of example only, if as shown in FIG. 2C, prior to exposure to a predetermined stimulus the swollen stimulus sensitive gel 210 contained a blue colorant 311, and the indicator spot 216 were colored yellow, and if the swollen stimulus sensitive gel 210 were thin enough, the combination of the two colors would result in the creation of a third color—green. But upon exposure to the predetermined stimulus, as shown in FIG. 2D, the swollen stimulus sensitive gel 210 would shrink and collapse so that the shrunken stimulus sensitive gel 220 would be so opaque because of the blue colorant 211, the shrunken stimulus sensitive gel 220 would block the view of at least some portion of the indicator spot 216. Thus, even though the stimulus indicating device 200 could potentially show: i) only green prior to exposure to the predetermined stimulus; ii) only blue after exposure to the predetermined stimulus; or iii) some combination thereof, such potential colors are irrelevant because the stimulus indicating device 200 would definitively indicate that the stimulus sensitive product to which it is attached had been exposed to a predetermined stimulus.

In an alternative embodiment of the present invention, as shown in FIG. 2E and FIG. 2F in conjunction with FIG. 3A and FIG. 3B, the stimulus sensitive gel 210 and 220 can contain a colorant 311 that is the same color as the indicator spot 216. By way of example only, as shown in FIG. 2E, the swollen stimulus sensitive gel 210 would be transparent enough even with the colorant 211, that the indicator spot 216 (which is preferably a glyph, such as a happy face “ [symbol] ”) would be visible through both the indicator window 212 and the swollen stimulus sensitive gel 210. Moreover, the concentration of the colorant 211 does not need to be overly concentrated so as to be so opaque that it creates a new color. Instead, all the shrunken stimulus sensitive gel 220 needs to accomplish is to match the color of the indicator spot 216. Thus, the visual impression through the indicator window 212 of the shrunken stimulus sensitive gel 220 in conjunction with the indicator spot 216 after exposure to the predetermined stimulus, simply needs to appear uniform in color so that the indicator spot 216 cannot be discerned through the shrunken stimulus sensitive gel 220. Because in this alternate version of the alternative embodiment, the shrunken stimulus sensitive gel 220 and the indicator spot 216 are the same color, as shown in FIG. 2F the indicator spot 216 is preferably a design or glyph (by way of example only, an “ [symbol] ” or a happy face prior to exposure to the predetermined stimulus) that, once covered due to the shrunken stimulus sensitive gel 220 covering the indicator spot 216 visible through the indicator window 212, the stimulus indicating device 200 will warn the user that the product attached to it had been exposed to a potentially harmful stimulus.

As shown in FIG. 3A and FIG. 3B, the stimulus sensitive gel 310 and 320 would preferably be fixed or secured at the attachment point 318, or at more than one attachment point if desired. The stimulus sensitive gel 310 and 320 may be fixed to the attachment point 318 with a suitable epoxy, glue, or it could be heat stamped upon creation of the stimulus indicating device 300. The attachment point 318 is preferably positioned at a point close to the indicator spot 316 and indicator window 312. Attaching the stimulus sensitive gel 310 and 320 to the attachment point 318 helps to ensure that as the swollen stimulus sensitive gel 310 collapses or shrinks in a desired direction—preferably toward the attachment point 318, and toward the indicator spot 316 and toward the indicator window 312. Securing or fixing the stimulus sensitive gel 310 and 320 to the attachment point 318 prevents the stimulus sensitive gel 310 and 320 from floating or moving within the compartment and revealing the indicator spot 316 after the swollen stimulus sensitive gel 310 had undergone its phase transition, thereby preventing a false indication that the product attached to the stimulus indicator device 300 had not been exposed to a predetermined stimulus.

All embodiments discussed herein of the stimulus indicating device 300 containing the swollen stimulus sensitive gel 310 and the shrunken stimulus sensitive gel 320 may be based on any type of stimulus sensitive gel that undergoes a phase transition upon exposure of the stimulus sensitive gel to a predetermined stimulus.

By way of example only, the stimulus indicating device 300 can be manufactured using stimulus sensitive gels that include polyacrylic acid (PAA) gel, a polyacrylamide (PAAm) gel, and/or its variations such as poly(N-isopropylacrylamide) (PNIPAAm) gels, and/or their derivatives. As is known in the art, such stimulus sensitive gels and/or other equivalent gels and/or their derivatives, undergo a significant change in volume in response to a range of stimuli, including temperature, solvent composition, pH, ionic strength, etc.

By way of example only, it is known in the art that when the predetermined stimulus is temperature, the direction of the volume change in the stimulus sensitive gel 310 and 320 used in all the embodiments of the stimulus indicating device 300 discussed herein can be selected so as to correlate to a specific situation. For example, one of ordinary skill will appreciate and understand that if the stimulus sensitive gel in this embodiment is swollen at the beginning of its use as it undergoes its phase transition, it will collapse or shrink, thereby causing a change in indication or color in the stimulus indicator 300. Alternatively, the stimulus sensitive gel could start out collapsed or shrunken, but upon exposure to its predetermined stimulus it would permanently expand or swell and cause a change in color or indication in the stimulus indicator 300. By way of example only and as disclosed herein and in prior applications, a stimulus sensitive gel 310 and 320 can be of the UCST type gel or the LCST type gel.

As one of ordinary skill in the art will appreciate, a UCST type stimulus sensitive gel, such as PAAm gels, could be used when one wishes to have an initially swollen and transparent or at least somewhat visually clear swollen stimulus sensitive gel collapse or shrink when cooled below a predetermined or trigger temperature and thereby: i) expel liquid; ii) so as to become at least partially opaque; and/or iii) at least partially, if not preferably fully, cover an indicator spot 316 and block its view by the user. By employing these characteristics, the stimulus indicating device 300 will result to provide a change in color or some other indication of exposure to a predetermined stimulus. A UCST type gel could also be used when one wishes to have the reverse characteristics, i.e., an initially shrunken stimulus sensitive gel that expands or swells when it is heated beyond a predetermined stimulus, and thereby: i) collect liquid; ii) so as to become at least partially transparent, and/or iii) at least partially if not fully reveal the indicator spot so as to result in a change in color or some other indication.

Alternatively, an LCST type stimulus sensitive gel, such as PNIPAAm gels, could be used when one wishes to have an initially swollen and transparent stimulus sensitive gel collapse or shrink when heated above a predetermined or trigger temperature and thereby: i) expel liquid; ii) so as to become at least partially opaque; and/or iii) at least partially, if not preferably fully, cover an indicator spot and block its view by the user. By employing these characteristics, the stimulus indicating device 300 will result to provide a change in color or some other indication of exposure to a predetermined stimulus. An LCST type gel could also be used when one wishes to have the reverse characteristics, i.e., an initially shrunken stimulus sensitive gel that expands or swells when it is cooled below a predetermined stimulus, and thereby: i) collect liquid; ii) so as to become at least partially transparent; and iii) at least partially if not preferably fully reveal the indicator spot so as to result in a change in color or some other indication.

One of ordinary skill in the art will understand that although the stimulus sensitive gel 310 and 320 discussed herein in regard to the stimulus indicating device 300 may be of the LCST type of gel (i.e., the initially swollen stimulus sensitive gel 310 will collapse or shrink upon exposure to its predetermined stimulus of a warmer temperature, and become the shrunken stimulus sensitive gel 320; as well as expand or swell upon exposure to its predetermined stimulus of a cooler temperature, and become the swollen stimulus sensitive gel 310), the range and scope of this invention includes and envisions the swollen stimulus sensitive gel 310 and the shrunken stimulus sensitive gel 320 also being of the USCT type of gel. Moreover, it should be noted that all the variations of the different embodiments discussed herein can be combined with the variations of other embodiments described herein and that are known in the art, as would be understood to one of ordinary skill in the art.

The behavior of the USCT gels and the LCST gels depends on their chemical structure. Many examples of both kinds of polymers are known in the literature. For example, if the stimulus sensitive gel 310 and 320 employed in all the embodiments of the stimulus indicating device 300 discussed herein were made of USCT type stimulus sensitive gels, it could be any number of such USCT gels, including: i) polyacrylic acid (PAA) gel combined with polyacrylamide (PAAm) gel; or ii) PAAm gel combined with poly sodium 3-butenoate (SB) gel to result in the creation of poly(AAm-co-SB) gel; or iii) their derivates, and as described in Tanaka, “Gels,” Scientific American 244 (1981) at 124-138 and Tanaka, “Phase Transitions in Ionic Gels,” Physical Review Letters 45 (1980) at 1636-1639, wherein the predetermined “trigger” stimulus at which a USCT gel undergoes its phase transition, and thereby expels the liquid 314 and thus collapses or shrinks in volume, can be “tuned” to a particular value by changing the solvent trapped in the gel polymer matrix in addition to introducing salts, surfactants, or other substances to the gel matrix. Such “tuning” in regard to UCST type gels is discussed herein and in U.S. Pat. No. 5,100,933.

Similarly, if the stimulus sensitive gel 310 and 320 employed in all the embodiments of the stimulus indicating device 300 discussed herein were made of LSCT type stimulus sensitive gels, it could be any number of such LCST gels, including PNIPAAm gels, and as described in U.S. Pat. No. 4,732,930 in regard to PNIPAAm LCST type gels, the predetermined stimulus, such as temperature at which a stimulus sensitive gel 310 and 320 undergoes its phase transition and changes volume, can be “tuned” to a particular value by adding salts, surfactants, or other substances to the gel matrix. Explanations of how the transition temperature of an LCST gel can be tuned can be found in the following references: Zhang et al., “Specific Ion Effects on the Water Solubility of Macromolecules: PNIPAM and the Hofineister Series” Journal of the American Chemical Society volume 127 at 14505 to 14510 and Park et al., “Sodium Chloride-Induced Phase Transition in Nonionic Poly(N-isopropylacrylamide) Gel” Macromolecules volume 26 at 5045 to 5048.

Regardless of whether LCST type stimulus sensitive gels or USCT type stimulus sensitive gels are used to indicate exposure to a predetermined stimulus, what is important is that the change in volume of the stimulus sensitive gel be tailored to the application in which the stimulus indicator is being used. For example, a change in volume of the stimulus sensitive gel 310 and 320, and thus the corresponding expulsion of liquid 314 can be insignificant or it can be dramatic. If the desired visual indication is the result of the swollen stimulus sensitive gel 310 completely collapsing and collecting over and thereby visually blocking the indicator spot 316 from view via the indicator window 312, then a large change in volume is preferred.

### Permeable Membrane

In accordance with the purpose of the invention, as embodied and broadly described herein and in conjunction with FIG. 4A and FIG. 4B as well as in conjunction with FIG. 2A through 2F, another alternative embodiment of the inventive stimulus indicating devices described herein has at least two compartments which contain initially in the first compartment 402 a preferably swollen stimulus sensitive gel 410 and an indicator spot 416 positioned under the swollen stimulus sensitive gel 410, and preferably contains in the second compartment 404 an absorbent material 407, which would be any substance that could absorb the fluid 414 contained in and then expelled by the swollen stimulus sensitive gel 410 as it collapses or shrinks, but that also permanently prevents the then shrunken stimulus sensitive gel 420 from re-expanding or re-swelling, and thereby prevents the then shrunken stimulus sensitive gel 420 from re-revealing the indicator spot 416 once it was hidden by the shrunken stimulus sensitive gel 420. Although this embodiment is described in terms of the stimulus sensitive gel preferably being initially swollen and preferably fully transparent (as the stimulus sensitive gel collapses or shrinks it becomes more opaque and at least partially blocks the view of an indicator spot 416 below it, as discussed herein in regard to stimulus sensitive gels, one of ordinary skill in the art would appreciate that the same invention can be achieved with an initially shrunken stimulus sensitive gel that is initially visually opaque but that expands or swells upon exposure to a predetermined stimulus so as to become at least partially if not fully transparent and reveal an indicator spot.

The first compartment 402 and second compartment 404 are formed in part by the backing layer 425 on the bottom of the stimulus indicating device 400, and an upper layer 426 on the top of the stimulus indicating device 400. The top layer 426 of the stimulus indicating device 400 is formed by at least the indicator window 412 and the top portion 408 of the top layer 426. The indicator spot 416 can be viewed through an indicator window 412 located in the top layer 426 of the stimulus indicating device 400. The first compartment 402 and the second compartment 404 are additionally formed and differentiated from one another by a permeable membrane 430. The permeable membrane 430 is designed to allow the expelled fluid 414 to pass from the first compartment 402 into the second compartment 404, as well as from the second compartment 404 into the first compartment 402.

Alternatively, as shown in FIG. 4C an alternate embodiment could position the first compartment 402 above the second compartment 404 separated by the permeable membrane 430. Other shapes are contemplated within the scope of the invention as would be understood by one of ordinary skill in the art and/or as previously described in prior applications.

Prior to being exposed to a predetermined trigger stimulus, the swollen stimulus sensitive gel 410 has not yet undergone a phase transition and preferably allows the entire indicator spot 416 to be visible to the user. The indicator spot 416 is positioned below the indicator window 412, and is preferably completely visible through both the indicator window 412 and the swollen stimulus sensitive gel 410 prior to the stimulus indicating device 400 being exposed to the predetermined stimulus because the swollen stimulus sensitive gel 410 is swollen with a clear liquid and is therefore clear and transparent. The swollen stimulus sensitive gel 410 contains fluid 414, which allows the swollen stimulus sensitive gel 410 to maintain its expanded or swollen volume, and consequently its visually transparent or clear appearance. When the swollen stimulus sensitive gel 410 is exposed to a predetermined stimulus, however, it undergoes its phase transition and the fluid 414 contained in the swollen stimulus sensitive gel 410 is expelled from the swollen stimulus sensitive gel 410 and enters the first compartment 402.

As discussed herein, this alternative embodiment of the stimulus indicating device 400 contains a stimulus sensitive gel 410 and 420 described herein in regard to FIG. 4A and FIG. 4B. As the stimulus sensitive gel is exposed to a predetermined stimulus, by way of example only a certain temperature, and it undergoes its phase transition by collapsing or shrinking in volume, it not only at least partially if not fully covers the indicator spot 416 previously visible through the display portion or indicator window 412 and through the previously transparent swollen stimulus sensitive gel 410, but it expels the fluid 414 (by way of example only, water that can be trapped by an absorbent material) from within the matrix of the swollen stimulus sensitive gel 410 into the compartment 402 of the stimulus indicator 400.

Upon exposure of the stimulus sensitive product to its predetermined phase transition stimulus, such as temperature, the swollen stimulus sensitive gel 410 would undergo its phase transition and collapse or shrink to become the shrunken stimulus sensitive gel 420 due to the loss of the fluid 414 contained in its matrix. As the swollen stimulus sensitive gel collapses or shrinks, it at least partially and preferably wholly covers or obscures the view of the indicator spot 416, so that the indicator spot 416 is at least partially if not preferably fully hidden from the view of the user through the indicator window 412. The more the swollen stimulus sensitive gel 410 collapses or shrinks the more it collapse and covers and visually obscures or obfuscates the indicator spot 416, and the more it becomes like the collapsed or shrunken stimulus sensitive gel 420 in FIG. 4B. Such partial or full covering or obfuscation of the indicator spot 416 by the collapsing or shrinking of the swollen stimulus sensitive gel 410 to become the collapsed or shrunken stimulus sensitive gel 420 is the same for all variations of this embodiment discussed herein.

Also, as the stimulus sensitive gel 410 collapses or shrinks in response to the predetermined stimulus, the expelled fluid 415 expelled from the swollen stimulus sensitive gel 410 is expelled into the first compartment 402, and passes into the second compartment 404 though the permeable membrane 430 that separates the at least two compartments 402 and 404.

Because the permeable membrane 430 separating the at least first compartment 402 and second compartment 404 allows the expelled fluid 414 to pass in both directions, the expelled fluid 415 could subsequently pass back from the second compartment 430 into the first compartment 402. And when the predetermined stimulus is removed, the shrunken stimulus sensitive gel 410 would then have the ability to reabsorb the previously expelled fluid 415 once the predetermined stimulus is removed, thereby expanding or swelling to its original or near original volume. In doing so, the now re-swollen stimulus sensitive gel 410 could re-reveal the indicator spot 416. Accordingly, the second compartment 404 preferably contains an absorbent material 407 that has an affinity for the expelled fluid 415 (as described herein or as understood in the art), that permanently binds to and or traps the expelled fluid 414 in the second compartment 404. By way of example only, if the expelled fluid 414 were water, the absorbent material 407 could be a silica gel, such as hygroscopic silica or another absorbent material that permanently binds to the expelled fluid 414 expelled from the swollen stimulus sensitive gel 410.

Trapping the expelled fluid 414 in the second compartment 404 with the absorbent material 407 results in a constant or fixed volume of liquid 414 and shrunken stimulus sensitive gel 420 in the first compartment 404 from that point forward. Because the volume of liquid 414 and shrunken stimulus sensitive gel 420 in the first compartment 402 is fixed due to the expelled fluid 414 being trapped in the second compartment 404 by the absorbent material 407, the collapsed or shrunken stimulus sensitive gel 420 is permanently prevented from re-expanding and re-revealing the indicator spot 416 even when the predetermined stimulus condition is removed. In this way the stimulus indicating device 400 will permanently show that it, and the stimulus sensitive product attached to it, had been exposed to a deleterious predetermined stimulus.

It should be noted that by manipulating the permeability of the permeable membrane 430 connecting the first compartment 402 to the second compartment 404, the time required for expelled fluid 414 to move from the second compartment 404 into the first compartment 402 can be varied. Such manipulation of the permeable membrane 430 includes increasing or decreasing its thickness and/or increasing or decreasing its surface area facing the first compartment 402 and/or second compartment 404 and/or increasing or decreasing its wicking ability, so as to control the speed at which the expelled fluid 415 travels from the first compartment 402, through the permeable membrane 430, and enters the second compartment 404 or visa versa.

An advantage of using such an alternative embodiment of the stimulus indicating device 400 is that both the exposure to a predetermined stimulus as well as the cumulative time of exposure can be indicated. As an example, if the predetermined stimulus occurs for just a short period of time, and is removed before the expelled fluid 414 has completely moved from the first compartment 402 through the permeable membrane 430 and into the second compartment 404, then the expelled fluid 415 will be wicked or drawn back into the first compartment 404 by and into the shrunken stimulus sensitive gel 420 as the shrunken stimulus sensitive gel 420 re-expands or swells as a result of undergoing its reverse phase transition, (i.e., removing the predetermined stimulus). The reason this happens is because the permeable membrane 430 allows the expelled liquid 415 to pass into both directions. And so in this case, no irreversible indication of exposure to the predetermined stimulus will be indicated by the stimulus indicating device 400 because the time of exposure to the predetermined stimulus was too brief to enable enough expelled fluid 415 to pass completely through the permeable membrane 430, be bound by the absorbent material 407, and cause the stimulus indicating device 400 to change from a first indication to a second indication.

The swollen stimulus sensitive gel 410 can be made to undergo its phase transition when it is exposed to the proper or predetermined stimulus, such as and by way of example only, when it is heated or cooled to a designated temperature, depending on whether the polymer gel was of the LCST or UCST type. Regardless, as the swollen stimulus sensitive gel 410 collapses or shrinks, the fluid 414 (or other liquid or mixture) contained in the matrix of the swollen stimulus sensitive gel 410, is expelled. Consequently, as shown in FIG. 4A and FIG. 4B, the expelled fluid 414 would be absorbed by a suitable absorbent material 407, such as hygroscopic silica or another absorbent material in the second compartment 404 that permanently binds to the expelled fluid 415 expelled from the stimulus sensitive gel 410.

The collapsing or shrinking of the swollen stimulus sensitive gel 410 (caused by the loss of the liquid 414 contained in the matrix of the swollen stimulus sensitive gel 410 when the swollen stimulus sensitive gel 410 undergoes its phase transition), thereby resulting in the shrunken stimulus sensitive gel 420 preferably collecting over the indicator spot 416 of the stimulus indicating device 400, would at least partially and preferably completely hide the colored indicator spot 416 previously visible through the indicator window 412 and through the swollen stimulus sensitive gel 410, thereby indicating to the user of the stimulus sensitive product that the product had been exposed to a harmful stimulus, such as an extreme temperature.

By way of example only, prior to exposure to a deleterious stimulus such as temperature, the indicator spot 416 could be a happy face [symbol] or be simple green circle, which would indicate to the user that the stimulus sensitive product attached to the stimulus indicating device 400 was undamaged and still viable. But upon being exposed to a deleterious stimulus, the swollen stimulus sensitive gel 410 would shrink and partially, if not preferably fully cover, the indicator spot 416.

As one of ordinary skill in the art understands, stimulus sensitive gels, such as LCST and UCST, are opaque in not only their native pre-manufactured form, but also in their manufactured molded but unswollen form or state, It is only upon swelling with a clear liquid or fluid that the stimulus sensitive gels become transparent. Preferably the stimulus sensitive gel 410 and 420 would be undyed and thus transparent or “invisible” to the user of the stimulus indicating device 400 when the stimulus sensitive gel was initially in its expanded state 410, but as the swollen stimulus indicating gel 410 begins to collapse or shrink, the opaque quality of the shrunken stimulus sensitive gel 420 concentrates over the indicator spot 412 so as to at least partially if not completely block the view of the indicator spot 412 below it, thereby indicating to the user of the stimulus sensitive product that the product had been exposed to a harmful stimulus, such as an extreme temperature.

Preferably the stimulus sensitive gel 410 and 420 is manufactured so as to be free of coloring or dye particles. But in an alternative embodiment the stimulus sensitive gel 410 and 420 could contain colorant 411 that could be by way of example only, dye particles. Importantly, the colorant 411 would preferably be incorporated into the matrix of the stimulus sensitive gel 410 and 420. By incorporating the colorant 411 into the matrix of the stimulus sensitive gel 410 and 420, that colorant 411 could be used to enhance or accentuate the visual impact of the swollen stimulus gel 410 as it expelled the fluid 414 and becomes the shrunken stimulus sensitive gel 420. Because the colorant 411 is preferably incorporated into the matrix of the stimulus sensitive gel 410 and 420, it is not expelled from the swollen stimulus sensitive gel 410 when the swollen stimulus sensitive gel 410 collapses and becomes the shrunken stimulus sensitive gel 420. Instead, because the colorant 411 is incorporated into the matrix of the stimulus sensitive gel 410 and 420, as the swollen stimulus sensitive gel 410 shrinks and collapses the colorant 411 becomes concentrated within the stimulus sensitive gel 410 and 420 so as to make the shrunken stimulus sensitive gel 420 even more opaque and able to block, even partially, the view of the indicator spot 416.

Referring again to FIG. 4A and FIG. 4B, after exposure to the predetermined stimulus, the shrunken stimulus sensitive gel 420 would remain permanently in its collapsed or shrunken state, even if the predetermined stimulus, such as temperature, were removed because the shrunken stimulus sensitive gel 420 would not come back into contact with the expelled fluid 415 because the expelled fluid 415 had been bound to and/or trapped by the absorbent material 407, thereby permanently preventing the shrunken stimulus sensitive gel 420 from expanding back to its original volume once the predetermined stimulus had been removed. Thus, the shrunken stimulus sensitive gel 420 is permanently prevented from expanding back to original volume because either the absorbent material 407 has a stronger affinity for the expelled fluid 415 than the shrunken stimulus sensitive gel 420, or because the absorbent material would not physically touch the shrunken stimulus sensitive gel 420. Either way the absorbent material, which is for example a silica gel such as hygroscopic silica 407 or an equivalent absorbent material that has an affinity for and that permanently binds to the expelled fluid 415, which would be expelled from the swollen stimulus sensitive 410 as it collapsed or shrunk. By permanently trapping the expelled fluid 415 in the absorbent material 405, the shrunken stimulus sensitive gel 420 would be permanently prevented from expanding or swelling and re-revealing the indicator spot 416, even when the predetermined stimulus condition is removed.

It should be noted that the predetermined temperature discussed herein that causes the swollen stimulus sensitive gel 410 to undergo its phase transition is only one example of a predetermined stimulus or trigger stimulus that will cause the inventive stimulus sensitive gel 410 and 420 to undergo its phase transition. For example, the swollen stimulus sensitive gel 410 of this alternative embodiment could trigger or undergo its phase transition upon exposure to a predetermined stimulus such as a predetermined pH level, or the swollen stimulus sensitive gel 410 of this alternative embodiment could trigger or undergo its phase transition upon exposure to a predetermined level of electromagnetic radiation.

As the expelled fluid 415 leaves the swollen stimulus sensitive gel 410, the swollen stimulus sensitive gel 410 collapses or shrinks in volume, so as to result in the shrunken stimulus gel 420 shown in FIG. 4B. As shown in FIG. 4B, as the swollen stimulus sensitive gel 410 collapses or shrinks in volume, it preferably moves towards the attachment point 418, and in a direction toward the indicator spot 416 and indicator window 412. Thus, by decreasing the volume of the swollen stimulus sensitive gel 410 to result in the shrunken stimulus sensitive gel 420, the indicator spot 416 becomes preferably fully covered and not visible to the user through the indicator window 412. Thus, as the volume of the swollen stimulus sensitive gel 410 decreases it begins to resemble the shrunken stimulus sensitive gel 420, and hides the indicator spot 416 from the user through the indicator window 412.

It should be noted that it is not necessary for the swollen stimulus sensitive gel 410 to collapse or shrink entirely in order for the indicator spot 416 to be less visible to the user. Instead, if even a portion of the indicator spot 416 is covered from the view of the user through the indicator window 412 after exposure to the deleterious stimulus, it is enough to signal to the user that the product attached to the stimulus indicating device 400 had been exposed to a potentially harmful stimulus. More specifically, although the decrease in volume of the swollen stimulus sensitive gel 410 in all of the embodiments of the stimulus indicating device 400 discussed herein containing a stimulus sensitive gel can be by any amount so long as it is registerable, preferably the decrease in volume of the swollen stimulus sensitive gel 410 would be between at least a 1/10 reduction in original volume, and up to a 500 times decrease in original volume. In regard to all embodiments of the stimulus indicating device 400 discussed herein as they pertain to the decrease in the volume being “registerable” what is meant is that the volume change of the swollen stimulus sensitive gel 410 expels enough liquid 414 from the swollen stimulus sensitive gel 410 to cause the swollen stimulus sensitive gel 410 so as to collapse or shrink enough so that it becomes opaque enough to block the view of the indicator spot 416.

By way of example only, the indicator spot 416 (e.g., an indicator spot 416 that is the same color as the stimulus sensitive gel 410 and 420 but is a glyph, such as a happy face “ [symbol] ”) would be visible through the indicator window 412 and through the swollen stimulus sensitive gel 410 because of the transparency of the swollen stimulus sensitive gel 410 due to the unexpelled fluid 414 contained in the swollen stimulus sensitive gel 410. As the fluid 414 is expelled there is an increase in the opacity of an undyed collapsed or shrunken stimulus sensitive gel 420 that serves to provide an indication of exposure because it blocks the view of the indicator spot 416 (e.g., an indicator spot 416 that is the same color as the stimulus sensitive gel 410 and 420 but is a glyph, such as a happy face ( [symbol] )), which is at least partially and preferably fully covered from the view of the user through the indicator window 412, and indicates to the user that the product had been exposed to a predetermined stimulus.

Alternatively, the collapsing of a swollen stimulus sensitive gel 410 that contains colorant 411 also obscures the view of the indicator spot 416 because the shrinking or collapsing swollen stimulus sensitive gel 410 cause the colorant 411 to concentrate over the indicator spot 416 thereby resulting in a registerable change in color (e.g., as shown in FIG. 2A and FIG. 2B, a change in color from a first color to a second color).

Of course, one of ordinary skill in the art understands the reverse is true, such that a shrunken stimulus sensitive gel 420 is employed that initially hides or obscures the indicator spot 416, but upon exposure to a predetermined stimulus the shrunken stimulus sensitive gel 420 absorbs water and expands or swells enough so as to become the swollen stimulus sensitive gel 410 so that it reveals at least a portion or enough of the indicator spot 416 so that a registerable indication or change in color (e.g., revealing the glyph of the indicator spot 416, or a change in color from a first color to a second color, respectively) occurs in the stimulus indicating device 400, and is visible via the indicator window 412.

In regard to all the embodiments of the stimulus indicating device discussed herein being “irreversible” and “permanent,” what is meant is that once the stimulus indicating device 400 provides an indication of exposure to an adverse stimulus extreme (which is also referred to herein as a predetermined stimulus), that indication of exposure does not change, even though the adverse stimulus extreme or predetermined stimulus might be removed in the future.

Both the backing layer 425 and the upper layer 426 may be constructed of a strong, resilient leak-proof material, such as plastic or other polymer material, so as to provide for the twisting or bending that might occur during transportation of or application to the stimulus sensitive product without tearing, breaking or leaking. The backing layer 425 and the upper layer 426 may also be made of a material that preferably allows them to be joined and sealed together, such as by heat stamping or other suitable means. The backing layer 425 and the upper layer 426 can both approximate the length and width of the first compartment 402, although variations in these dimensions are within the scope of the present invention. The upper layer 426 can preferably be made of a clear material, such as plastic, so that the user of the stimulus indicating device 400 can view at least some portion of the backing material or indicator spot 416. The upper layer 426 can also be able to accept paint or ink so as to allow for coloring or concealing at least some portion of the first compartment 402.

Although some portion of the upper layer 426 can also accept paint or ink for coloring, it is preferable that the indicator window 412 portion of the upper layer 426 remain free from ink or coloring so that the user of the stimulus indicating device 400 can observe the first compartment 402 through the indicator window 412 as explained herein.

The stimulus sensitive gel 410 and 420 employed by the alternative variations of this embodiment, as shown in FIG. 4A and FIG. 4B, is preferably manufactured so as to not contain a dye or colorant 411 because although a swollen stimulus sensitive gel 410 is transparent, when it expels its fluid and becomes a shrunken stimulus sensitive gel 420, it becomes visually cloudy or opaque. Thus, when the swollen stimulus sensitive gel 410 collapses or shrinks in response to the predetermined stimulus, by even a partial amount, the change or decrease in volume will result in the stimulus indicating device 400 changing, at least partially, from transparent to at least partially cloudy or opaque, because the stimulus sensitive gels discussed herein naturally become more cloudy or opaque and non-transparent as they shrink or collapse by even a partial amount.

Although it is preferred that the stimulus sensitive gel 410 and 420 is manufactured to not contain a colorant 411 an alternative embodiment of the stimulus sensitive gel 410 and 420 could contain a colorant 411 such as dye particles, it is preferred that the dye particles or colorant be different from the color of the indicator spot 416. In this way the color of the stimulus sensitive gel 410 and 420 in both its swollen and collapsed state, is different from the color of the indicator spot 416. Thus, when the swollen stimulus sensitive gel 410 collapses or shrinks in response to the predetermined stimulus, by even a partial amount, the change or decrease in volume will result in the stimulus indicating device 400 changing, at least partially, from a first color to a second color, wherein the color change is visible to the user of the stimulus indicating device 400 through the indicator window 412. It should be noted that if the stimulus sensitive gel 410 and 420 does contain a colorant 411, when the stimulus sensitive gel is in its swollen state (i.e., the swollen stimulus sensitive gel 410), the concentration of colorant 411 contained in the swollen stimulus sensitive gel 410 should be either: i) minimal enough so that the swollen stimulus sensitive gel 410 preferably still appears transparent; or ii) of such a concentration that while it provides a minimal hue or coloring to the swollen stimulus sensitive 410, that hue or coloring is not so intense so as to obscure the user from viewing the coloring or shape of the indicator spot through the swollen stimulus sensitive gel 410. Regardless, as the swollen stimulus sensitive gel 410 does begin to shrink and expel its fluid, the colorant 411 (because its particles are embedded in the matrix of the stimulus sensitive gel) are not expelled from the gel matrix. Instead, the colorant 411 would concentrate over the indicator spot 416 as the swollen stimulus sensitive gel 410 shrank or collapsed, so as to aid in the covering and/or blocking the view of the indicator spot 416.

Although the preferred version of this alternative embodiment contains a stimulus sensitive gel 410 and 420 that lacks any dye or colorant, an alternative version of the stimulus sensitive gel 410 and 420 of this alternative embodiment of the stimulus indicating device 400 can be colored so as and can be combined in conjunction with all the embodiments shown in FIG. 2A through FIG. 2F (and as discussed above in regard to FIG. 3A and FIG. 3B) to disclose to the user of the stimulus indicating device 400 that the product to which it is attached had been exposed to a predetermined stimulus.

Preferably, the stimulus sensitive gel 410 and 420 would be fixed or secured at the attachment point 418, or at more than one attachment point if desired. The stimulus sensitive gel 410 and 420 may be fixed to the attachment point 418 with a suitable epoxy, glue, or it could be heat stamped upon creation of the stimulus indicating device 400. The attachment point 418 is preferably positioned at a point close to the indicator spot 416 and indicator window 412. Attaching the stimulus sensitive gel 410 and 420 to the attachment point 418 helps to ensure that the swollen stimulus sensitive gel 410 collapses or shrinks in a desired direction—preferably toward the attachment point 418, and toward the indicator spot 416 and toward the indicator window 412. Securing or fixing the stimulus sensitive gel 410 and 420 to the attachment point 418 prevents the stimulus sensitive gel 410 and 420 from floating or moving within the compartment and revealing the indicator spot 416 after the swollen stimulus sensitive gel 410 had undergone its phase transition, thereby preventing a false indication that the product attached to the stimulus indicator device 400 had not been exposed to a predetermined stimulus.

All embodiments discussed herein of the stimulus indicating device 400 containing the swollen stimulus sensitive gel 410 and the shrunken stimulus sensitive gel 420 may be based on any type of stimulus sensitive gel that undergoes a phase transition upon exposure of the stimulus sensitive gel to a predetermined stimulus.

By way of example only, the stimulus indicating device 400 can be manufactured using stimulus sensitive gels that include polyacrylic acid (PAA) gel, a polyacrylamide (PAAm) gel, and/or its variations such as poly(N-isopropylacrylamide)(PNIPAAm) gels, and/or their derivatives. As is known in the art, such stimulus sensitive gels and/or other equivalent gels and/or their derivatives, undergo a significant change in volume in response to a range of stimuli, including temperature, solvent composition, pH, ionic strength, etc.

By way of example only, it is known in the art that when the predetermined stimulus is temperature, the direction of the volume change in the stimulus sensitive gel 410 and 420 used in all the embodiments of the stimulus indicating device 400 discussed herein can be selected so as to correlate to a specific situation. For example, one of ordinary skill will appreciate and understand that if the stimulus sensitive gel in this embodiment is swollen at the beginning of its use as it undergoes its phase transition, it will collapse or shrink, thereby causing a change in color or indication in the stimulus indicator 400. Alternatively, the stimulus sensitive gel could start out collapsed or shrunken, but upon exposure to its predetermined stimulus it would permanently expand or swell and cause a change in color or indication in the stimulus indicator 400. By way of example only and as disclosed herein and in prior applications, a stimulus sensitive gel 410 and 420 can be of the UCST type or the LCST type gel.

As one of ordinary skill in the art will appreciate, a UCST type stimulus sensitive gel, such as PAAm gels, could be used when one wishes to have an initially swollen and transparent or at least somewhat visually clear swollen stimulus sensitive gel collapse or shrink when cooled below a predetermined or trigger temperature and thereby: i) expel liquid; ii) so as to become at least partially opaque; and/or iii) at least partially, if not preferably fully, cover an indicator spot 416 and block its view by the user. By employing these characteristics, the stimulus indicating device 400 will provide a change in color or some other indication of exposure to a predetermined stimulus. A UCST type gel could also be used when one wishes to have the reverse characteristics, i.e., an initially shrunken stimulus sensitive gel that expands or swells when it is heated beyond a predetermined stimulus, and thereby: i) collect liquid; ii) so as to become at least partially transparent, and/or iii) at least partially if not fully reveal the indicator spot so as to result in a change in color or some other indication.

Alternatively, an LCST type stimulus sensitive gel, such as PNIPAAm gels, could be used when one wishes to have an initially swollen and transparent stimulus sensitive gel collapse or shrink when heated above a predetermined or trigger temperature and thereby: i) expel liquid; ii) so as to become at least partially opaque; and/or iii) at least partially, if not preferably fully, cover an indicator spot and block its view by the user. By employing these characteristics, the stimulus indicating device 400 will result to provide a change in color or some other indication of exposure to a predetermined stimulus. An LCST type gel could also be used when one wishes to have the reverse characteristics, i.e., an initially shrunken stimulus sensitive gel that expands or swells when it is cooled below a predetermined stimulus, and thereby: i) collect liquid; ii) so as to become at least partially transparent; and iii) at least partially if not preferably fully reveal the indicator spot so as to result in a change in color or some other indication.

One of ordinary skill in the art will understand that although the stimulus sensitive gel 410 and 420 discussed herein in regard to the stimulus indicating device 400 may be of the LCST type of gel (i.e., the initially swollen stimulus sensitive gel 410 will collapse or shrink upon exposure to its predetermined stimulus of a warmer temperature, and become the shrunken stimulus sensitive gel 420; as well as expand or swell upon exposure to its predetermined stimulus of a cooler temperature, and become the swollen stimulus sensitive gel 410), the range and scope of this invention includes and envisions the swollen stimulus sensitive gel 410 and the shrunken stimulus sensitive gel 420 also being of the USCT type of gel. Moreover, it should be noted that all the variations of the different embodiments discussed herein can be combined with the variations of other embodiments described herein and that are known in the art, as would be understood to one of ordinary skill in the art.

The behavior of the USCT gels and the LCST gels depends on their chemical structure. Many examples of both kinds of polymers are known in the literature. For example, if the stimulus sensitive gel 410 and 420 employed in all the embodiments of the stimulus indicating device 400 discussed herein were made of USCT type stimulus sensitive gels, it could be any number of such USCT gels, including: i) polyacrylic acid (PAA) gel combined with polyacrylamide (PAAm) gel; or ii) PAAm gel combined with poly sodium 3-butenoate (SB) gel to result in the creation of poly(AAm-co-SB) gel; or iii) their derivates, and as described in Tanaka, “Gels,” Scientific American 244 (1981) at 124-138 and Tanaka, “Phase Transitions in Ionic Gels,” Physical Review Letters 45 (1980) at 1636-1639, the predetermined “trigger” stimulus at which a USCT gel undergoes its phase transition, and thereby expels the liquid 414 and thus collapses or shrinks in volume, can be “tuned” to a particular value by changing the solvent trapped in the gel polymer matrix in addition to introducing salts, surfactants, or other substances to the gel matrix. Such “tuning” in regard to UCST type gels is discussed herein and in U.S. Pat. No. 5,100,933. Similarly, if the stimulus sensitive gel 410 and 420 employed in all the embodiments of the stimulus indicating device 400 discussed herein were made of LSCT type stimulus sensitive gels, it could be any number of such LCST gels, including PNIPAAm gels, and as described in U.S. Pat. No. 4,732,930 in regard to PNIPAAm, the predetermined stimulus, such as temperature at which a stimulus sensitive gel 410 and 420 undergoes its phase transition and changes volume, can be “tuned” to a particular value by adding salts, surfactants, or other substances to the gel matrix. Explanations of how the transition temperature of an LCST gel can be tuned can be found in the following references: Zhang et al., “Specific Ion Effects on the Water Solubility of Macromolecules: PNIPAM and the Hofineister Series” Journal of the American Chemical Society volume 127 at 14505 to 14510 and Park et al., “Sodium Chloride-Induced Phase Transition in Nonionic 65 Gel Macromolecules volume 26 at 5045 to 5048.

Regardless of whether LCST type stimulus sensitive gels or USCT type stimulus sensitive gels are used to indicate exposure to a predetermined stimulus, what is important is that the change in volume of the stimulus sensitive gel be tailored to the application in which the stimulus indicator is being used. For example, a change in volume of the stimulus sensitive gel 410 and 420, and thus the corresponding expulsion of liquid 414 can be insignificant or it can be dramatic. If the desired visual indication is the result of the swollen stimulus sensitive gel 410 shrinking or completely collapsing over and thereby visually blocking the view of the indicator spot 416 through the indicator window 412, then a large change in volume is preferred.

### Semi-Perm Membrane

In accordance with the purpose of the invention, as embodied and broadly described herein and in conjunction with FIG. 5A and FIG. 5B as well as FIG. 2A through 2F, another alternative embodiment of the inventive stimulus indicating devices described herein has at least two compartments which contain initially in the first compartment 502 a preferably swollen stimulus sensitive gel 510 and indicator spot 516 positioned under the swollen stimulus sensitive gel 510, and preferably contains a second compartment 504 for collecting expelled fluid 515 that is expelled from the swollen stimulus sensitive gel 510 as it collapses or shrinks, and wherein the second compartment possibly contain an absorbent material 507 for absorbing and binding the expelled fluid 515 as described herein. The first compartment 502 and second compartment 504 are separated by a semi-permeable membrane 531 that traps expelled fluid 515 in the second compartment 504, thereby permanently keeping the then shrunken stimulus sensitive gel 520 from re-expanding or re-swelling, and thereby preventing the then shrunken stimulus sensitive gel 520 from re-revealing the indicator spot 516 once it was hidden by the shrunken stimulus sensitive gel 520. Although this embodiment is described in terms of the stimulus sensitive gel preferably being initially swollen and preferably fully transparent (as the stimulus sensitive gel collapses or shrinks it becomes more opaque and at least partially blocks the view of an indicator spot below it), as discussed herein in regard to stimulus sensitive gels, one of ordinary skill in the art would appreciate that the same invention can be achieved with an initially shrunken stimulus sensitive gel that is initially visually opaque but that expands or swells upon exposure to a predetermined stimulus so as to become at least partially if not fully transparent and reveal an indicator spot.

The first compartment 502 and second compartment 504 are formed in part by the backing layer 525 on the bottom of the stimulus indicating device 500, and an upper layer 526 on the top of the stimulus indicating device 500. The top layer 526 of the stimulus indicating device 500 is formed by at least the indicator window 512 and the top portion 508 of the top layer 526. The indicator spot 516 can be viewed through an indicator window 512 located in the top layer 526 of the stimulus indicating device 500. The first compartment 502 and the second compartment 504 are additionally formed and differentiated from one another by a semi-permeable membrane 531. The semi-permeable membrane 531 is designed to allow the expelled liquid 515 to pass from the first compartment 502 into the second first compartment 504 only, and to block the expelled liquid 515 from passing back into the first compartment 502.

Alternatively, as shown in FIG. 5C an alternate embodiment could position the first compartment 502 above the second compartment 504 separated by the semi-permeable membrane 531. Other shapes are contemplated within the scope of the invention as would be understood by one of ordinary skill in the art and/or as previously described in prior applications.

Prior to being exposed to a predetermined trigger stimulus, the swollen stimulus sensitive gel 510 has not yet undergone a phase transition and preferably allows the entire indicator spot 516 to be visible to the user. The indicator spot 516 is positioned below the indicator window 512, and is preferably completely visible through both the indicator window 512 and the swollen stimulus sensitive gel 510 prior to the stimulus indicating device 500 being exposed to the predetermined stimulus because the swollen stimulus sensitive gel 510 is swollen with a clear liquid and is therefore clear and transparent. The swollen stimulus sensitive gel 510 contains fluid 514, which allows the swollen stimulus sensitive gel 510 to maintain its expanded or swollen volume, and consequently its visually transparent or clear appearance. When the swollen stimulus sensitive gel 510 is exposed to a predetermined stimulus, however, it undergoes its phase transition and the fluid 514 contained in the swollen stimulus sensitive gel 510 is expelled from the swollen stimulus sensitive gel 510 and enters the first compartment 502.

As discussed herein, this alternative embodiment of the stimulus indicating device 500 contains a stimulus sensitive gel 510 and 520 described herein in regard to FIG. 5A and FIG. 5B. As the stimulus sensitive gel 510 and 520 is exposed to a predetermined stimulus, by way of example only, a certain temperature, and it undergoes its phase transition by collapsing or shrinking in volume, it not only at least partially if not fully covers the indicator spot 516 previously visible through the display portion or indicator window 512 and through the previously transparent stimulus sensitive gel 510, but it expels the fluid 514 (by way of example only, water that can be trapped by absorbent material) from within the matrix of the swollen stimulus sensitive gel 510 and into the first compartment 502 of the stimulus indicator 500.

Upon exposure of the stimulus sensitive product to its predetermined phase transition stimulus, such as temperature, the swollen stimulus sensitive gel 510 would, undergo its phase transition and collapse or shrink to become the shrunken stimulus sensitive gel 520 due to the loss of fluid 514 contained in its matrix. As the swollen stimulus sensitive gel collapses or shrinks, it at least partially and preferably wholly covers or obscures the view of the indicator spot 516, so that the indicator spot 516 is at least partially if not preferably fully hidden from the view of the user through the indicator window 512. The more the swollen stimulus sensitive gel 510 collapses or shrinks the more it collapses or visually obscures the view of the indicator spot 516, and the more it becomes like the collapsed or shrunken stimulus sensitive gel 520 in FIG. 5B. Such partial or full obfuscation of the indicator spot 516 by the collapsing or shrinking of the swollen stimulus sensitive gel 510 to become the collapsed or shrunken stimulus sensitive gel 520 is the same for all variations of this embodiment discussed herein.

Also, as the stimulus sensitive gel 510 collapses or shrinks in response to the predetermined stimulus, the expelled fluid 515 expelled from the swollen stimulus sensitive gel 510 is expelled into the first compartment 502, and passes into the second compartment 504 though the semi-permeable membrane 531 that separates the at least two compartments 502 and 504.

Because the semi-permeable membrane 531 separating the at least first compartment 502 and second compartment 504 allows the expelled liquid 515 and/or constituent parts 411 to only pass from the first compartment 502 into the second compartment 504, the expelled fluid 515 are trapped outside the first compartment 502 in the second compartment 504, resulting in a constant volume of liquid 514 and shrunken stimulus sensitive gel 520 in the first compartment 502 from that point forward. Alternatively, the second compartment 504 could also contain an absorbent material 507 that has an affinity for the expelled liquid 515 (as described herein, in particular in regard to FIGS. 5A and 5B or as understood in the art), that permanently binds to and/or traps the expelled liquid 515 in the second compartment 504. By way of example only, if the expelled liquid 514 were water, the absorbent material could be a silica gel, such as hygroscopic silica or another absorbent material that permanently binds to the expelled liquid 515 expelled from the swollen stimulus sensitive gel 510.

Trapping the expelled liquid 515 in the second compartment 504 via the semi-permeable membrane 531 alone or in combination with an absorbent material 507 results in a constant or fixed volume of liquid 514 and 515 and shrunken stimulus sensitive gel 520 in the first compartment 502 from that point forward. Because the volume of liquid 514 and 515 and shrunken stimulus sensitive gel 520 in the first compartment 502 is fixed due to the expelled liquid 515 being trapped in the second compartment 504 by the semi-permeable membrane 531 alone or in combination with absorbent material 507, the collapsed or shrunken stimulus sensitive gel 520 is permanently prevented from re-expanding and re-revealing the indicator spot 516, even when the predetermined stimulus condition is removed. In this way the stimulus indicating device 500 will permanently show that it, and the stimulus sensitive product attached to it, had been exposed to a deleterious predetermined stimulus.

It should be noted that by manipulating the permeability of the semi-permeable membrane 531 connecting the first compartment 502 to the second compartment 504, the time required for expelled liquid 515 to move from the first compartment 502 into the second compartment 504 can be varied. Such manipulation of the semi-permeable membrane 531 includes increasing or decreasing its thickness and/or increasing or decreasing its surface area facing the first compartment 502 and/or second compartment 504 and/or increasing or decreasing its wicking ability, so as to control the speed at which the expelled fluid 515 travels from the first compartment 504, through the semi-permeable membrane 531, and enters the second compartment 502.

An advantage of using such an alternate embodiment of the stimulus indicating device 500 is that both the exposure to a predetermined stimulus as well as the time of exposure can be indicated. As an example, if the predetermined stimulus occurs for just a short period of time, and is removed before the expelled liquid 515 has completely moved from the first compartment 502 through the semi-permeable membrane 531 and into the second compartment 504 because the semi-permeable membrane 531 prevents the expelled liquid 515 from freely flowing into the second compartment 504, then the expelled liquid 515 will be wicked or drawn back into the shrunken stimulus sensitive gel 520 as the shrunken stimulus sensitive gel 520 re-expands or swells as a result of undergoing its reverse phase transition because for example the predetermined stimulus had been removed, and thereby preventing the stimulus indicating device 500 from changing from a first indication to a second indication.

The swollen stimulus sensitive gel 510 can be made to undergo its phase transition when it is exposed to the proper or predetermined stimulus, such as and by way of example only, when it is heated or cooled to a designated temperature, depending on whether the polymer gel was of the LCST or UCST type. Regardless, as the swollen stimulus sensitive gel 510 collapses or shrinks, the fluid 514 (or other liquid or mixture) contained in the matrix of the swollen stimulus sensitive gel 510, are expelled. Consequently, as shown in FIG. 5A and FIG. 5B, the expelled liquid 515 would be absorbed by a suitable absorbent material 507 such as a silica gel, such as hygroscopic silica or another absorbent material in the second compartment 504 that permanently binds to the expelled liquid 515 expelled from the stimulus sensitive gel 510.

The collapsing or shrinking of the swollen stimulus sensitive gel 510 (caused by the loss of the liquid 514 contained in the matrix of the swollen stimulus sensitive gel 510 when the swollen stimulus sensitive gel 510 undergoes its phase transition), thereby resulting in the shrunken stimulus sensitive gel 520 preferably collecting over the indicator spot 516 of the stimulus indicating device 500, would at least partially and preferably completely hide the colored indicator spot 516 previously visible through the indicator window 512 and through the swollen stimulus sensitive gel 510, thereby indicating to the user of the stimulus sensitive product that the product had been exposed to a harmful stimulus, such as an extreme temperature.

It should be noted that if the stimulus sensitive gel 510 and 520 does contain a colorant 511, when the stimulus sensitive gel is in its swollen state (i.e., the swollen stimulus sensitive gel 510), the concentration of the colorant 511 contained in the swollen stimulus sensitive gel 510 should be either: i) minimal enough so that the swollen stimulus sensitive gel 510 preferably still appears transparent; or ii) of such a concentration that while it provides a minimal hue or coloring to the swollen stimulus sensitive 510 that the coloring or shape of the indicator spot is still visible through the swollen stimulus sensitive gel 510. Regardless, as the swollen stimulus sensitive gel 510 does begin to shrink and expel its fluid, the colorant 511 (because they are embedded in the matrix of the stimulus sensitive gel) are not expelled from the gel matrix. Instead, the colorant 511 would concentrate over the indicator spot 516 as the swollen stimulus sensitive gel 510 shrank or collapsed, so as to aid in the covering and/or blocking the view of the indicator spot 516.

By way of example only, prior to exposure to a deleterious stimulus such as temperature, the indicator could be a happy face [symbol] or be simple green circle, which would indicate to the user that the stimulus sensitive product attached to the stimulus indicating device was undamaged and still viable. But upon being exposed to a deleterious stimulus, the swollen stimulus sensitive gel 510 would shrink and partially, if not preferably fully cover, the indicator spot 516.

As one of ordinary skill in the art understands, stimulus sensitive gels, such as LCST and UCST, are opaque in not only their native pre-manufactured form, but also in their manufactured molded but unswollen form or state, It is only upon swelling with a clear liquid or fluid that the stimulus sensitive gels become transparent. Preferably the stimulus sensitive gel 510 and 520 would be undyed and thus transparent or “invisible” to the user of the stimulus indicating device 500 when the stimulus sensitive gel was initially in its expanded state 510, but as the swollen stimulus indicating gel 510 begins to collapse or shrink, the opaque quality of the shrunken stimulus sensitive gel 520 concentrates over the indicator spot 512 so as to at least partially if not completely block the view of the indicator spot 512 below it, thereby indicating to the user of the stimulus sensitive product that the product had been exposed to a harmful stimulus, such as an extreme temperature.

Preferably the stimulus sensitive gel 510 and 520 is manufactured so as to be free of coloring or dye particles. But in an alternative embodiment the stimulus sensitive gel 510 and 520 could contain colorant 511 that could be by way of example only, dye particles. Importantly, the colorant 511 would preferably be incorporated into the matrix of the stimulus sensitive gel 510 and 520. By incorporating the colorant 511 into the matrix of the stimulus sensitive gel 510 and 520, that colorant 511 could be used to enhance or accentuate the visual impact of the swollen stimulus gel 510 as it expelled the fluid 514 and becomes the shrunken stimulus sensitive gel 520. Because the colorant 511 is preferably incorporated into the matrix of the stimulus sensitive gel 510 and 520, it is not expelled from the swollen stimulus sensitive gel 510 when the swollen stimulus sensitive gel 510 collapses and becomes the shrunken stimulus sensitive gel 520. Instead, because the colorant 511 is incorporated into the matrix of the stimulus sensitive gel 510 and 520, as the swollen stimulus sensitive gel 510 shrinks and collapses the colorant 511 becomes concentrated within the stimulus sensitive gel 510 and 520 so as to make the shrunken stimulus sensitive gel 520 even more opaque and able to block, even partially, the view of the indicator spot 516.

Referring again to FIG. 5A and FIG. 5B, after exposure to the predetermined stimulus, the shrunken stimulus sensitive gel 520 would remain permanently in its collapsed or shrunken state, even if the predetermined stimulus, such as temperature, were removed because the shrunken stimulus sensitive gel 520 would not come back into contact with the expelled fluid 515 because the expelled fluid 515 had been boinid to and/or trapped by the semi-permeable membrane 531 and possibly absorbent material 507 (as disclosed herein), thereby permanently preventing the shrunken stimulus sensitive gel 520 from expanding back to its original volume once the predetermined stimulus had been removed. Thus, the shrunken stimulus sensitive gel 520 is permanently prevented from expanding back to original volume because either the absorbent material 507 has a stronger affinity for the expelled fluid 515 than the shrunken stimulus sensitive gel 520, or because the absorbent material 507 would not physically touch the shrunken stimulus sensitive gel 520. Either way the absorbent material, which is for example a silica gel such as hygroscopic silica 507 or an equivalent absorbent material that has an affinity for and permanently binds to the expelled liquid 515, which would be expelled from the swollen stimulus sensitive 510 as it collapsed or shrunk. By permanently trapping the expelled liquid 515 via the semi-permeable membrane 531 and possibly the absorbent material 507, the shrunken stimulus sensitive gel 520 would be permanently prevented from expanding or swelling and re-revealing the indicator spot 516, even when the predetermined stimulus condition is removed.

It should be noted that the predetermined temperature discussed herein that causes the swollen stimulus sensitive gel 510 to undergo its phase transition is only one example of a predetermined stimulus or trigger stimulus that will cause the inventive stimulus sensitive gel 510 and 520 to undergo its phase transition. For example, the swollen stimulus sensitive gel 510 of this alternative embodiment could trigger or undergo its phase transition upon exposure to a predetermined stimulus such as a predetermined pH level, or the swollen stimulus sensitive gel 510 of this alternative embodiment could trigger or undergo its phase transition upon exposure to a predetermined level of electromagnetic radiation.

As the expelled fluid 515 leave the swollen stimulus sensitive gel 510, the swollen stimulus sensitive gel 510 collapses or shrinks in volume, so as to result in the shrunken stimulus gel 520 shown in FIG. 5B. As shown in FIG. 5B, as the swollen stimulus sensitive gel 510 collapses or shrinks in volume, it preferably moves towards the attachment point 518, and in a direction toward the indicator spot 516 and indicator window 512. Thus, by decreasing the volume of the swollen stimulus sensitive gel 510 to result in the shrunken stimulus sensitive gel 520, the indicator spot 516 becomes preferably fully covered and not visible to the user through the indicator window 512. Thus, as the volume of the swollen stimulus sensitive gel 510 decreases it begins to resemble the shrunken stimulus sensitive gel 520, and hides the indicator spot 516 from the user through the indicator window 512.

It should be noted that it is not necessary for the swollen stimulus sensitive gel 510 to collapse or shrink entirely in order for the indicator spot 516 to be less visible to the user. Instead, if even a portion of the indicator spot 516 is covered from the view of the user through the indicator window 512 after exposure to the deleterious stimulus, it is enough to signal to the user that the product attached to the stimulus indicating device 500 had been exposed to a potentially harmful stimulus. More specifically, although the decrease in volume of the swollen stimulus sensitive gel 510 in all of the embodiment of the stimulus indicating device 500 discussed herein containing a stimulus sensitive gel can be by any amount so long as it is registerable, preferably the decrease in volume of the swollen stimulus sensitive gel 510 would be between at least a 1/10 reduction in original volume, and up to a 500 times decrease in original volume. In regard to all embodiments of the stimulus indicating device 500 discussed herein as they pertain to the decrease in the volume being “registerable” what is meant is that the volume change of the swollen stimulus sensitive gel 510 expels enough liquid 514 from the swollen stimulus sensitive gel 510 so as to cause the swollen stimulus sensitive gel 510 to collapse or shrink enough so that it becomes opaque enough to block the view of the indictor spot 416.

By way of example only, the indicator spot 516 (e.g., an indicator spot 516 that is the same color as the stimulus sensitive gel 510 and 520 but is a glyph, such as a happy face “ [symbol] ”) would be visible through the indicator window 512 and through the swollen stimulus sensitive gel 510 because of the transparency of the swollen stimulus sensitive gel 510 due to the unexpelled fluid 514 contained in the swollen stimulus sensitive gel 510. As the fluid 514 is expelled there is an increase in the opacity of an undyed collapsed or shrunken stimulus sensitive gel 520 that serves to provide an indication of exposure because it blocks the view of the indicator spot 516 (e.g., an indicator spot 516 that is the same color as the stimulus sensitive gel 510 and 520 but is a glyph, such as a happy face ( [symbol] )), which is at least partially and preferably fully covered from the view of the user through the indicator window 312, and indicates to the user that the product had been exposed to a predetermined stimulus.

Alternatively, the collapsing of a swollen stimulus sensitive gel 510 that contains colorant 511 also obscures the view of the indicator spot 516 because the shrinking or collapsing swollen stimulus sensitive gel 510 cause the colorant 511 to concentrate over the indicator spot 516 thereby resulting in a registerable change in color (e.g., as shown in FIG. 2A and FIG. 2B, a change in color from a first color to a second color).

Of course, one of ordinary skill in the art understands the reverse is true, such that a shrunken stimulus sensitive gel 520 is employed that initially hides or obscures the indicator spot 516, but upon exposure to a predetermined stimulus the shrunken stimulus sensitive gel 520 absorbs water and expands or swells enough so as to become the swollen stimulus sensitive gel 510 so that it reveals at least a portion or enough of the indicator spot 516 so that a registerable indication or change in color (e.g., revealing the glyph of the indicator spot 516, or a change in color from a first color to a second color, respectively) occurs in the stimulus indicating device 500, and is visible via the indicator window 512.

In regard to all the embodiments of the stimulus indicating device discussed herein being “irreversible” and “permanent,” what is meant is that once the stimulus indicating device provides an indication of exposure to an adverse stimulus extreme (which is also referred to herein as a predetermined stimulus), that indication of exposure does not change, even though the adverse stimulus extreme or predetermined stimulus might be removed in the future.

Both the backing layer 525 and the upper layer 526 may be constructed of a strong, resilient leak-proof material, such as plastic or other polymer material, so as to provide for the twisting or bending that might occur during transportation of or application to the stimulus sensitive product without tearing, breaking or leaking. The backing layer 525 and the upper layer 526 may also be made of a material that preferably allows them to be joined and sealed together, such as by heat stamping or other suitable means. The backing layer 525 and the upper layer 526 can both approximate the length and width of the first compartment 502, although variations in these dimensions are within the scope of the present invention. The upper layer 526 can preferably be made of a clear material, such as plastic, so that the user of the stimulus indicating device 500 can view at least some portion of the backing material or indicator spot 516. The upper layer 526 can also be able to accept paint or ink so as to allow for coloring or concealing at least some portion of the first compartment 502.

Although some portion of the upper layer 526 can also accept paint or ink for coloring, it is preferable that the indicator window 512 portion of the upper layer 526 remain free from ink or coloring so that the user of the stimulus indicating device 500 can observe the first compartment 502 through the indicator window 512 as explained herein.

The stimulus sensitive gel 510 and 520 employed by the alternate variations of this embodiment, as shown in FIG. 5A and FIG. 5B, is preferably manufactured so as to not contain a dye or colorant 511 because although a swollen stimulus sensitive gel 510 is transparent, when it expels its fluid and becomes a shrunken stimulus sensitive gel 520, it becomes visually cloudy or opaque. Thus, when the swollen stimulus sensitive gel 510 collapses or shrinks in response to the predetermined stimulus, by even a partial amount, the change or decrease in volume will result in the stimulus indicating device 500 changing, at least partially, from transparent to at least partially cloudy or opaque, because the stimulus sensitive gels discussed herein naturally become more cloudy or opaque and non-transparent as they shrink or collapse by even a partial amount.

Although it is preferred that the stimulus sensitive gel 510 and 520 is manufactured to not contain a colorant 511 an alternative embodiment of the stimulus sensitive gel 510 and 520 could contain a colorant 511 such as dye particles, it is preferred that the dye particles or colorant be different from the color of the indicator spot 516. In this way the color of the stimulus sensitive gel 510 and 520 in both its swollen and collapsed state, is different from the color of the indicator spot 516. Thus, when the swollen stimulus sensitive gel 510 collapses or shrinks in response to the predetermined stimulus, by even a partial amount, the change or decrease in volume will result in the stimulus indicating device 300 changing, at least partially, from a first color to a second color, wherein the color change is visible to the user of the stimulus indicating device 500 through the indicator window 512. It should be noted that if the stimulus sensitive gel 510 and 320 does contain a colorant 511, when the stimulus sensitive gel is in its swollen state (i.e., the swollen stimulus sensitive gel 510), the concentration of colorant 511 contained in the swollen stimulus sensitive gel 510 should be either: i) minimal enough so that the swollen stimulus sensitive gel 510 preferably still appears transparent; or ii) of such a concentration that while it provides a minimal hue or coloring to the swollen stimulus sensitive 510, that hue or coloring is not so intense so as to obscure the user from viewing the coloring or shape of the indicator spot through the swollen stimulus sensitive gel 510. Regardless, as the swollen stimulus sensitive gel 510 does begin to shrink and expel its fluid, the colorant 511 (because its particles are embedded in the matrix of the stimulus sensitive gel) are not expelled from the gel matrix. Instead, the colorant 511 would concentrate over the indicator spot 516 as the swollen stimulus sensitive gel 510 shrank or collapsed, so as to aid in the covering and/or blocking the view of the indicator spot 516.

Although the preferred version of this alternative embodiment contains a stimulus sensitive gel 510 and 520 that lacks any dye or colorant, an alternative version of the stimulus sensitive gel 510 and 520 of this alternative embodiment of the stimulus indicating device 500 can be colored so as and can be combined in conjunction with all the embodiments shown in FIG. 2A through FIG. 2F (and as discussed above in regard to FIG. 3A and FIG. 3B) to disclose to the user of the stimulus indicating device 500 that the product to which it is attached had been exposed to a predetermined stimulus.

Preferably, the stimulus sensitive gel 510 and 520 would be fixed or secured at the attachment point 518, or at more than one attachment point desired. The stimulus sensitive gel 510 and 520 may be fixed to the attachment point 518 with a suitable epoxy, glue, or it could be heat stamped upon creation of the stimulus indicating device 500. The attachment point 518 is preferably positioned at a point close to the indicator spot 516 and indicator window 512. Attaching the stimulus sensitive gel 510 and 520 to the attachment point 518 helps to ensure that the swollen stimulus sensitive gel 510 collapses or shrinks in a desired direction—preferably toward the attachment point 518, and toward the indicator spot 516 and toward the indicator window 512. Securing or fixing the stimulus sensitive gel 510 and 520 to the attachment point 518 prevents the stimulus sensitive gel 510 and 520 from floating or moving within the compartment and covering up the indicator spot 516 after the swollen stimulus sensitive gel 510 had undergone its phase transition, thereby preventing a false indication that the product attached to the stimulus indicator device 500 had not been exposed to a predetermined stimulus.

All embodiments discussed herein of the stimulus indicating device 500 containing the swollen stimulus sensitive gel 510 and the shrunken stimulus sensitive gel 520 may be based on any type of stimulus sensitive gel that undergoes a phase transition upon exposure of the stimulus sensitive gel to a predetermined stimulus.

By way of example only, the stimulus indicating device 500 can be manufactured using stimulus sensitive gels that include polyacrylic acid (PAA) gel, a polyacrylamide (PAAm) gel, and/or its variations such as poly(N-isopropylacrylamide)(PNIPAAm) gels, and/or their derivatives. As is known in the art, such stimulus sensitive gels and/or other equivalent gels and/or their derivatives, undergo a significant change in volume in response to a range of stimuli, including temperature, solvent composition, pH, ionic strength, etc.

By way of example only, it is known in the art that when the predetermined stimulus is temperature, the direction of the volume change in the stimulus sensitive gel 510 and 520 used in all the embodiments of the stimulus indicating device 500 discussed herein can be selected so as to correlate to a specific situation. For example, one of ordinary skill will appreciate and understand that if the stimulus sensitive gel in this embodiment is swollen at the beginning of its use as it undergoes its phase transition, it will collapse or shrink, thereby causing a change in color or indication in the stimulus indicator 500.

Alternatively, the stimulus sensitive gel could start out collapsed or shrunken, but upon exposure to its predetermined stimulus it would permanently expand or swell and cause a change in color or indication in the stimulus indicator 500. By way of example only and as disclosed herein and in prior applications, a stimulus sensitive gel 510 and 520 can be of the UCST type or the LCST type gel. As one of ordinary skill in the art will appreciate, a UCST type stimulus sensitive gel, such as PAAm gels, could be used when one wishes to have an initially and transparent or at least somewhat visually clear swollen stimulus sensitive gel collapse or shrink when cooled below a predetermined or trigger temperature and thereby: i) expel liquid; ii) so as to become at least partially opaque; and/or iii) at least partially, if not preferably fully, cover an indicator spot and block its view by the user. By employing these characteristics, the stimulus indicating device 500 will result to provide a change in color or some other indication of exposure to a predetermined stimulus. A UCST type gel could also be used when one wishes to have the reverse characteristics, i.e., an initially shrunken stimulus sensitive gel that expands or swells when it is heated beyond a predetermined stimulus, and thereby: i) collect liquid; ii) so as to become at least partially transparent, and/or iii) at least partially if not fully reveal the indicator spot so as to result in a change in color or some other indication. change in color or indication.

Alternatively, an LCST type stimulus sensitive gel, such as PNIPAAm gels, could be used when one wishes to have an initially swollen and transparent stimulus sensitive gel collapse or shrink when heated above a predetermined or trigger temperature and thereby: i) expel liquid; ii) so as to become at least partially opaque; and/or iii) at least partially, if not preferably fully, cover an indicator spot and block its view by the user. By employing these characteristics, the stimulus indicating device 500 will result to provide a change in color or some other indication of exposure to a predetermined stimulus. An LCST type gel could also be used when one wishes to have the reverse characteristics, i.e., an initially shrunken stimulus sensitive gel that expands or swells when it is cooled below a predetermined stimulus, and thereby: i) collect liquid; ii) so as to become at least partially transparent; and iii) at least partially if not preferably fully reveal the indicator spot so as to result in a change in color or some other indication.

One of ordinary skill in the art will understand that although the stimulus sensitive gel 510 and 520 discussed herein in regard to the stimulus indicating device 500 may be of the LCST type of gel (i.e., the initially swollen stimulus sensitive gel 510 will collapse or shrink upon exposure to its predetermined stimulus of a warmer temperature, and become the shrunken stimulus sensitive gel 520; as well as expand or swell upon exposure to its predetermined stimulus of a cooler temperature, and become the swollen stimulus sensitive gel 510), the range and scope of this invention includes and envisions the swollen stimulus sensitive gel 510 and the shrunken stimulus sensitive gel 520 also being of the USCT type of gel. Moreover, it should be noted that all the variations of the different embodiments discussed herein can be combined with the variations of other embodiments described herein and that are known in the art, as would be understood to one of ordinary skill in the art.

The behavior of the USCT gels and the LCST gels depends on their chemical structure. Many examples of both kinds of polymers are known in the literature. For example, if the stimulus sensitive gel 510 and 520 employed in all the embodiments of the stimulus indicating device 500 discussed herein were made of USCT type stimulus sensitive gels, it could be any number of such USCT gels, including: i) polyacrylic acid (PAA) gel combined with polyacrylamide (PAAm) gel; or ii) PAAm gel combined with poly sodium 3-butenoate (SB) gel to result in the creation of poly(AAm-co-SB) gel; or iii) their derivates, and as described in Tanaka, “Gels,” Scientific American 244 (1981) at 124-138 and Tanaka, “Phase Transitions in Ionic Gels,” Physical Review Letters 45 (1980) at 1636-1639, the predetermined “trigger” stimulus at which a USCT gel undergoes its phase transition, and thereby expels the liquid 514 and thus collapses or shrinks in volume, can be “tuned” to a particular value by changing the solvent trapped in the gel polymer matrix in addition to introducing salts, surfactants, or other substances to the gel matrix. Such “tuning” in regard to UCST type gels is discussed herein and in U.S. Pat. No. 5,100,933. Similarly, if the stimulus sensitive gel 510 and 520 employed in all the embodiments of the stimulus indicating device 500 discussed herein were made of LSCT type stimulus sensitive gels, it could be any number of such LCST gels, including PNIPAAm gels, and as described in U.S. Pat. No. 4,732,930 in regard to PNIPAAm, the predetermined stimulus, such as temperature at which a stimulus sensitive gel 510 and 520 undergoes its phase transition and changes volume, can be “tuned” to a particular value by adding salts, surfactants, or other substances to the gel matrix. Explanations of how the transition temperature of an LCST gel can be tuned can be found in the following references: Zhang et al., “Specific Ion Effects on the Water Solubility of Macromolecules: PNIPAM and the Hofineister Series” Journal of the American Chemical Society volume 127 at 14505 to 14510 and Park et al., “Sodium Chloride-Induced Phase Transition in Nonionic Poly(N-isopropylacrylamide) Gel Macromolecules volume 26 at 5045 to 5048.

Regardless of whether LCST type stimulus sensitive gels or USCT type stimulus sensitive gels are used to indicate exposure to a predetermined stimulus, what is important is that the change in volume of the stimulus sensitive gel be tailored to the application in which the stimulus indicator is being used. For example, a change in volume of the stimulus sensitive gel 510 and 520, and thus the corresponding expulsion of liquid 514 can be insignificant or it can be dramatic. If the desired visual indication is the result of the swollen stimulus sensitive gel 510 shrinking and completely collapsing above and thereby visually blocking the view of the indicator spot 516 through the indicator window 512, then a large change in volume is preferred.

### Cold Side—Neck Portion

In accordance with the purpose of the invention, as embodied and broadly described herein and in conjunction with FIG. 6A and FIG. 6B as well as FIG. 2G through 2L, another alternative embodiment of the inventive stimulus indicating devices described herein has at least two compartments, a first compartment 602 and a second compartment 604. The first compartment 602 and second compartment 604 are separated by way of example only a constricting portion 632 or neck portion 632 or any other type of choke portion 632 understood by one of ordinary skill in the art or as described in prior applications that constricts the flow of the stimulus sensitive gel 610 and 620. Prior to exposure to a predetermined stimulus the swollen stimulus sensitive gel 610 is contained in either: i) only the first compartment 602; ii) only the second compartment 604; or iii) both the first compartment 602 and the second compartment 604. This type of stimulus sensitive gel and its initial location in the first, second or both compartments is dependant on the application of the stimulus indicator device.

In the preferred variation of this alternative embodiment, the swollen stimulus sensitive gel 610 is preferably initially contained in both the first compartment 602 and second compartment 604. More particularly, the first compartment 602 and the second compartment 604 contain the swollen stimulus sensitive gel 610 that is swollen enough to be clear or transparent so that at least a portion and preferably all of the indicator spot 616 which is also contained in the second compartment 604 is visible through the indicator window 612 and the swollen stimulus sensitive gel 610. The first compartment 602 also preferably contains absorbent material 605 for absorbing and binding the expelled fluid 615 that is expelled from the swollen stimulus sensitive gel 610 as described herein. The second compartment 604 collects and serves as a reservoir for the stimulus sensitive gel 610 and 620 as it collapses and shrinks due to exposure to a predetermined stimulus. The second compartment also preferably contains absorbent material 605 for binding the expelled fluid 615.

The neck portion 632 constricts and binds the shrunken stimulus sensitive gel 620, even when it is only partially collapsed or shrunken because of its shape. More specifically, as shown in at least FIG. 6A and FIG. 6B and as described in prior applications, the side of the neck portion 632 that faces the first compartment is wider than the portion that faces the second compartment 604, so that it acts as a funnel as the swollen stimulus sensitive gel 610 collapses and shrinks and moves into the second compartment 604 upon exposure to a predetermined stimulus, but prevents that shrunken stimulus sensitive gel 620 from expanding back into the first compartment 602 and re-revealing the indicator spot 616 in the second compartment 604 if the predetermined stimulus is removed and the shrunken stimulus sensitive gel 620 undergoes its reverse phase transition.

Although this embodiment is described in terms of the stimulus sensitive gel 610 and 620 preferably being initially swollen and preferably fully transparent (as the swollen stimulus sensitive gel 610 collapses or shrinks it becomes more opaque and at least partially blocks the view of an indicator spot 614 below it), one of ordinary skill in the art would appreciate that the same invention can be achieved with an initially shrunken stimulus sensitive gel 620 that is initially visually opaque but that expands or swells upon exposure to a predetermined stimulus so as to become at least partially if not fully transparent and reveal an indicator spot.

The first compartment 602 and second compartment 604 are formed in part by the backing layer 625 on the bottom of the stimulus indicating device 600, and an upper layer 626 on the top of the stimulus indicating device 600. The top layer 626 of the stimulus indicating device 600 is formed by at least the indicator window 612 and the top portion 608 of the top layer 626. The indicator spot 616 can be viewed through an indicator window 612 located in the top layer 626 of the stimulus indicating device 600, and that it is positioned above the indicator spot 616 located in the second compartment 604. The first compartment 602 and the second compartment 604 are additionally formed and differentiated from one another by the neck portion 632.

As shown in FIG. 6A prior to being exposed to a predetermined trigger stimulus, the swollen stimulus sensitive gel 610 has not yet undergone a phase transition and preferably is clear and transparent so that it preferably reveals the entire indicator spot 616. The indicator spot 616 is positioned below the indicator window 612, and is preferably completely visible through both the indicator window 612 and the swollen stimulus sensitive gel 610 prior to the stimulus indicating device 600 being exposed to the predetermined stimulus because the swollen stimulus sensitive gel 610. The swollen stimulus sensitive gel 610 contains preferably clear fluid 614 which allows the swollen stimulus sensitive gel 610 to maintain its expanded or swollen volume.

Upon exposure of the stimulus sensitive product to its predetermined phase transition stimulus, such as temperature, the swollen stimulus sensitive gel 610 would undergo its phase transition and collapse or shrink to become the shrunken stimulus sensitive gel 620 due to the loss of the water or liquid 614 contained in its matrix. As the swollen stimulus sensitive gel collapses or shrinks, it not only partially or wholly withdraws from the first compartment 602, but it collapses or shrinks into the second compartment 604 thereby at least partially if not fully covering the indicator spot 616. The more the swollen stimulus sensitive gel 610 collapses or shrinks the more it covers the indicator spot 616, and the more it becomes like the collapsed or shrunken stimulus sensitive gel 620 in FIG. 6B. Such partial or full obscuring of the indicator spot 616 by the collapse or shrinking and resulting collapsing of the swollen stimulus sensitive gel 610 over the indicator spot 616 to become the collapsed or shrunken stimulus sensitive gel 620 is the same for all variations of this embodiment discussed herein.

As discussed herein, this alternative embodiment of the stimulus indicating device 600 contains a stimulus sensitive gel 610 and 620 described herein in regard to FIG. 6A and FIG. 6B. As the stimulus sensitive gel is exposed to a predetermined stimulus, by way of example only a certain temperature, and it undergoes its phase transition by collapsing or shrinking in volume, it not only at least partially if not fully covers the indicator spot 616 previously visible through the display portion or indicator window 612 and through the previously transparent swollen stimulus sensitive gel 610, but it also expels the fluid 614 (by way of example only, water that can be trapped by absorbent material) from within the matrix of the swollen stimulus sensitive gel 610 and into at least the first compartment 602 if not also into the second compartment 604 of the stimulus indicator 600.

Upon exposure of the stimulus sensitive product to its predetermined phase transition stimulus, such as temperature, the swollen stimulus sensitive gel 610 would undergo its phase transition and collapse or shrink to become the shrunken stimulus sensitive gel 620 due to the loss of the fluid 614 contained in its matrix. As the swollen stimulus sensitive gel collapses or shrinks, it at least partially and preferably wholly covers and obscures the view of the indicator spot 616 previously visible through the indicator window 616, so that the indicator spot 612 is at least partially if not preferably fully hidden from the view of the user through the indicator window 612. The more the swollen stimulus sensitive gel 610 collapses or shrinks the more it collapses and covers and visually obscures or obfuscates the indicator spot 616, and the more it becomes like the collapsed or shrunken stimulus sensitive gel 620 in FIG. 6B. Such partial or preferably full covering or obfuscation of the indicator spot 616 by the collapse or shrinking of the swollen stimulus sensitive gel 610 to become the collapsed or shrunken stimulus sensitive gel 620 is the same for all variations of this embodiment discussed herein.

The swollen stimulus sensitive gel 610 can be made to undergo its phase transition when it is exposed to the proper or predetermined stimulus, such as and by way of example only, when it is heated or cooled to a designated temperature, depending on whether the polymer gel was of the LCST or UCST type. Regardless, as the swollen stimulus sensitive gel 610 collapses or shrinks, the fluid 614 (or other liquid or mixture) contained in the matrix of the swollen stimulus sensitive gel 610, is expelled.

The collapsing or shrinking of the swollen stimulus sensitive gel 610 (caused by the loss of the liquid 614 contained in the matrix of the swollen stimulus sensitive gel 610 when the swollen stimulus sensitive gel 610 undergoes its phase transition), thereby resulting in the shrunken stimulus sensitive gel 620 preferably collecting over the indicator spot 616 of the stimulus indicating device 600, would at least partially and preferably completely hide the colored indicator spot 616 previously visible through the indicator window 612 and through the swollen stimulus sensitive gel 610, thereby indicating to the user of the stimulus sensitive product that the product had been exposed to a harmful stimulus, such as an extreme temperature.

Although not needed in this embodiment because the neck portion provides the ability of the stimulus indicating device 600 to block the shrunken stimulus sensitive gel 620 from reexpanding and revealing the indicator spot 616, it may be desired to have an absorbent material (such as hygroscopic silica or another absorbent material) in either the first compartment 602 or the second compartment 604 or both, to absorb the expelled liquid 615 and permanently bind to the expelled fluid 615 expelled from the swollen stimulus sensitive gel 610 as discussed herein and incorporated by reference.

It should be noted that by manipulating the size of the neck portion 632 (e.g., the opening that faces the first compartment 602 and the opening that faces the second compartment) and/or manipulating the angle at which the neck portion travels from the first compartment 602 to the second compartment 604, the time required for stimulus sensitive gel 610 and 620 to move from the first compartment 602 into the second compartment 604, and thereby cover or obscure the indicator spot 616 can be varied. Such manipulation of the neck portion 632 includes increasing or decreasing its openings of the neck portion 632 and/or increasing or decreasing the angle of the neck portion 632, so as to control the speed at which the stimulus sensitive gel 610 and 620 moves from the first compartment 602 into the second compartment 604.

An advantage of using such an alternative embodiment of the stimulus indicating device 600 is that both the exposure to a predetermined stimulus as well as the cumulative time of exposure can be indicated. As an example, if the predetermined stimulus occurs for just a short period of time, and is removed before the stimulus sensitive gel 610 and 620 have completely moved from the first compartment 602 into the second compartment 604 because the neck portion 632 prevents the stimulus sensitive gel 610 and 620 from freely flowing into the second compartment 604, then the expelled liquid 615 will be wicked or drawn back into the portion of the shrunken stimulus sensitive gel 620 that remains in the first compartment 602 so as to re-expand or re-swell as a result of undergoing its reverse phase transition because for example the predetermined stimulus had been removed, and thereby preventing the stimulus indicating device 600 from changing from a first color 613 to a second color 617 or from a first indication to a second indication as described herein. And so in this case, no irreversible indication of exposure to the predetermined stimulus will be indicated by the stimulus indicating device 600 because the time of exposure to the predetermined stimulus was too brief to enable enough of the shrunken stimulus sensitive gel 620 to pass through the neck portion 632 and cause the stimulus indicating device 600 to change from a first indication to a second indication.

It should be noted that the predetermined temperature discussed herein that causes the swollen stimulus sensitive gel 610 to undergo its phase transition is only one example of a predetermined stimulus or trigger stimulus that will cause the inventive stimulus sensitive gel 610 and 620 to undergo its phase transition. For example, the swollen stimulus sensitive gel 610 of this preferred embodiment could trigger or undergo its phase transition upon exposure to a predetermined stimulus such as a predetermined pH level, or the swollen stimulus sensitive gel 610 of this preferred embodiment could trigger or undergo its phase transition upon exposure to a predetermined level of electromagnetic radiation.

As the expelled fluid 615 leaves the swollen stimulus sensitive gel 610, the swollen stimulus sensitive gel 610 collapses or shrinks in volume, so as to result in the shrunken stimulus gel 620 shown in FIG. 6B. As shown in FIG. 6B, as the swollen stimulus sensitive gel 610 collapses or shrinks in volume, it preferably moves towards the attachment point 618, and in a direction towards the indicator spot 616 and indicator window 612. Thus, by decreasing the volume of the swollen stimulus sensitive gel 610 to result in the shrunken stimulus sensitive gel 620, the indicator spot 616 becomes at least partially and preferably fully hidden or obscured to the view of the user through the indicator window 612. Thus, as the volume of the swollen stimulus sensitive gel 610 decreases it begins to resemble the shrunken stimulus sensitive gel 620, and hides the indicator spot 616 to the user through the indicator window 612.

It should be noted that it is not necessary for the swollen stimulus sensitive gel 610 to collapse or shrink entirely in order for the indicator spot 616 be less visible to the user. Instead, if even a portion of the indicator spot 616 is visible to the user through the indicator window 612, that is enough to signal to the user that the product attached to the stimulus indicating device 600 had been exposed to a potentially harmful stimulus. More specifically, although the decrease in volume of the swollen stimulus sensitive gel 610 in all of the embodiments of the stimulus indicating device 600 discussed herein containing a stimulus sensitive gel can be by any amount so long as it is registerable, preferably the decrease in volume of the swollen stimulus sensitive gel 610 would be between at least a 1/10 reduction in original volume, and up to a 500 times decrease in original volume. In regard to all embodiments of the stimulus indicating device 600 discussed herein as they pertain to the decrease in the volume being “registerable” what is meant is that the volume change of the swollen stimulus sensitive gel 610 expels enough liquid 614 and from the swollen stimulus sensitive gel 610 to cause the swollen stimulus sensitive gel 610 so as to cause the swollen stimulus sensitive gel 610 to collapse or shrink enough so that it becomes opaque enough to block the view of the indicator spot 616.

By way of example only, the indicator spot 616 (e.g., an indicator spot 616 that is the same color as the stimulus sensitive gel 610 and 620 but is a glyph, such as a happy face “ [symbol] ”) would be visible through the indicator window 612 and through the swollen stimulus sensitive gel 610 because of the transparency of the swollen stimulus sensitive gel 610 due to the unexpelled fluid 614 contained in the swollen stimulus sensitive gel 610. As the fluid 614 is expelled there is an increase in the opacity of an undyed collapsed or shrunken stimulus sensitive gel 620 that serves to provide an indication of exposure because it blocks the view of the indicator spot 616 (e.g., an indicator spot 616 that is the same color as the stimulus sensitive gel 610 and 620 but is a glyph, such as a happy face ( [symbol] )), which is at least partially and preferably fully covered from the view of the user through the indicator window 612, and indicates to the user that the product had been exposed to a predetermined stimulus.

Alternatively, the collapsing of a swollen stimulus sensitive gel 610 that contains colorant 611 also obscures the view of the indicator spot 616 because the shrinking or collapsing swollen stimulus sensitive gel 610 cause the colorant 611 to concentrate over the indicator spot 616 thereby resulting in a registerable change in color (e.g., as shown in FIG. 2A and FIG. 2B, a change in color from a first color to a second color).

Of course, one of ordinary skill in the art understands the reverse is true, such that a shrunken stimulus sensitive gel 620 is employed that initially hides or obscures the indicator spot 616, but upon exposure to a predetermined stimulus the shrunken stimulus sensitive gel 620 absorbs water and expands or swells enough so as to become the swollen stimulus sensitive gel 610 so that it reveals at least a portion or enough of the indicator spot 616 so that a registerable indication or change in color (e.g., revealing the glyph of the indicator spot 616, or a change in color from a first color to a second color, respectively) occurs in the stimulus indicating device 600, and is visible via the indicator window 612.

In regard to all the embodiments of the stimulus indicating device discussed herein being “irreversible” and “permanent,” what is meant is that once the stimulus indicating device provides an indication of exposure to an adverse stimulus extreme (which is also referred to herein as a predetermined stimulus), that indication of exposure does not change, even though the adverse stimulus extreme or predetermined stimulus might be removed in the future.

Both the backing layer 625 and the upper layer 626 may be constructed of a strong, resilient leak-proof material, such as plastic or other polymer material, so as to provide for the twisting or bending that might occur during transportation of or application to the stimulus sensitive product without tearing, breaking or leaking. The backing layer 625 and the upper layer 626 may also be made of a material that preferably allows them to be joined and sealed together, such as by heat stamping or other suitable means. The backing layer 625 and the upper layer 626 can both approximate the length and width of the first compartment 602, although variations in these dimensions are within the scope of the present invention. The upper layer 626 can preferably be made of a clear material, such as plastic, so that the user of the stimulus indicating device 600 can view at least some portion of the backing material or indicator spot 416. The upper layer 626 can also be able to accept paint or ink so as to allow for coloring or concealing at least some portion of the first compartment 602.

Although some portion of the upper layer 626 can also accept paint or ink for coloring, it is preferable that the indicator window 612 portion of the upper layer 626 remain free from ink or coloring so that the user of the stimulus indicating device 600 can observe the first compartment 602 through the indicator window 612 as explained herein.

The stimulus sensitive gel 610 and 620 employed by the alternative variations of this embodiment, as shown in FIG. 6A and FIG. 6B, is preferably manufactured so as to not contain a dye or colorant 611 because although a swollen stimulus sensitive gel 610 is transparent, when it expels its fluid and becomes a shrunken stimulus sensitive gel 620, it becomes visually cloudy or opaque. Thus, when the swollen stimulus sensitive gel 610 collapses or shrinks in response to the predetermined stimulus, by even a partial amount, the change or decrease in volume will result in the stimulus indicating device 600 changing, at least partially, from transparent to at least partially cloudy or opaque, because the stimulus sensitive gels discussed herein naturally become more cloudy or opaque and non-transparent as they shrink or collapse by even a partial amount.

Preferably the stimulus sensitive gel 610 and 620 is manufactured so as to be free of coloring or dye particles. But in an alternative embodiment the stimulus sensitive gel 610 and 620 could contain constituent parts 609 that could be dye particles. Importantly, the dye particles 609 would preferably be incorporated into the matrix of the stimulus sensitive gel 610 and 620. By incorporating the dye particles 609 into the matrix of the stimulus sensitive gel 610 and 620, those dye particles could be used to enhance or accelerate the visual impact of the swollen stimulus gel 610 as it expelled the fluid 614 and becomes the shrunken stimulus sensitive gel 620. Because the dye particles 609 are preferably incorporated into the matrix of the stimulus sensitive gel 610 and 620, they are not expelled from the swollen stimulus sensitive gel 610 when it collapses and becomes the shrunken stimulus sensitive gel 620. Instead, because the dye particles 609 are incorporated into the matrix of the stimulus sensitive gel 610 and 620, as the swollen stimulus sensitive gel 610 shrinks and collapses the dye particles become concentrated within the stimulus sensitive gel 610 and 620 so as to make the shrunken stimulus sensitive gel 620 even more opaque and able to block, even partially, the view of the indicator spot 616.

The stimulus sensitive gel 610 and 620 employed by the alternative variations of this embodiment, as shown in FIG. 6A and FIG. 6B, is preferably manufactured so as to not contain a dye or colorant 611 because although a swollen stimulus sensitive gel 610 is transparent, when it expels its fluid and becomes a shrunken stimulus sensitive gel 620, it becomes visually cloudy or opaque. Thus, when the swollen stimulus sensitive gel 610 collapses or shrinks in response to the predetermined stimulus, by even a partial amount, the change or decrease in volume will result in the stimulus indicating device 600 changing, at least partially, from transparent to at least partially cloudy or opaque, because the stimulus sensitive gels discussed herein naturally become more cloudy or opaque and non-transparent as they shrink or collapse by even a partial amount.

Although it is preferred that the stimulus sensitive gel 610 and 620 is manufactured to not contain a colorant 611 an alternative embodiment of the stimulus sensitive gel 610 and 620 could contain a colorant 611 such as dye particles, it is preferred that the dye particles or colorant be different from the color of the indicator spot 616. In this way the color of the stimulus sensitive gel 610 and 620 in both its swollen and collapsed state, is different from the color of the indicator spot 616. Thus, when the swollen stimulus sensitive gel 610 collapses or shrinks in response to the predetermined stimulus, by even a partial amount, the change or decrease in volume will result in the stimulus indicating device 600 changing, at least partially, from a first color to a second color, wherein the color change is visible to the user of the stimulus indicating device 600 through the indicator window 612. It should be noted that if the stimulus sensitive gel 610 and 620 does contain a colorant 611, when the stimulus sensitive gel is in its swollen state (i.e., the swollen stimulus sensitive gel 610), the concentration of colorant 611 contained in the swollen stimulus sensitive gel 610 should be either: i) minimal enough so that the swollen stimulus sensitive gel 610 preferably still appears transparent; or ii) of such a concentration that while it provides a minimal hue or coloring to the swollen stimulus sensitive 610, that hue or coloring is not so intense so as to obscure the user from viewing the coloring or shape of the indicator spot through the swollen stimulus sensitive gel 610. Regardless, as the swollen stimulus sensitive gel 610 does begin to shrink and expel its fluid, the colorant 611 (because its particles are embedded in the matrix of the stimulus sensitive gel) are not expelled from the gel matrix. Instead, the colorant 611 would concentrate over the indicator spot 616 as the swollen stimulus sensitive gel 610 shrank or collapsed, so as to aid in the covering and/or blocking the view of the indicator spot 616. Although the preferred version of this alternative embodiment contains a stimulus sensitive gel 610 and 620 that lacks any dye or colorant, an alternative version of the stimulus sensitive gel 610 and 620 of this alternative embodiment of the stimulus indicating device 600 can be colored so as and can be combined in conjunction with all the embodiments shown in FIG. 2A through FIG. 2F (and as discussed above in regard to FIG. 3A and FIG. 3B) to disclose to the user of the stimulus indicating device 600 that the product to which it is attached had been exposed to a predetermined stimulus.

Preferably, the stimulus sensitive gel 610 and 620 would be fixed or secured at the attachment point 618, or at more than one attachment point desired. The stimulus sensitive gel 610 and 620 may be fixed to the attachment point 618 with a suitable epoxy, glue, or it could be heat stamped upon creation of the stimulus indicating device 600. The attachment point 618 is preferably positioned at a point near to the indicator spot 616 and indicator window 612. Attaching the stimulus sensitive gel 610 and 620 to the attachment point 618 helps to ensure that the swollen stimulus sensitive gel 610 collapses or shrinks in a desired direction—preferably toward the attachment point 618, and toward the indicator spot 616 and toward the indicator window 612. Securing or fixing the stimulus sensitive gel 610 and 620 to the attachment point 618 prevents the stimulus sensitive gel 610 and 620 from floating or moving within the compartment and covering up the indicator spot 616 after the swollen stimulus sensitive gel 610 had undergone its phase transition, thereby preventing a false indication that the product attached to the stimulus indicator device 600 had not been exposed to a predetermined stimulus.

All embodiments discussed herein of the stimulus indicating device 600 containing the swollen stimulus sensitive gel 610 and the shrunken stimulus sensitive gel 620 may be based on any type of stimulus sensitive gel that undergoes a phase transition upon exposure of the stimulus sensitive gel to a predetermined stimulus.

By way of example only, the stimulus indicating device 600 can be manufactured using stimulus sensitive gels that include polyacrylic acid (PAA) gel, a polyacrylamide (PAAm) gel, and/or its variations such as poly n-isopropylacrylamide (PNIPAAm) gels, and/or their derivatives. As is known in the art, such stimulus sensitive gels and/or other equivalent gels and/or their derivatives, undergo a significant change in volume in response to a range of stimuli, including temperature, solvent composition, pH, ionic strength, etc.

By way of example only, it is known in the art that when the predetermined stimulus is temperature, the direction of the volume change in the stimulus sensitive gel 610 and 620 used in all the embodiments of the stimulus indicating device 600 discussed herein can be selected so as to correlate to a specific situation. For example, one of ordinary skill will appreciate and understand that if the stimulus sensitive gel in this embodiment is swollen at the beginning of its use as it undergoes its phase transition, it will collapse or shrink, thereby causing a change in color or indication in the stimulus indicator 600. Alternatively, the stimulus sensitive gel could start out collapsed or shrunken, but upon exposure to its predetermined stimulus it would permanently expand or swell and cause a change in color or indication in the stimulus indicator 600. By way of example only and as disclosed herein and in prior applications, a stimulus sensitive gel 610 and 620 can be of the UCST type or the LCST type gel.

As one of ordinary skill in the art will appreciate, a UCST type stimulus sensitive gel, such as PAAm gels, could be used when one wishes to have an initially and transparent or at least somewhat visually clear swollen stimulus sensitive gel collapse or shrink when cooled below a predetermined or trigger temperature and thereby: i) expel liquid; ii) so as to become at least partially opaque; and/or iii) at least partially, if not preferably fully, cover an indicator spot 616 and block its view by the user. By employing these characteristics, the stimulus indicating device 600 will provide a change in color or some other indication of exposure to a predetermined stimulus. A UCST type gel could also be used when one wishes to have the reverse characteristics, i.e., an initially shrunken stimulus sensitive gel that expands or swells when it is heated beyond a predetermined stimulus, and thereby: i) collect liquid; ii) so as to become at least partially transparent, and/or iii) at least partially if not fully reveal the indicator spot so as to result in a change in color or some other indication. change in color or indication.

Alternatively, an LCST type stimulus sensitive gel, such as PNIPAAm gels, could be used when one wishes to have an initially swollen and transparent stimulus sensitive gel collapse or shrink when heated above a predetermined or trigger temperature and thereby: i) expel liquid; ii) so as to become at least partially opaque; and/or iii) at least partially, if not preferably fully, cover an indicator spot and block its view by the user. By employing these characteristics, the stimulus indicating device 300 will result to provide a change in color or some other indication of exposure to a predetermined stimulus. An LCST type gel could also be used when one wishes to have the reverse characteristics, i.e., an initially shrunken stimulus sensitive gel that expands or swells when it is cooled below a predetermined stimulus, and thereby: i) collect liquid; ii) so as to become at least partially transparent; and iii) at least partially if not preferably fully reveal the indicator spot so as to result in a change in color or some other indication.

One of ordinary skill in the art will understand that although the stimulus sensitive gel 610 and 620 discussed herein in regard to the stimulus indicating device 600 may be of the LCST type of gel (i.e., the initially swollen stimulus sensitive gel 610 will collapse or shrink upon exposure to its predetermined stimulus of a warmer temperature, and become the shrunken stimulus sensitive gel 620; as well as expand or swell upon exposure to its predetermined stimulus of a cooler temperature, and become the swollen stimulus sensitive gel 610), the range and scope of this invention includes and envisions the swollen stimulus sensitive gel 610 and the shrunken stimulus sensitive gel 620 also being of the USCT type of gel. Moreover, it should be noted that all the variations of the different embodiments discussed herein can be combined with the variations of other embodiments described herein and that are known in the art, as would be understood to one of ordinary skill in the art.

The behavior of the USCT gels and the LCST gels depends on their chemical structure. Many examples of both kinds of polymers are known in the literature. For example, if the stimulus sensitive gel 610 and 620 employed in all the embodiments of the stimulus indicating device 600 discussed herein were made of USCT type stimulus sensitive gels, it could be any number of such USCT gels, including: i) polyacrylic acid (PAA) gel combined with polyacrylamide (PAAm) gel; or ii) PAAm gel combined with poly sodium 3-butenoate (SB) gel to result in the creation of poly(AAm-co-SB) gel; or iii) their derivates, and as described in Tanaka, “Gels,” Scientific American 244 (1981) at 124-138 and Tanaka, “Phase Transitions in Ionic Gels,” Physical Review Letters 45 (1980) at 1636-1639, the predetermined “trigger” stimulus at which a USCT gel undergoes its phase transition, and thereby expels the liquid 614 and thus collapses or shrinks in volume, can be “tuned” to a particular value by changing the solvent trapped in the gel polymer matrix in addition to introducing salts, surfactants, or other substances to the gel matrix. Such “tuning” in regard to UCST type gels is discussed herein and in U.S. Pat. No. 5,100,933. Similarly, if the stimulus sensitive gel 610 and 620 employed in all the embodiments of the stimulus indicating device 600 discussed herein were made of LSCT type stimulus sensitive gels, it could be any number of such LCST gels, including PNIPAAm gels, and as described in U.S. Pat. No. 4,732,930 in regard to PNIPAAm, the predetermined stimulus, such as temperature at which a stimulus sensitive gel 610 and 620 undergoes its phase transition and changes volume, can be “tuned” to a particular value by adding salts, surfactants, or other substances to the gel matrix. Explanations of how the transition temperature of an LCST gel can be tuned can be found in the following references: Zhang et al., “Specific Ion Effects on the Water Solubility of Macromolecules: PNIPAM and the Hofineister Series” Journal of the American Chemical Society volume 127 at 14505 to 14510 and Park et al., “Sodium Chloride-Induced Phase Transition in Nonionic Poly(N-isopropylacrylamide) Gel” Macromolecules volume 26 at 5045 to 5048.

Regardless of whether LCST type stimulus sensitive gels or USCT type stimulus sensitive gels are used to indicate exposure to a predetermined stimulus, what is important is that the change in volume of the stimulus sensitive gel be tailored to the application in which the stimulus indicator is being used. For example, a change in volume of the stimulus sensitive gel 610 and 620, and thus the corresponding expulsion of liquid 614 can be insignificant or it can be dramatic. If the desired visual indication is the result of the swollen stimulus sensitive gel 610 shrinking or completely and collapsing over and thereby visually blocking the view of the indicator spot 616 through the indicator window 612, then a large change in volume is preferred.

### Concentration Sensitive Gel—Acetone/Water

In accordance with the purpose of the invention, as embodied and broadly described herein and in conjunction with FIG. 7A and FIG. 7B, as well as with FIG. 2G through FIG. 2L, another embodiment of a stimulus sensitive gel employed in a stimulus indicating device is one that does not require the interaction of a secondary aspect so as to permanently indicate exposure to a predetermined stimulus. More particularly, this alternative embodiment of a stimulus sensitive device employs a stimulus sensitive gel in conjunction with an indicator spot, but does not require a secondary aspect (by way of example only, this means this alternative embodiment does not need to use another substance to absorb the liquid expelled from the gel in order to provide the indication of exposure to a detrimental stimulus; or it provides the indication of exposure to a detrimental stimulus without the need for another aspect to react to expelled constituent parts; or does not require a constricting portion to block the movement of the stimulus sensitive gel in order to provide the indication of exposure to a detrimental stimulus to enable it to permanently indicate to a user that the product attached to the stimulus indicating device had been exposed to a predetermined stimulus.

This ability to singularly and permanently indicate exposure to a predetermined stimulus results from attractive forces at the molecular level inside the stimulus sensitive gel. These attractive forces are the result of the strong affinity the polymer chains have for each other, which is caused in part by the hydrogen bonding and electrostatic attractions among the polymer chains of the stimulus sensitive gel used in this alternative embodiment. In this alternative embodiment discussed herein, the stimulus sensitive gel is of the UCST type of gel, and more preferably is of the polyacrylamide-co-sodium 3-butenoate type of UCST type gel. As such, the UCST type gels preferably used in this embodiment normally possess electrostatic interactions and hydrogen bonding between the acrylamide, acrylic acid and sodium 3-butenoate monomers forming the polymer chains. These are all weak forces when compared to the permanent covalent bonds, which link repeating units in a polymer chain.

When these weak forces found in the this alternative embodiment of the stimulus sensitive gel are multiplied by the myriad of such interactions taking place upon the stimulus sensitive gel undergoing its phase transition in reaction to a predetermined stimulus so as to collapse or shrink, that collapsed or shrunken state is permanently stabilized, even when the predetermined stimulus is removed.

The fact that the collapsed or shrunken stimulus sensitive gel is stabilized by weak forces, and is not stabilized by permanent bonds, is evidenced by the ability of the collapsed or shrunken stimulus sensitive gel employed in this alternative embodiment to undergo its reverse phase transition and return to its expanded or swollen state when for example, the solvent is replaced by fresh water. A discussion of how these forces may interact to stabilize the collapsed or shrunken state of this alternative stimulus sensitive gel is disclosed by Ilmain et al., “Volume Transition in a Gel Driven by Hydrogen Bonding,” Nature volume 349 at 400 to 401, and is incorporated herein.

In contrast, there are other types of stimulus sensitive gels, such as LCST types gel and in particular, is a PNIPAAm type of stimulus sensitive gel so that when it collapses or shrinks in response to a predetermined stimulus, it will undergo reverse phase transition when the predetermined stimulus is removed because PNIPAAm chains have a limited ability to interact electrostatically since they are not electrically charged, nor form hydrogen bonds since carboxylic acid groups are absent. Consequently, the reverse transition occurs quite easily.

In these alternative embodiments, the stimulus sensitive gel is kept in a bath of liquid that bathes the swollen stimulus sensitive gel and prevents it from prematurely undergoing its phase transition due to the volatile liquid or constituent parts contained in the swollen stimulus sensitive gel (by way of example only, the acetone) evaporating before the stimulus sensitive gel could be sealed in its container. The scope of this embodiment, however, includes the use of proper manufacturing procedures and precautions so that this alternative swollen stimulus sensitive gel could be manufactured without being contained in a liquid bath.

Accordingly, when the swollen stimulus sensitive gel of these embodiments collapses or shrinks to become the shrunken stimulus sensitive gel, the attractive forces are so strong that the shrunken stimulus sensitive gel remains collapsed or shrunken post-phase transition so long as the shrunken stimulus sensitive gel remains in the closed environment and no tangible substances are allowed to enter or leave the compartment, thereby maintaining the fluid surrounding the shrunken stimulus sensitive gel in a constant state. Thus, so long as the liquid surrounding the post-phase transition stimulus sensitive gel remains constant, the shrunken stimulus sensitive gel will remain collapsed or shrunken and the indicator spot will remain covered or hidden through the indicator window, even if the predetermined stimulus is subsequently removed.

In accordance with the purpose of the invention, as embodied and broadly described herein and in conjunction with FIG. 7A and FIG. 7B, an alternative embodiment of the inventive stimulus indicating devices described herein preferably has a single compartment or first compartment 702 containing a preferably swollen stimulus sensitive gel 710, and indicator spot 716, and a liquid bath 703. Although this embodiment is described in terms of the stimulus sensitive gel preferably being swollen initially so as to initially reveal an indicator spot and when it shrinks or collapses it becomes more opaque and obscure or cover the indicator spot, as discussed herein in regard to stimulus sensitive gels, one of ordinary skill in the art would appreciate that the same invention can be achieved with an initially shrunken stimulus sensitive gel obscuring or covering an indicator spot that expands or swells upon exposure to a predetermined stimulus so as to reveal an indicator spot. In this alternative embodiment the first compartment 702 is formed by the backing layer 725 on the bottom of the stimulus indicating device 700 and an upper layer 726 on the top of the stimulus indicating device 700. The top layer 726 of the stimulus indicating device 700 is formed by at least the indicator window 712 and the top portion 708 of the top layer 726. The indicator spot 716 can be viewed through an indicator window 712 located in the top layer 726 of the stimulus indicating device 700. The swollen stimulus sensitive gel 710 is surrounded by the liquid bath 703.

Prior to being exposed to a predetermined trigger stimulus, the swollen stimulus sensitive gel 710 has not yet undergone a phase transition and stretches out among the first compartment 702 so that it covers the entire indicator spot 716. The indicator spot 716 is positioned below the indicator window 712, and is preferably fully visible through the swollen stimulus sensitive gel 710 and through the indicator window 708 prior to the stimulus indicating device 700 being exposed to the predetermined stimulus because the swollen or expanded stimulus sensitive gel 710 is preferably fully clear or transparent. As shown in FIG. 7A, only a portion of the swollen stimulus sensitive gel 710 is visible through the indicator window 712, with the remaining portion of the swollen stimulus sensitive gel 710 hidden from the view of the user by the top portion 708 of the stimulus indicating device 700.

The swollen stimulus sensitive gel 710 contains fluid 714 which allows the swollen stimulus sensitive gel 710 to maintain its expanded or swollen volume as well as its transparent appearance. When the swollen stimulus sensitive gel 710 is exposed to a predetermined stimulus, however, it undergoes its phase transition and the fluid 714 contained in the swollen stimulus sensitive gel 710 is expelled from the swollen stimulus sensitive gel 710 and enters the liquid bath 703.

As the expelled fluid 715 and/or constituent parts 711 leave the swollen stimulus sensitive gel 710, the swollen stimulus sensitive gel 710 collapses or shrinks in volume, so as to result in the shrunken stimulus gel 720 shown in FIG. 7B collected over the indicator spot 716. As shown in FIG. 7B, as the swollen stimulus sensitive gel 710 collapses or shrinks in volume, it preferably moves towards the attachment point 718, and in a direction toward the indicator spot 716 and indicator window 712. Thus, by decreasing the volume of the swollen stimulus sensitive gel 710 to result in the shrunken stimulus sensitive gel 720, the indicator spot 716 is visible to the user through the indicator window 712. Thus, as the volume of the swollen stimulus sensitive gel 710 decreases it begins to resemble the shrunken stimulus sensitive gel 720, and hides or obscures the indicator spot 716 to the user through the indicator window 712.

It should be noted that it is not necessary for the swollen stimulus sensitive gel 710 to collapse or shrink entirely in order for the indicator spot 716 to become less transparent or clear and block the view of the indicator spot from the user. Instead, if even a portion of the indicator spot 716 is obscured from the view of the user through the indicator window 712, that is enough to signal to the user that the product attached to the stimulus indicating device 700 had been exposed to a potentially harmful stimulus.

More specifically, although the decrease in volume of the swollen stimulus sensitive gel 710 in all of the embodiments of the stimulus indicating device 700 discussed herein can be by any amount so long as it is registerable, preferably the decrease in volume of the swollen stimulus sensitive gel 710 would be between at least a 1/10 reduction in original volume, and up to a 500 times decrease in original volume. In regard to all embodiments of the stimulus indicating device 700 discussed herein as they pertain to the decrease in the volume being “registerable” what is meant is that the volume change of the swollen stimulus sensitive gel 710 expels enough liquid 714 711 from the swollen stimulus sensitive gel 710 to cause the swollen stimulus sensitive gel 710 to collapse or shrink enough so that it hides or obscures enough of the indicator spot 716 so that a registerable change in color (e.g., a change in color from a first color to a second color) or indication (e.g., an indicator spot 716 that is the same color as the stimulus sensitive gel 710 and 720 but is a glyph, such as an happy face or “ [symbol] ”) occurs in the stimulus indicating device 700, and is blocked or obscured from the indicator window 712, and indicates to the user that the product had been exposed to a predetermined stimulus. Of course, one of ordinary skill in the art understands the reverse is true, and that if a stimulus sensitive gel 710 and 720 is employed that covers up the indicator spot upon exposure to a predetermined stimulus, then it need only cover a portion or enough of the indicator spot 716 so that a registerable change in color (e.g., a change in color from a first color to a second color) occurs in the stimulus indicating device 700, and is visible via the indicator window 712.

As discussed herein, this alternative embodiment of the stimulus indicating device 700 initially contains a swollen stimulus sensitive gel 710 that uses the attractive forces within the stimulus sensitive gel 710 and 720 to permanently indicate exposure to a predetermined stimulus. These attractive forces are the result of the strong affinity the polymer chains in the shrunken stimulus sensitive gel 720 have for each other, which is caused in part by the hydrogen bonding and electrostatic attractions among the polymer chains of the shrunken stimulus sensitive gel 720 used in this alternative embodiment. In this alternative embodiment, the stimulus sensitive gel 710 and 720 is of the UCST type of gel, and more preferably is of the polyacrylamide-co-sodium 3-butenoate type of UCST type gel. As such, the UCST type gels normally possess electrostatic interactions and hydrogen bonding between the acrylamide, acrylic acid and sodium 3-butenoate monomers forming the polymer chains. These are all weak forces when compared to the permanent covalent bonds, which link repeating units in a polymer chain.

When these weak forces found in this alternative stimulus sensitive gel 710 and 720 are multiplied by the myriad of interactions that occur when the swollen stimulus sensitive gel 710 undergoes its phase transition in reaction to a predetermined stimulus and collapses or shrinks so as to become (even partially) the shrunken stimulus sensitive gel 720, that collapsed or shrunken stimulus sensitive gel 720 is permanently stabilized, even when the predetermined stimulus is removed. A discussion of how these forces may interact to stabilize the collapsed or shrunken state of this alternative stimulus sensitive gel is disclosed by Ilmain et al., “Volume Transition in a Gel Driven by Hydrogen Bonding,” Nature volume 349 at 400 to 401, and is incorporated herein.

The collapsed or shrunken stimulus sensitive gel 720 will remain stabilized and in its collapsed state, and will not undergo its reverse phase transition and thereby expand or swell to its original volume unless the solvent is replaced by fresh water.

Whether or not the combined strength of the weak attractions present in the shrunken stimulus sensitive gel is sufficient to stabilize the shrunken state and prevent it from expanding to the swollen state once the harmful stimulus is removed is dependent on: (i) the monomers building the chains themselves and (ii) the type of solvent and constituent parts and the relative amounts of them contained within the stimulus sensitive gel. For example and as explained herein, manipulating the amount of water and acetone in a swollen stimulus sensitive gel 710 will cause the swollen stimulus sensitive gel 710 to require either greater or lesser intensity of its predetermined stimulus in order to undergo its phase transition and collapse or shrink.

For example, if the predetermined stimulus was (by way of example only) temperature, decreasing the concentration of the acetone in the swollen stimulus sensitive gel 710 during its manufacture will cause that swollen stimulus sensitive gel 710 to require a cooler temperature in order to undergo its phase transition and collapse or shrink so as to become the permanently shrunken stimulus sensitive gel 720, and remain permanently collapsed or shrunken until the solvent is replaced by fresh water.

For example, if the swollen stimulus sensitive gel 710 is a 10% crosslinked poly (AAm-co-SB) gel that has a acetone concentration of 59.5%, the transition temperature would be 2° C. However, if the swollen stimulus sensitive gel 710 is a 10% crosslinked poly (AAm-co-SB) gel that has a acetone concentration of 61%, the transition temperature would occur at room temperature or roughly 22° C.

As the stimulus sensitive gel is exposed to a predetermined stimulus, by way of example only a certain temperature, and it undergoes its phase transition by collapsing or shrinking in volume, it not only begins to at least partially (and preferably fully) hides or obscures the indicator spot 716 previously visible through the display portion or indicator window 712, but it expels the fluid 711 (by way of example only, water) and constituent parts 711 (by way of example only, acetone) from within the matrix of the swollen stimulus sensitive gel 710 and into the fluid 703 contained in the single compartment 702 of the stimulus indicator 700 that surrounds and bathes the swollen stimulus sensitive gel 710. Importantly, as the fluid 711 are expelled from within the matrix of the swollen stimulus sensitive gel 710 and into the fluid 703 contained in the single compartment 702, the attractive forces within the matrix of the swollen stimulus sensitive gel 710 and 720 cause the partially or fully shrunken stimulus sensitive gel 720 to remain permanently collapsed or shrunken (even partially). Thus, the attractive forces resulting from the strong affinity the polymer chains in the shrunken stimulus sensitive gel 720 have for each other, which is caused in part by the hydrogen bonding and electrostatic attractions among the polymer chains of the shrunken stimulus sensitive gel 720 keeps the shrunken stimulus sensitive gel 720 collapsed or shrunken. Thus, this alternative embodiment of this invention does not follow the typical reversibility pattern of a stimulus sensitive gel 710 and 720 (i.e., the collapsed or shrunken stimulus sensitive gel 720 of this alternative embodiment will not expand or swell back to or near its original volume when the predetermined stimulus is removed) because so long as the shrunken stimulus sensitive gel 720 is maintained in a stimulus indicating device 700 in which the first compartment 702 is closed to tangible substances (i.e., the shrunken stimulus sensitive gel 720 and the fluid 703 surrounding the shrunken stimulus sensitive gel 720 are contained in the first compartment 702 that is sealed and that prevents any outside liquids or constituent parts from passing into or out of that sealed first compartment 702), but is open to intangible stimuli (i.e., the sealed first compartment 702 still allows stimuli that cause the stimulus sensitive gel 710 and 720 to undergo a phase transition, to pass in and out of the sealed first compartment 702), the shrunken stimulus sensitive gel 720 will not expand or swell back to (or near to) its original swollen stimulus sensitive gel 710 volume, even when the predetermined stimulus is removed (by way of example only, even if the subsequent temperature of the shrunken stimulus sensitive gel 720 far exceeds the temperature at which the previously swollen stimulus sensitive gel 710 collapsed or shrunk in reaction to that predetermined stimulus). Because the shrunken stimulus sensitive gel 720 in this alternative embodiment remains collapsed or shrunken even when the predetermined stimulus is removed, so long as the shrunken stimulus sensitive gel 720 remains in a closed environment, the indicator spot 716 in the stimulus indicating device 700 will remain permanently blocked or obscured from the view of the user of the stimulus indicating device 700. More particularly, shrunken stimulus sensitive gel 720 of this alternative embodiment will only undergo its reverse phase transition and expand or swell back to the swollen stimulus sensitive gel's 710 original volume when: i) the predetermined stimulus is removed; and ii) the sealed first compartment 702 in which the shrunken stimulus sensitive gel 720 is contained is no longer closed to tangible substances (by way of example only, distilled water is added to the first compartment 702).

By way of example only, if predetermined stimulus is removed and the acetone-water mixture inside the polymer matrix of the shrunken stimulus sensitive gel 720 of this alternative embodiment is replaced with pure distilled and deionized water, the shrunken stimulus sensitive gel will undergo its reverse phase transition and will expand or swell back to its original swollen stimulus sensitive gel 710 volume. By way of example only, if the swollen stimulus sensitive gel 710 of this alternative embodiment collapses or shrinks in response to a predetermined stimulus of a temperature dropping below 2° C., that then shrunken stimulus sensitive gel 720 will not expand or swell back to or near its original volume or size even when the temperature of the shrunken stimulus sensitive gel 710 is increased to ambient temperature (25° C. or 77° F.) or higher for a period of months.

Thus, because of the method of manufacture of the stimulus sensitive gel 710 and 720 in this alternative embodiment as disclosed herein, the shrunken stimulus sensitive gel 720 remains collapsed or shrunken so long as the first compartment 702 of the stimulus indicating device 700 system remains closed or sealed (by way of example only, no distilled liquid is withdrawn from the first compartment 702 nor are they inserted into the first compartment 702), the collapsed or shrunken stimulus sensitive gel 720 is unable to expand or swell when the predetermined trigger stimulus (by way of example only, the temperature of the stimulus sensitive gel goes below 2° C.) is removed. Thus, the indicator spot 716 that became at least partially (and preferably fully) blocked or obscured from view upon the collapsing or shrinking of the previously swollen stimulus sensitive gel 710 is now permanently blocked or obscured from view due to the shrunken stimulus sensitive gel 720 being permanently collapsed or shrunken in volume.

It will be appreciated that the embodiment discussed herein teaching the stimulus sensitive gel 710 and 720 as containing water as the liquid 714 and acetone as the constituent parts 711 is illustrative only; and it will be appreciated that the liquid 714 and those constituent parts 711 could be replaced by any other substances or mixtures or elements or ions that work for the same purpose, such as mixtures of ethanol and water, or mixtures of water and other non-polar and polar solvents, etc.

It should be noted that the predetermined temperature discussed herein that causes the swollen stimulus sensitive gel 710 to undergo its phase transition is only one example of a predetermined stimulus or trigger stimulus that will cause the inventive stimulus sensitive gel 710 and 720 to undergo its phase transition. For example, the swollen stimulus sensitive gel 710 of this alternative embodiment could trigger or undergo its phase transition upon exposure to a predetermined stimulus such as a predetermined pH level, or the swollen stimulus sensitive gel 710 of this alternative embodiment could trigger or undergo its phase transition upon exposure to a predetermined level of electromagnetic radiation.

In regard to all the embodiments of the stimulus indicating device discussed herein being “irreversible” and “permanent,” what is meant is that once the stimulus indicating device provides an indication of exposure to an adverse stimulus extreme (which is also referred to herein as a predetermined stimulus), that exposure indication does not change, even though the adverse stimulus extreme or predetermined stimulus might be removed in the future.

Both the backing layer 725 and the upper layer 726 may be constructed of a strong, resilient leak-proof material, such as plastic or other polymer material, so as to provide for the twisting or bending that might occur during transportation of or application to the stimulus sensitive product without tearing, breaking or leaking. The backing layer 725 and the upper layer 726 may also be made of a material that preferably allows them to be joined and sealed together, such as by heat stamping or other suitable means. The backing layer 725 and the upper layer 726 can both approximate the length and width of the first compartment 702, although variations in these dimensions are within the scope of the present invention. The upper layer 726 can preferably be made of a clear material, such as plastic. The upper layer 726 can also be able to accept paint or ink so as to allow for coloring or concealing at least some portion of the first compartment 702.

Although some portion of the upper layer 726 can also accept paint or ink for coloring, it is preferable that the indicator window 712 portion of the upper layer 726 remain free from ink or coloring so that the user of the stimulus indicating device 700 can observe the first compartment 702 through the indicator window 712 as explained herein.

Although it is preferred that the stimulus sensitive gel 710 and 720 is manufactured to not contain a colorant 711 an alternative embodiment of the stimulus sensitive gel 710 and 720 could contain a colorant 711 such as dye particles, it is preferred that the dye particles or colorant be different from the color of the indicator spot 716. In this way the color of the stimulus sensitive gel 710 and 720 in both its swollen and collapsed state, is different from the color of the indicator spot 716. Thus, when the swollen stimulus sensitive gel 710 collapses or shrinks in response to the predetermined stimulus, by even a partial amount, the change or decrease in volume will result in the stimulus indicating device 700 changing, at least partially, from a first color to a second color, wherein the color change is visible to the user of the stimulus indicating device 700 through the indicator window 712. It should be noted that if the stimulus sensitive gel 710 and 720 does contain a colorant 711, when the stimulus sensitive gel is in its swollen state (i.e., the swollen stimulus sensitive gel 710), the concentration of colorant 711 contained in the swollen stimulus sensitive gel 710 should be either: i) minimal enough so that the swollen stimulus sensitive gel 710 preferably still appears transparent; or ii) of such a concentration that while it provides a minimal hue or coloring to the swollen stimulus sensitive 710, that hue or coloring is not so intense so as to obscure the user from viewing the coloring or shape of the indicator spot through the swollen stimulus sensitive gel 710. Regardless, as the swollen stimulus sensitive gel 710 does begin to shrink and expel its fluid, the colorant 711 (because its particles are embedded in the matrix of the stimulus sensitive gel) are not expelled from the gel matrix. Instead, the colorant 711 would concentrate over the indicator spot 716 as the swollen stimulus sensitive gel 710 shrank or collapsed, so as to aid in the covering and/or blocking the view of the indicator spit 716.

In either the undyed or dyed embodiment, the color of the stimulus sensitive gel 710 and 720 in both its swollen and collapsed state, is different from the color of the indicator spot 716. Thus, when the swollen stimulus sensitive gel 710 collapses or shrinks in response to the predetermined stimulus, by even a partial amount, the change or decrease in volume will result in the stimulus indicating device 700 changing, at least partially, from a first color to a second color, wherein the color change is visible to the user of the stimulus indicating device 700 through the indicator window 712.

Although the preferred version of this alternative embodiment contains a stimulus sensitive gel 710 and 720 that lacks any dye or colorant, an alternative version of the stimulus sensitive gel 710 and 720 of this alternative embodiment of the stimulus indicating device 700 can be colored so as and can be combined in conjunction with all the embodiments shown in FIG. 2A through FIG. 2F (and as discussed above and in regard to FIG. 3A and FIG. 3B) to disclose to the user of the stimulus indicating device 700 that the product to which it is attached had been exposed to a predetermined stimulus.

Preferably, the stimulus sensitive gel 710 and 720 would be fixed or secured at the attachment point 718, or at more than one attachment point desired. The stimulus sensitive gel 710 and 720 may be fixed to the attachment point 718 with a suitable epoxy, glue, or it could be heat stamped upon creation of the stimulus indicating device 700. The attachment point 718 is preferably positioned at a point near the indicator spot 716 and indicator window 712. Attaching the stimulus sensitive gel 710 and 720 to the attachment point 718 helps to ensure that the swollen stimulus sensitive gel 710 collapses or shrinks in a desired direction—preferably toward both the attachment point 718, and toward the indicator spot 716 and the indicator window 712. Securing or fixing the stimulus sensitive gel 710 and 720 to the attachment point 718 prevents the stimulus sensitive gel 710 and 720 from floating or moving within the compartment and re-revealing the indicator spot 716 after the swollen stimulus sensitive gel 710 had undergone its phase transition, thereby preventing a false indication that the product attached to the stimulus indicator device 700 had not been exposed to a predetermined stimulus.

All embodiments discussed herein of the stimulus indicating device 700 containing the swollen stimulus sensitive gel 710 and the shrunken stimulus sensitive gel 720 may be based on any type of stimulus sensitive gel that undergoes a phase transition upon exposure of the stimulus sensitive gel to a predetermined stimulus.

By way of example only, the stimulus indicating device 700 of this alternative embodiment can be manufactured using stimulus sensitive gels that include polyacrylic acid (PAA) gel, a polyacrylamide (PAAm) gel, and/or its variations such as poly(N-isopropylacrylamide) (PNIPAAm) gels, and/or their derivatives. As is known in the art, such stimulus sensitive gels and/or other equivalent gels and/or their derivatives, undergo a significant change in volume in response to a range of stimuli, including temperature, solvent composition, pH, ionic strength, etc.

By way of example only, it is known in the art that when the predetermined stimulus is temperature, the direction of the volume change in the stimulus sensitive gel 710 and 720 used in all the embodiments of the stimulus indicating device 700 discussed herein can be selected so as to correlate to a specific situation. For example, one of ordinary skill will appreciate and understand that if the stimulus sensitive gel in this embodiment is swollen at the beginning of its use as it undergoes its phase transition, it will collapse or shrink, thereby causing a change in color or indication in the stimulus indicator 700. Alternatively, the stimulus sensitive gel could start out collapsed or shrunken, but upon exposure to its predetermined stimulus it would permanently expand or swell and cause a change in color or indication in the stimulus indicator 700.

As one of ordinary skill in the art will appreciate, a UCST type stimulus sensitive gel, such as PAAm gels, could be used when one wishes to have an initially swollen and transparent or at least somewhat visually clear swollen stimulus sensitive gel collapse or shrink when cooled below a predetermined or trigger temperature and thereby: i) expel liquid; ii) so as to become at least partially opaque; and/or iii) at least partially, if not preferably fully, cover an indicator spot 716 and block its view by the user. By employing these characteristics, the stimulus indicating device 700 will provide a change in color or some other indication of exposure to a predetermined stimulus. A UCST type gel could also be used when one wishes to have the reverse characteristics, i.e., an initially shrunken stimulus sensitive gel that expands or swells when it is heated beyond a predetermined stimulus, and thereby: i) collect liquid; ii) so as to become at least partially transparent, and/or iii) at least partially if not fully reveal the indicator spot so as to result in a change in color or some other indication.

Alternatively, an LCST type stimulus sensitive gel, such as PNIPAAm gels, could be used when one wishes to have an initially swollen and transparent stimulus sensitive gel collapse or shrink when heated above a predetermined or trigger temperature and thereby: i) expel liquid; ii) so as to become at least partially opaque; and/or iii) at least partially, if not preferably fully, cover an indicator spot and block its view by the user. By employing these characteristics, the stimulus indicating device 700 will result to provide a change in color or some other indication of exposure to a predetermined stimulus. An LCST type gel could also be used when one wishes to have the reverse characteristics, i.e., an initially shrunken stimulus sensitive gel that expands or swells when it is cooled below a predetermined stimulus, and thereby: i) collect liquid; ii) so as to become at least partially transparent; and iii) at least partially if not preferably fully reveal the indicator spot so as to result in a change in color or some other indication.

One of ordinary skill in the art will understand that although the stimulus sensitive gel 710 and 720 discussed herein in regard to the stimulus indicating device 700 may be of the UCST type of gel (i.e., the initially swollen stimulus sensitive gel 710 will collapse or shrink upon exposure to its predetermined stimulus of a cooler temperature, and become the shrunken stimulus sensitive gel 720; as well as expand or swell upon exposure to its predetermined stimulus of a wanner temperature, and become the swollen stimulus sensitive gel 720), the range and scope of this invention includes and envisions the swollen stimulus sensitive gel 710 and the shrunken stimulus sensitive gel 720 also being of the LCST type of gel. Moreover, it should be noted that all the variations of the different embodiments discussed herein can be combined with the variations of other embodiments described herein and that are known in the art, as would be understood to one of ordinary skill in the art.

The behavior of the USCT gels and the LCST gels depends on their chemical structure. Many examples of both kinds of polymers are known in the literature. For example, if the stimulus sensitive gel 710 and 720 employed in all the embodiments of the stimulus indicating device 700 discussed herein were made of USCT type stimulus sensitive gels, it could be any number of such USCT gels, including: i) polyacrylic acid (PAA) gel combined with polyacrylamide (PAAm) gel; or ii) PAAm gel combined with poly sodium 3-butenoate (SB) gel to result in the creation of poly(AAm-co-SB) gel; or iii) their derivates, and as described in Tanaka, “Gels,” Scientific American 244 (1981) at 124-138 and Tanaka, “Phase Transitions in Ionic Gels,” Physical Review Letters 45 (1980) at 1636-1639, the predetermined “trigger” stimulus at which a USCT gel undergoes its phase transition, and thereby expels the liquid 714 and thus collapses or shrinks in volume, can be “tuned” to a particular value by changing the solvent trapped in the gel polymer matrix in addition to introducing salts, surfactants, or other substances to the gel matrix. Such “tuning” in regard to UCST type gels is discussed herein as well in prior applications. Similarly, if the stimulus sensitive gel 710 and 720 employed in all the embodiments of the stimulus indicating device 700 discussed herein were made of LSCT type stimulus sensitive gels, it could be any number of such LSCT gels, including PNIPAAm and as described in U.S. Pat. No. 4,732,930 in regard to PNIPAAm or LCST type gels the predetermined stimulus, such as temperature at which a stimulus sensitive gel 710 and 720 undergoes its phase transition and changes volume, can be “tuned” to a particular value by adding salts, surfactants, or other substances to the gel matrix. Explanations of how the transition temperature of an LCST gel can be tuned can be found in the following references: Zhang et al., “Specific Ion Effects on the Water Solubility of Macromolecules: PNIPAM and the Hofineister Series” Journal of the American Chemical Society volume 127 at 14505 to 14510 and Park et al., “Sodium Chloride-Induced Phase Transition in Nonionic Poly(N-isopropylacrylamide) Gel” Macromolecules volume 26 at 5045 to 5048.

Regardless of whether LCST type stimulus sensitive gels or USCT type stimulus sensitive gels are used to indicate exposure to a predetermined stimulus, what is important is that the change in volume of the stimulus sensitive gel be tailored to the application in which the stimulus indicator is being used. For example, a change in volume of the stimulus sensitive gel 710 and 720, and thus the corresponding expulsion of liquid 714 can be insignificant or it can be dramatic. If the desired visual indication is the result of the swollen stimulus sensitive gel 710 shrinking and collapsing above and thereby visually blocking the view of the indicator spot 716 through the indicator window 712, then a large change in volume is preferred.

### Method for Manufacturing; Doping and Setting the Trigger Temperature of a Hot-Side Temperature

For all the embodiments of the swollen stimulus sensitive gel discussed herein, the swollen stimulus sensitive gel can be manufactured to undergo its phase transition at any predetermined stimulus. By way of example only, the swollen stimulus sensitive gel discussed herein could be of the UCST type and could be made to trigger or undergo its phase transition (i.e., collapse or shrink and expel the fluid and/or constituent parts) upon exposure to a temperature of less than 2° C. Alternatively, and by way of example only, the swollen stimulus sensitive gel discussed herein could be of the LCST type and could be made to trigger or undergo its phase transition (i.e., collapse or shrink and expel the fluid and/or constituent parts) upon exposure to a temperature greater than 8° C. It will be understood by one of ordinary skill in the art that other temperatures and/or stimuli can be set as the predetermined stimulus by varying the method and/or ingredients disclosed herein.

By way of example only, the discussion below will disclose how to make a swollen stimulus sensitive gel of the LCST type, which undergoes its phase transition (i.e., collapses or shrinks and thereby expels the liquid and constituent parts contained in the swollen stimulus sensitive gel) upon being exposed to a temperature warmer than 8° C.

The method of manufacturing such a swollen stimulus sensitive gel comprises three steps. In the first step, NIPAAm and N,N′-methylenebisacrylamide (BIS) are polymerized to form a PNIPAAm gel. The gel as synthesized exhibits a transition temperature of 37° C. In the second step, the transition temperature of the gel is adjusted to the desired transition temperature via the addition of salts, surfactants or solvents. Once the amounts of additives required to obtain gel formulations that trigger at the desired transition temperatures are well established, these need not be repeated for all gels.

Taken together, all these steps comprise the process of preparing a swollen stimulus sensitive gel that will undergo its volume transition upon being exposed to a predetermined stimulus as well as provide foolproof, permanent and irreversible indication of the stimulus sensitive product's exposure to such stimulus.

### 1. Preparation of Polymer Gels by Polymerization of NIPAAm

By way of example only, the swollen stimulus sensitive gel is prepared as a LCST type of polymer gel, and by way of example only, this LCST type of polymer gel created via the polymerization of NIPAAm. This polymerization of NIPAAm is accomplished by employing the following ingredients, although one of ordinary skill in the art will recognize that certain of the following ingredients can be replaced by other similar types of ingredients, and recognizes/understands that the amounts of the ingredients are exemplary only. Accordingly, the amounts of the ingredients can be varied by any amount so long as the desired gel is created. Moreover, the amounts can be increased or decreased proportionally so that larger or smaller amounts of swollen stimulus sensitive gel can be created. The ingredients include:
i) 1 grams of NIPAAm (97% purity from Aldrich);
ii) 20 milliliters of distilled and deionized water;
iii) 0.0133 grams of N,N′-methylenebisacrylamide (electrophoresis grade from Aldrich);
iv) 0.02 grams of ammonium persulfate (98% purity from Aldrich); and
v) 0.24 microliters of N,N,N′,N′-tetramethylethylenediamine (abbreviated TEMED, 98% purity from Aldrich).

It should be noted that as described herein, it is preferred that the stimulus sensitive gel be free from any coloring or colorant, because once the transparent swollen stimulus sensitive gel collapses, it becomes very opaque, and can block the view of the indicator spot just by itself. Accordingly, there is not a need for a colorant. However, if a colorant is desired for the stimulus sensitive gel, the manufacture of the gel can include 0.025 grams of Red 110 M (from LanXess Corporation). This amount in proportion to the other ingredients included in the manufacture of the gel, will be of such a concentration that it allow the swollen stimulus sensitive gel to have a transparent appearance, but when the swollen stimulus sensitive gel expels its fluid and shrinks, the red colorant will concentrate over the indicator spot, thereby providing an indication of exposure to a predetermined stimulus.

In order to manufacture such gel, the following method is preferably followed, although one of ordinary skill in the art will recognize that certain steps can be performed in varying order, and the amounts can be varies as described herein or as known to one of ordinary skill in the art:

TEMED catalyzes the polymerization reaction such that the reaction may occur at low temperatures (near 0° C.) although one of ordinary skill in the art will recognize that TEMED may be substituted with another redox polymerization catalyst such as Sodium Metabisulfite.

In order to manufacture the swollen stimulus sensitive gel, the following method is preferably followed, although one of ordinary skill in the art will recognize that certain steps can be performed in varying order, one of ordinary skill in the art will recognize that other materials could be substituted for the listed materials, and one of ordinary skill in the art will recognize that the amounts can be varied:
1. The distilled and deionized water is purged with nitrogen gas for 15 to 20 minutes so as to remove all possible amounts of oxygen.
2. Using a disposable 10 ml plastic pipette, 10 milliliters of distilled and deionized water are added into a 20 milliliter glass scintillation vial.
3. The entire 1 gram of NIPAAm is added into the scintillation vial and that mixture stirred thoroughly for about 5 minutes.
4. The entire 0.0133 grams of N,N′-methylenebisacrylamide is added to the scintillation vial and extensively stirred for 5 minutes or until all the components in the scintillation vial are completely dissolved.
5. The 0.02 grams of ammonium persulfate added to the scintillation vial and extensively stirred for 5 minutes or until all the components in the scintillation vial are completely dissolved.
6. Again, although it is preferred that no colorant be added during the manufacture of the stimulus sensitive gel, if a colorant is used (e.g., 0.025 grams of Red 110 M iron oxide), it should be added at this point to the scintillation vial and the particles are suspended in the solution by a combination of stirring and sonication in a low power ultrasonic bath. The Red 110 M iron oxide pigment particles have a size on the order of micrometers and are at least 1000 times larger than the pore size of the gel, hence once the gel is prepared around the particles, the particles are locked inside the gel and are not able to leach out. As discussed herein and as understood by one of ordinary skill, for all the embodiments disclosed herein, one embodiment may work better with a transparent stimulus sensitive gel, while others will work better with a stimulus sensitive gel that is dyed a given color. One of ordinary skill will also understand that different color dyes can be used to make the stimulus sensitive gel color different from, or the same as, the indicator spot.
7. The mixture is then cooled down to 0° C. by placing it in a iced water bath for 5 minutes.
8. The mixture is taken out from the iced water bath and the entire 24 microliters of TEMED are added. TEMED catalyzes the polymerization reaction such that the reaction may occur at low temperatures (near 0° C.) although one of ordinary skill in the art will recognize that TEMED may be substituted with another redox polymerization catalyst such as Sodium Metabisulfite. Performing the above mentioned steps results in a pre-gel mixture that will form PNIPAAm-BIS gels.

The procedure to cast the gels is independent of the recipe employed. The pre-gel mixture is rapidly (within 10 minutes of addition of TEMED) transferred from the scintillation vial into molds so as to allow gels of desired shapes to form. The pre-gel mixture is preferably cast into glass molds since the gel does not stick on glass surfaces and hence can be removed from the molds easily. Some of the types of molds employed are described below although one of ordinary skill in the art will recognize that the gels can be cast in variety of shapes and sizes. Glass pipettes can be used which preferably have an inner diameter of either about 7 mm or about ⅓ inch. Similarly, rectangular or round glass capillaries (e.g., from Fiber Optic Center New Bedford, Mass.) having an inner diameter of 0.4 mm or 1/64 inches could be used as well. In addition, the gel may be cast between glass plates in a protein electrophoresis gel casting unit (Mini PROTEAN® 3 system from Bio-Rad for instance). The space between two glass plates can be 1.0 mm or 1.5 mm.

The molds employed can vary in length and width in addition to thickness, and as will be appreciated by one of ordinary skill in the art, the desired speed with which the transition of the resulting gel occurs is limited by the smallest dimension of the gel. There is an inverse relation between transition speed and the smallest dimension of the gel: larger gels take longer to transition after exposure to the predetermined stimulus trigger. Next the ends of the glass molds are sealed, either by flame sealing or by putting epoxy at the ends. The reason for sealing the pre-gel mixture in the glass molds is to prevent the pre-gel mixture from coming in contact with air during the polymerization process. It is important to prevent the pre-gel mixture from coming into contact with oxygen in the air during the polymerization process, because oxygen retards and may even stop the polymerization reaction. This is the same reason that the distilled and deionized water is purged with nitrogen at the beginning of the manufacture of the gel. After the adding TEMED and casting the gel into the desired mold, the polymerization is allowed to proceed for roughly one hour.

The gels are then taken out from the glass molds by breaking the glass molds or by removing the glass plates if using a protein electrophoresis gel casting unit. The gels removed from the glass plates are cut into pieces (10 mm×10 mm or 20 mm×20 mm). Then the gels or gel films are washed extensively in water. The polymerized gels are washed in distilled and deionized water for seven days, with the water changed at least every other day. Immersing the polymerized gels in deionized water is a necessary step so as to remove unreacted components. During the gel forming process, there is always the possibility that some NIPAAm and BIS, in the case of PNIPAAm-BIS gels, do not incorporate into the polymer chains that form the gel. During polymerization, some polymer chains are formed that are not connected to the gel network and as such can be washed from the gel. TEMED also needs to be removed from the gel. The removal of TEMED, unbound polymer chains and unreacted monomers is achieved, as mentioned above, by simply immersing the gel in distilled and deionized water. Doing so completes the method for manufacturing a PNIPAAm-BIS gels with or without a colorant.

### 2. Shifting the Transition Temperature of the Gel to the Required Temperature

The stimulus required for all three types of gels prepared as described above to undergo a volume transition is 37° Centigrade since the main constituent NIPAAm is the same for all three types of gels. However, as will be described below the stimulus may easily be shifted to any prescribed temperature below 37° Centigrade but first we describe the underlying physical interactions that govern the volume phase transition in gels in order to understand how such shifts in required stimulus may be achieved. Various forces have been recognized as responsible for the swelling of polymer gels: polymer-solvent interactions, polymer chain elasticity and monomer counterion pressure. Whether a gel is shrunken or collapsed depends on the competition amongst the three interactions. PNIPAAm gels swell to a large extent in water since water is a good solvent for PNIPAAm. In water, NIPAAm polymer chains become greatly extended such that the contact between polymer chain and water is maximized and the result is a swollen gel. In order to induce PNIPAAm gels to undergo a volume transition, the gel solvent needs to be made a poor solvent such that NIPAAm polymer chains contract to avoid contact with the surrounding solvent and lead the gel to shrink.

A further concept inherent in these polymer gels is the directionality of the temperature-induced volume changes. Some polymer gels (e.g., NIPAAm) shrink when heated above a trigger temperature. These polymer gels are said to show a “Lower Critical Solution Temperature” or LCST. LCST behavior depends on the chemical structure. Many examples of LCST polymer gels are known in the literature.

In polymer physics, LCST polymer-solvent systems are those in which the solubility of the polymer is enhanced at low temperatures and diminished at high temperatures. PNIPAAm gels are LCST gels, which means that below their transition temperature they are swollen but above it they are in the collapsed state. Interestingly, the transition temperature of PNIPAAm can be changed significantly by immersing the gel in solutions of salt and water. The salt used in these solutions is Sodium Chloride although one of ordinary skill in the art will recognize that Sodium Chloride may be substituted with other Sodium salts. Temperature and salt concentration play a similar role in dictating whether the gel is swollen or not: increasing temperature and or increasing salt concentration decreases the affinity of the PNIPAAm gels for their solvent. Thus keeping salt concentration fixed, below a specific temperature the gel will be swollen and keeping temperature fixed, above a specific salt concentration the surrounding solvent becomes such a poor solvent for the gel that the gel collapses. This relationship between salt concentration and transition temperature is what allows us to control the transition temperature.

One of the embodiments of this invention is a swollen stimulus sensitive gel that goes through its phase transition at a predetermined level of stimulus. For example, as discussed above, malaria vaccine spoils after exposure to a temperature greater than 8° C. Therefore, in the preferred embodiment of the invention, the PNIPAAm gel is manufactured so as the phase transition of the gel, and therefore the expulsion of the salt solution occurs at 8° C. But the solution salt concentration that causes a stimulus sensitive gel to trigger or go through its phase transition at a predetermined level of stimulus, can be determined for any level of stimulus.

As is known in the art, the transition temperature of PNIPAAm can be changed significantly by immersing the gel in solutions of salt and water. See for example Tae Gwan Park et al “Sodium Chloride-induced phase transition in nonionic Poly(n-isopropylacrylamide) gels”, Macromolecules 1993 or Yanhie Zhang et al “Specific Ion Effects on the Water Solubility of Macromolecules: PNIPAAm and the Hofineister Series” Journal of the American Chemical Society 2005. The salt used in these solutions can be, by way of example only, sodium chloride although one of ordinary skill in the art will recognize that sodium chloride may be substituted with other sodium salts.

Temperature and salt concentration play a similar role in dictating whether the gel is swollen or not: increasing temperature and/or increasing salt concentration decreases the affinity of the PNIPAAm gels for their solvent. Thus, by keeping the salt concentration of the PNIPAAm gel fixed during manufacture, so long as the stimulus sensitive gel is not exposed to a predetermined stimulus, for example the stimulus sensitive gel is kept below a certain temperature, the stimulus sensitive gel will remain swollen. But when the stimulus sensitive gel is exposed to a stimulus that equals or exceeds its predetermined stimulus, for example a higher temperature, the swollen stimulus sensitive gel will undergo its phase transition and collapse or shrink. Alternatively, by keeping the temperature of the stimulus sensitive gel fixed during its manufacture, so long as the stimulus sensitive gel is not exposed to a predetermined stimulus, for example the swollen stimulus sensitive gel is kept at a constant salt concentration, the swollen stimulus sensitive gel will remain swollen. When the concentration surrounding the swollen stimulus sensitive gel changes to such a degree that it equals the predetermined stimulus for that swollen stimulus sensitive gel, for example, the concentration of the solution surrounding the swollen stimulus sensitive gel rises to a predetermined level, at that point the solution surrounding the swollen stimulus sensitive gel becomes such a poor solvent for the swollen stimulus sensitive gel that the swollen stimulus sensitive gel collapses or shrinks. This relationship between certain types of stimuli, such as salt concentration and transition temperature, is what allows for the control of the phase transition of the stimulus sensitive gel at its predetermined stimulus, by way of example only, its transition temperature.

To determine the salt concentration that is needed to cause a stimulus sensitive gel to trigger, one needs to first start with gross variations of salt concentration then determine the level of stimulus that caused the stimulus sensitive gel to trigger or go through its phase transition. Then by narrowing that variation of salt concentration and again noting the level of stimulus that caused the trigger or phase transition, the stimulus sensitive gel with the proper or desired trigger or phase transition characteristics will become evident.

For example, to determine the solution salt concentration required for a stimulus sensitive gel to trigger at 8° centigrade, similarly sized pieces of washed gels are immersed in Sodium Chloride solutions prepared with concentrations ranging from 0 Molar to 4 Molar in 0.5 Molar increments. By using similarly sized pieces of washed gels, the determination is much more reliable. Next all the similarly sized gels immersed in salt solutions prepared with concentrations ranging from 0 Molar to 4 Molar, are placed in a constant temperature environment such as a constant temperature water bath at 8° centigrade. After some time it will be observed that between 2.5 Molar and 4 Molar, variations triggered and went through a phase transition, but between 0 Molar and 2 Molar the stimulus sensitive gels did not. Accordingly, it is known that the desired salt concentration lies somewhere between 2 and 2.5 Molar Sodium Chloride.

Accordingly, the next round of similarly sized pieces of washed gels are immersed in Sodium Chloride solutions prepared in the range of concentration between 2 Molar and 2.5 Molar in 0.1 Molar increments. Upon being exposed to the predetermined stimulus, for example, a temperature of 8° centigrade, it is observed that the 2.1 through 2.5 Molar variations triggered and went through a phase transition, but the 2 Molar did not. Accordingly, it is known that the desired salt concentration lies somewhere between 2 Molar and 2.1 Molar.

Finally, the next round of similarly sized pieces of washed gels are immersed in Sodium Chloride solutions prepared in the range of concentration between 2 Molar and 2.1 Molar in 0.02 Molar increments. Upon being exposed to the predetermined stimulus, for example, a temperature of 8° centigrade, it is observed that the 2.04 through 2.1 Molar variations triggered and went through a phase transition, but the 2 through 2.02 Molar stimulus sensitive gels did not. Thus, it is known that the desired salt concentration for a stimulus sensitive gel that triggers or goes through its phase transition at 8° centigrade lies between 2.02 and 2.04 Molar.

### Method for Manufacturing; Doping and Setting the Trigger Temperature of a Cold-Side Temperature Gel

For all the embodiments of the stimulus sensitive gel discussed herein, the stimulus sensitive gel can be manufactured to undergo its phase transition at any predetermined stimulus. By way of example only, the stimulus sensitive gel discussed herein could be of the UCST type and could be made to trigger or undergo its phase transition (i.e., collapse or shrink and expel liquid and/or constituent parts) upon exposure to a temperature of less than 2° C. Alternatively, and by way of example only, the stimulus sensitive gel discussed herein could be of the LCST type and could be made to trigger or undergo its phase transition (i.e., collapse or shrink and expel liquid and/or constituent parts) upon exposure to a temperature greater than 8° C. It will be understood by one of ordinary skill in the art that other temperatures and/or stimuli can be set as the predetermined stimulus by varying the method and/or ingredients disclosed herein.

By way of example only, the discussion below will disclose how to make a swollen stimulus sensitive gel of the UCST type, which undergoes its phase transition (i.e., collapses or shrinks and thereby expels the liquid and/or constituent parts contained in the stimulus sensitive gel) upon being exposed to a temperature cooler than 2° C.

The method of manufacturing such a swollen stimulus sensitive gel comprises at least two steps, and depending on the embodiment being employed there are variations in the second step that are dependent upon the particular embodiment.

In the first step, acrylamide and sodium vinyl acrylate are polymerized at room temperature to form a poly(acrylamide-co-sodium vinyl acrylate) gel (abbreviated PAAm-co-SVA gel, the co means that both Acrylamide and Sodium VinylAcrylate are polymerized together.) (The gel remains swollen in water at a temperature of 0° C. so we can say the trigger temperature of the PAAm-co-SVA gel in water occurs at a temperature below 0° C.).

In the second step, the transition temperature of the PAAm-co-SVA gel is adjusted to the desired transition temperature via the addition of salts or solvents. Once the amounts of additives required to obtain gel formulations that trigger at the desired transition temperature are well established, the steps described herein for determining those amounts need not be repeated for the manufacture of future gels.

Depending on the embodiment employed, there could be a variation in the second step wherein the PAAm-co-SVA gels are dried and immersed in solutions containing salts or solvents required for the desired transition temperature.

The resulting polymer gel (i.e., the swollen stimulus sensitive gel) will initially have had a transition temperature below 0° C., but by the completion of the second step in any of its variations, the transition temperature of the resulting polymer gel (i.e, the doped swollen stimulus sensitive gel) is shifted to the desired temperature (e.g., 2° C.).

The first two steps taken together including any variations of the second step comprise the process of preparing a swollen stimulus sensitive gel that will undergo its phase transition upon being exposed to a predetermined stimulus as well as provide foolproof, permanent and irreversible indication of the stimulus sensitive product's exposure to such stimulus.

### 1. Preparation of PAAm-co-SVA Polymer Gels by Polymerization of Acrylamide (AAm) and Sodium Vinyl Acrylate (SVA)

By way of example only, the swollen stimulus sensitive gel is prepared as a UCST type of polymer gel, and by way of example only, this UCST type of polymer gel is created via the polymerization of acrylamide and sodium vinyl acrylate, so as to form a Poly(acrylamide-co-sodium vinyl acrylate) gel (abbreviated PAAm-co-SVA) This polymerization of acrylamide and sodium vinyl acrylate is accomplished by employing the following ingredients, although one of ordinary skill in the art will recognize that certain of the following ingredients can be replaced by other similar types of ingredients, and recognizes/understands that the amounts of the ingredients are exemplary only. Accordingly, the amounts of the ingredients can be varied by any amount so long as the desired gel is created. Moreover, the amounts can be increased or decreased proportionally so that larger or smaller amounts of swollen stimulus sensitive gel can be created. The ingredients include:
i) 0.4622 grams of vinylacetic acid (preferably 98% purity from Aldrich)
ii) 0.2148 grams of sodium hydroxide (preferably 99.8% purity from Fisher) or alternatively 0.5691 grams of sodium carbonate (preferably 99.8% from Aldrich)
iii) 20 milliliters of distilled and deionized water;
iv) 1.0 grams of acrylamide (preferably electrophoresis grade from Aldrich)
v) between 0.0267 and 0.267 grams of N,N′-methylenebisacrylamide (preferably electrophoresis grade from Aldrich) and
vi) 0.04 grams of ammonium persulfate (preferably 98% purity from Aldrich).

It should be noted that as described herein, it is preferred that the stimulus sensitive gel be free from any coloring or colorant, because once the transparent swollen stimulus sensitive gel collapses, it becomes very opaque, and can block the view of the indicator spot just by itself. Accordingly, there is not a need for a colorant. However, if a colorant is desired for the stimulus sensitive gel, the manufacture of the gel can include 0.05 grams of Red 110 M (from LanXess Corporation). This amount in proportion to the other ingredients included in the manufacture of the gel, will be of such a concentration that it allow the swollen stimulus sensitive gel to have a transparent appearance, but when the swollen stimulus sensitive gel expels its fluid and shrinks, the red colorant will concentrate over the indicator spot, thereby providing an indication of exposure to a predetermined stimulus.

In order to manufacture such gel, the following method is preferably followed, although one of ordinary skill in the art will recognize that certain steps can be performed in varying order, and the amounts can be varies as described herein or as known to one of ordinary skill in the art:

i) place the 20 milliliters of distilled and deionized water into a scintillation vial and purge that distilled and deionized water with nitrogen gas for 15 to 20 minutes so as to remove all possible amounts of oxygen;

ii) add the 0.4622 grams of vinylacetic acid into the scintillation vial, and stir extensively for 5 minutes or until all of the vinylacetic acid is completely dissolved;

iii) add the 0.2148 grams of sodium hydroxide or 0.5691 grams of sodium carbonate to the scintillation vial and stir extensively until the salt is completely dissolved. The purpose of adding the sodium hydroxide or sodium carbonate to the mixture in the scintillation vial is so that it can react with the vinylacetic acid to form the salt sodium vinyl acrylate. Because the sodium vinyl acrylate salt is an ionic water soluble monomer, when it is copolymerized with the acrylamide, the resultant hydrogel will exhibit a large degree of expansion and/or swelling in size and/or volume;

iv) add the 1.0 grams of acrylamide to the scintillation vial and stir extensively for 5 minutes or until all the components in the scintillation vial are completely dissolved;

v) add between 0.0267 and 0.267 grams of N,N′-methylenebisacrylamide to the scintillation vial and stir extensively for 5 minutes or until all the components in the scintillation vial are completely dissolved. Here we may use varying amounts of crosslinker—N,N′-methylenebisacrylamide since the crosslinking density affects the mechanical properties of the gel as well as the resolution of the phase transition. For example, holding all other parameters constant, a gel with a low cross-link density, which is equivalent to incorporating low amounts of N,N′-methylenebisacrylamide in the gel, will exhibit good resolution around the trigger temperature. What is meant by good resolution around the transition temperature is that the gel will only transition when the harmful stimulus is in very close proximity to the trigger temperature of the gel. However, gels prepared with a low cross-link density have poor mechanical integrity, which makes it difficult to process or handle them. On the other hand, the cross-link density may be high corresponding to large amounts of N,N′-methylenebisacrylamide incorporated in the gel. Whereas the mechanical integrity of these gels is improved, the resolution of the gel response around the transition temperature is poor compared to the case with low cross-link density. Hence, it is desirable to optimize the N,N′-methylenebisacrylamide concentration to obtain good resolution and ease of handling the gel material for the preparation of all embodiments; and
vi) add the 0.04 grams of ammonium persulfate to the scintillation vial and stir extensively for 5 minutes or until all the components in the scintillation vial are completely dissolved.

Again, although it is preferred that no colorant be added during the manufacture of the stimulus sensitive gel, if a colorant is used (e.g., 0.05 grams of Red 110 M), it should be added at this point to the scintillation vial and stir extensively for 5 minutes or until all the components in the scintillation vial are completely dissolved. The addition of Red 110 M to the gel allows the shrunken stimulus sensitive gel to be better observed in its shrunken state. As discussed herein and as understood by one of ordinary skill, for all the embodiments disclosed herein, one embodiment may work better with a transparent stimulus sensitive gel, while others will work better with a stimulus sensitive gel that is dyed a given color. One of ordinary skill will also understand that different color dyes can be used to make the stimulus sensitive gel color different from, or the same as, the indicator spot.

The pre-gel mixture of AAm and SVA is rapidly transferred from the scintillation vial into molds to allow the polymerization process to occur and/or so as to allow gels to form into the desired shape. The pre-gel mixture is preferably cast between glass plates since the pre-gel does not stick on glass surfaces and hence can be removed from the plates easily. Some of the types of molds employed are described below although one of ordinary skill in the art will recognize that the gels can be case in any shape and size. Glass pipettes can be used which preferably have an inner diameter about 7 mm (7 mm does not work out to be ¼ of an inch; it is actually a little bit less than a ⅓). Similarly, rectangular or round glass capillaries (from Fiber Optic Center, MA for instance) having an inner diameter of 0.4 mm or 1/64 inches could be used as well. In addition, the gel may be cast between glass plates in a protein electrophoresis gel casting unit (Mimi PROTEAN® 3 system from Bio-Rad for instance). The space between two glass plates can be 1.0 mm or 1.5 min.

As will be appreciated by one of ordinary skill in the art, the molds employed to form the stimulus sensitive gels can vary in length, height and/or width, and as will be appreciated by one of ordinary skill in the art, the desired speed with which the transition of the resulting gel occurs is limited by the smallest dimension of that stimulus sensitive gel. Because there is an inverse relation between the transition speed and the smallest dimension of the gel, between two stimulus sensitive gels that have the same dimensions (e.g., length, height or width) except for one of the dimensions, the gel with the all the dimensions being smallest will undergo its phase transition faster than the other one. For example, a stimulus sensitive gel that is 1 cm long, 1.0 mm high, and 0.5 cm wide will take four times as long to completely undergo its phase transition after exposure to its predetermined stimulus. According to the theory of gel swelling (Tanaka and Fillmore “Kinetics of Swelling of Gels,” in Journal of Chemical Physics, volume 70 at 1214 to 1218), the time depends on the inverse of the length squared. So if between two gels, one of the gels has a dimension which is half of the other one, then it will be four times faster than a stimulus sensitive gel that is 1 cm long, 0.5 mm high, and 0.5 cm wide.

Next the ends of the glass molds are sealed, either by flame sealing or by putting epoxy at the ends. The reason for sealing the pre-gel mixture in the glass molds is to prevent the pre-gel mixture from coming in contact with air during the polymerization process. It is important to prevent the pre-gel mixture from coming into contact with oxygen in the air during the polymerization process, because oxygen retards and may even stop the polymerization reaction. This is the same reason that the distilled and deionized water is purged with nitrogen at the beginning of the manufacture of the gel.

The final step in transforming the pre-gel mixture into a robust stimulus sensitive gel mixture is to immerse the sealed glass molds containing the pre-gel mixture in a water bath at a temperature of 50° C. for at least one hour, but preferably the pre-gel mixture is immersed in the 50° C. water bath for two hours. After this period of two hours, polymerization is complete, and the stimulus sensitive gel can be removed from the glass molds.

An alternative to this final step of transforming the pre-gel mixture into a robust stimulus sensitive gel mixture is to add 50 microliters of N,N,N′N′-tetramethylethylenediamine (abbrieviated TEMED, preferably 98% purity from Aldrich) into the pre-gel mixture and stirring the mixture for 5 minutes or until it completely dissolves in the pre-gel mixture. TEMED catalyzes the polymerization reaction such that the reaction may occur at room temperature or even at lower temperatures although one of ordinary skill in the art will recognize that TEMED may be substituted with another redox polymerization catalyst such as sodium metabisulfite. After the addition of TEMED, the polymerization is allowed to proceed for approximately one hour. One of ordinary skill in the art will recognize, in addition to the two polymerization methods discussed above, the polymerization of the pre-gel mixture can be accomplished in many different ways.

Once polymerization is complete, the polymerized gels are taken out from the glass molds by breaking the glass molds or by removing the glass plates if using a protein electrophoresis gel casting unit. Immersing the polymerized gels in deionized water is a necessary step so as to remove unreacted components because during the process of forming the stimulus sensitive gel, there is always the possibility that some acrylamide, sodium vinylacrylate and N,N′-methylenebisacrylamide are not incorporated into the polymer chains that form the stimulus sensitive gel. During the polymerization of the stimulus sensitive gel, there is always the possibility that some polymer chains are formed but which do not incorporate into the polymer chains that form the gel, and as such can be washed from the gel.

In the case that the gel is formed at room temperature via the addition of a catalyst, that catalyst also needs to be removed from the gel. The removal of TEMED and unreacted monomers is achieved, as mentioned above, by simply immersing the gel in distilled and deionized water. The polymerized gels are washed extensively by immersing the gels in distilled and deionized water for at least two days, with the water changed at least once a day. Immersing the polymerized gels in deionized water is a necessary step so as to remove the components not being incorporated into the gel.

Moreover, if the polymerization process used TEMED, that TEMED also needs to be removed from the polymerized gel. The removal of TEMED, unbound polymer chains and unreacted monomers is achieved, as mentioned above, by simply immersing the polymerized gel is distilled and deionized water. Doing so completes the method for manufacturing PAAm-co-SVA gels, although any gel that exhibits UCST qualities would work for these embodiments.

After the polymerization of the stimulus sensitive gel is complete, the stimulus sensitive gel is denoted or referred to as PAAm-co-SVA gels.

### 2. Shifting the Transition Point of the Gel to the Predetermined Stimulus

Because of the ingredients and method used to prepare the PAAm-co-SVA swollen stimulus sensitive gel discussed above in Step 1, the polymerized gel will undergo its phase transition at a predetermined stimulus of less than 0° C. That predetermined stimulus can be altered, however, so as to cause the swollen stimulus sensitive gel to collapse or shrink upon cooling to any temperature. This altering of the predetermined stimulus can be accomplished because of the underlying physical interactions that govern the volume phase transition in stimulus sensitive gels. Various forces have been recognized as responsible for the swelling of polymer gels: polymer-solvent interactions, polymer chain elasticity and monomer counterion pressure. Whether a gel is shrunken or collapsed depends on the competition amongst the three interactions. PAAm-co-SVA gels swell to a large extent in water due to the presence of the ionic monomer SVA, whose sodium counterions contribute to the ionic pressure, and the favorable interaction between the polymer chains and water. To induce these gels to undergo a volume transition, the interaction between polymer chains must be more favorable than the interaction between the surrounding solvent and polymer chains. In a swollen gel, the interaction between the polymer chains forming the gel and the surrounding water is more favorable than the interaction between the polymer chains themselves such that the polymer chains extend as much as possible to maximize contact with water. However, when the solvent surrounding the gels is a poor solvent, such that the polymer chains forming the gels prefer to interact amongst them rather than with the poor solvent, then the polymer chains will contract in order to minimize their exposure to the poor solvent leading the gel to collapse. Compared to pure water, an acetone solution in water is a poor solvent for the PAAm-co-SVA gel and so these gels can be made to collapse in an acetone solution in water. However, as may be recognized by someone who is ordinary skilled in the art, solutions of other non-polar solvents in water can also cause unfavorable interactions with the polymer chains such that the gels can be made to collapse.

In water, PAAm-co-SVA chains become greatly extended such that the contact between polymer chains and water is maximized, thereby resulting in a swollen gel. In order to induce PAAm-co-SVA gels to undergo a volume transition, the interaction between the polymer chains and the surrounding solvent needs to be made unfavorable such that the PAAm-co-SVA chains contract to avoid contact with the surrounding solvent and lead the gel to shrink. This can also be accomplished by cooling the gel below its transition temperature since the interaction between the solvent and the polymer chains can be made unfavorable and hence lead to collapse of the gel by lowering the temperature.

A further concept inherent in these polymer gels is the directionality of the temperature-induced volume changes. As discussed herein, certain polymer gels (e.g., Poly(N-isopropylacrylamide) abbreviated PNIPAAm) shrink when heated above a trigger temperature. These polymer gels are said to show a “Lower Critical Solution Temperature” or LCST. LCST behavior depends on the chemical structure. Many examples of LCST polymer gels are known in the literature. In polymer physics, LCST polymer-solvent systems are those in which the solubility of the polymer is enhanced at low temperatures and diminished at high temperatures. Because PNIPAAm gels are LCST gels, when the PNIPAAm gel is below its predetermined stimulus (i.e., its transition temperature), it is swollen; but above its predetermined stimulus the PNIPAAm gel is in the collapsed state.

As also discussed herein, there are certain polymer gels (e.g., PAAm-co-SVA) that shrink when cooled below a trigger temperature. These polymer gels are said to show an “Upper Critical Solution Temperature” or UCST. UCST behavior depends on the chemical structure. Many examples of UCST polymer gels are known in the literature. In polymer physics, UCST polymer-solvent systems are those in which the solubility of the polymer is enhanced at high temperatures and diminished at low temperatures. Because PAAm-co-SVA gels are UCST gels, when the PAAm-co-SVA gel is below its predetermined stimulus (i.e., its transition temperature), it is shrunken; but above its predetermined stimulus the PAAm-co-SVA gel is in the swollen state.

As is known in the art, the transition temperature of both PNIPAAm and PAAm-co-SVA gels can be changed significantly by immersing the gel in solutions of water with other components (such as salt or solvents). In regard to the PNIPAAm gels, see for example Tae Gwan Park et al. “Sodium Chloride-induced phase transition in nonionic Poly(n-isopropylacrylamide) gels” Macromolecules 1993 or Yanhie Zhang et al. “Specific Ion Efects on the Waer Solubility of Macromolecules: PNIPAAm and the Hofineister Series” Journal of the American Chemical Society 2005. The salt used in these solutions can be, by way of example only, sodium chloride although one of ordinary skill in the art will recognize that sodium chloride may be substituted with other sodium salts. Similarly, in regard to PAAm-co-SVA gels see Seiji Katayama “Chemical Condition Responsible for Thermoswelling or Thermoshrinking Type of Volume Phase Transition in Gels. Effect of Relative Amounts of Hydrophobic to Hydrophilic Groups in the Side Chain” Journal of Physical Chemistry 1992.

Temperature and solvent concentration play a similar role in dictating whether the gel is swollen or not. For example the stimulus sensitive gel is kept above a certain temperature, the stimulus sensitive gel will remain swollen. But when the stimulus sensitive gel is exposed to a stimulus that equals or exceeds its predetermined stimulus, for example a lower temperature, the swollen stimulus sensitive gel will undergo its phase transition and collapse or shrink. Alternatively, by keeping the temperature of the stimulus sensitive gel fixed during its manufacture, so long as the stimulus sensitive gel is not exposed to a predetermined stimulus, for example the swollen stimulus sensitive gel is kept at a constant solvent concentration, the swollen stimulus sensitive gel will remain swollen. When the concentration surrounding the swollen stimulus sensitive gel changes to such a degree that it equals the predetermined stimulus for that swollen stimulus sensitive gel, for example, the concentration of the solution surrounding the swollen stimulus sensitive gel rises to a predetermined level, at that point the solution surrounding swollen stimulus sensitive gel becomes such a poor solvent for the swollen stimulus sensitive gel that the swollen stimulus sensitive gel collapses or shrinks. This relationship between certain types of stimuli, such as solvent concentration and transition temperature, is what allows for the control of the phase transition of the stimulus sensitive gel at its predetermined stimulus, by way of example only, its transition temperature.

One of the embodiments of this invention is a swollen stimulus sensitive gel that goes through its phase transition at a predetermined level of stimulus. By way of example only, malaria vaccine spoils after exposure to a temperature lower than 2° C. Therefore, a swollen stimulus sensitive gel used in conjunction with any embodiment of the stimulus indicating device described herein, can be set to trigger at 2° C. or cooler. By way of example only, a PAAm-co-SVA gel as the swollen stimulus sensitive gel can be manufactured so that as the phase transition of the swollen stimulus sensitive gel, and therefore the expulsion of the expelled liquid and the constituent parts in the form of a salt solution, occurs at approximately 2° C. As one of ordinary skill in the art can appreciate, the solvent concentration that causes a swollen stimulus sensitive gel to trigger or undergo its phase transition at a predetermined level of stimulus, can be determined for any stimulus, and more particularly at any level of stimulus.

To determine the solvent concentration that is needed to cause a given swollen stimulus sensitive gel to trigger or undergo its phase transition at a predetermined stimulus such as temperature, one needs to first start with gross variations of solvent concentration then determine from those gross variations the level of stimulus that causes the swollen stimulus sensitive gel to trigger or go through its phase transition. Then by narrowing that variation of solvent concentration and again noting the level of stimulus that caused the swollen stimulus sensitive gel to trigger or undergo its phase transition, the swollen stimulus sensitive gel with the proper or desired trigger of phase transition characteristics will become evident. Once the solvent concentration required to obtain gels that trigger at the desired transition temperature are well established, this procedure needs not be repeated for all manufactured gels.

By way of illustration only, to determine the proper acetone concentration for a stimulus sensitive gel to trigger at 2° centigrade, similarly sized pieces of washed stimulus sensitive gel films are immersed and saturated in acetone-water mixtures prepared whereby the concentrations of the acetone-water mixture vary by 10%, resulting in acetone-water mixtures having the following acetone concentrations: 80%, 70%, 60%, 50% and 40%. By using similarly sized pieces of washed gels, the determination is much more reliable. The saturation of the gels with acetone-water mixtures is done by immersing washed gel films in the corresponding acetone-water mixtures and replacing the acetone-water mixtures once daily for two days at room temperature.

The swollen gels immersed in the acetone-water mixtures are then placed in a constant temperature environment (such as a constant temperature water cooling bath) at 2° centigrade. After some time it will be observed that gel films saturated at 60% acetone concentration or above go through a phase transition, but the swollen stimulus sensitive gel films saturated at 50% acetone concentration or below failed to trigger and undergo their phase transition, and thus did not collapse or shrink. Accordingly, it is known that the desired acetone concentration for the swollen stimulus sensitive gel that will trigger and undergo its phase transition between 2° C. and room temperature lies below 60% concentration of acetone, but above 50% acetone concentration.

Thus, the next round of similarly sized pieces of washed swollen stimulus sensitive gel are immersed in the acetone-water mixtures having concentrations that vary by 2% between the known range of 50% and 60% acetone-water concentration, and are thereby saturated at 52%, 54%, 56%, and 58% acetone-water concentration. Next, upon being exposed to the predetermined stimulus, for example, a temperature of 2° C., after some time it will be observed that all of the swollen stimulus sensitive gels that were previously immersed in the acetone-water mixtures containing concentrations 52%, 54%, 56% and 58% acetone-water remained swollen and failed to trigger and undergo their phase transition, and thus did not collapse or shrink. Accordingly, it is known that the desired acetone-water concentration for a swollen stimulus sensitive gel that will trigger and undergo its phase transition at 2° C. lies between 58% and 60% acetone-water concentration.

Thus, the next round of similarly sized pieces of washed swollen stimulus sensitive gels are immersed in the acetone-water mixtures having concentrations that vary by 0.5% between the known range of 58.0% and 60.0% acetone-water concentration, and are thereby saturated at 58.5%, 59.0%, and 59.5% acetone-water concentration. Next, upon being exposed to the predetermined stimulus, for example, a temperature of 2° C., it is observed that the stimulus sensitive gels that were previously immersed in the acetone-water mixtures containing 58.5%, 59.0%, and 59.5% acetone-water concentration remained swollen and failed to trigger and undergo their phase transition, and thus did not collapse or shrink. Accordingly, it is known that the desired acetone-water concentration for a swollen stimulus sensitive gel that will trigger and undergo its phase transition at 2° C. lies between 59.5% and 60% acetone-water concentration.

At this point, it may not be necessary to determine with any more specificity the concentration of the acetone-water mixture necessary to cause the swollen stimulus sensitive gel to undergo its phase transition at 2° C., although following this method would allow such additional specificity.

### Alternate Embodiment of the Gel

### Method for Manufacturing a Stimulus Sensitive Gel

For all the embodiments of the stimulus sensitive gel discussed herein, the stimulus sensitive gel can be manufactured to undergo its phase transition at any predetermined stimulus. By way of example only, the stimulus sensitive gel discussed herein could be of the UCST type and could be made to trigger or undergo its phase transition (i.e., collapse or shrink and expel liquid and/or constituent parts) upon exposure to a predetermined temperature that decreases from a first temperature to a second temperature. Alternatively, and by way of example only, the stimulus sensitive gel discussed herein could be of the LCST type and could be made to trigger or undergo its phase transition (i.e., collapse or shrink and expel liquid and/or constituent parts) upon exposure to a predetermined temperature that rises in temperature from a first temperature to a second temperature. It will be understood by one of ordinary skill in the art that other temperatures and/or stimuli can be set as the predetermined stimulus by varying the method and/or ingredients disclosed herein.

By way of example only, the discussion below will disclose how to make a swollen stimulus sensitive gel of the UCST type, which undergoes its phase transition (i.e., collapses or shrinks and thereby expels the liquid and/or constituent parts contained in the stimulus sensitive gel) upon being exposed to a temperature cooler than 2° C.

The method of manufacturing such a swollen stimulus sensitive gel comprises forming an interpenetrating polymer network from polyacrylamide (PAAm) and polyacrylic acid (PAAc). This gel is referred to as IPN-PAAm-PAAc. During the synthesis of the interpenetrating network gel, a portion of the acrylic acid groups on the PAAc gels are ionized through the addition of sodium hydroxide. By controlling the degree of ionization, the transition temperature of the gel can be adjusted to the desired transition temperature. Once the amount of ionization required to obtain gel formulations that trigger at the desired transition temperature are well established, the steps described herein for determining those amounts need not be repeated for the manufacture of future gels.

The resulting polymer gel (i.e., the swollen stimulus sensitive gel) will initially have had a transition temperature near 200° C., but by the completion of the second step, the transition temperature of the resulting polymer gel (i.e, the doped swollen stimulus sensitive gel) is shifted to the desired temperature (e.g., 2° C.).

Such comprises the process of preparing a swollen stimulus sensitive gel that will undergo its phase transition upon being exposed to a predetermined stimulus as well as provide foolproof, permanent and irreversible indication of the stimulus sensitive product's exposure to such stimulus.

### 1. Preparation of Interpenetrating Polymer Gels by Polymerization of Acrylamide and Acrylic Acid

By way of example only, the swollen stimulus sensitive gel is prepared as a UCST type of polymer gel, and by way of example only, this UCST type of polymer gel is created through the formation of an interpenetrating polymer network of polyacrylamide (PAAm) and polyacrylic acid (PAAc) so as to form an IPN-PAAm-PAAc. This polymerization of acrylamide and acrylic acid is accomplished in several steps: first, the PAAm gel is formed. After that, the PAAm gel is washed extensively in water. Then the PAAm gel is dried completely and later swollen in an acrylic acid solution. The acrylic acid is then polymerized and the IPN-PAAm-PAA is formed. The polymerization is done by employing the following ingredients, although one of ordinary skill in the art will recognize that certain of the following ingredients can be replaced by other similar types of ingredients, and recognizes/understands that the amounts of the ingredients are exemplary only. Accordingly, the amounts of the ingredients can be varied by any amount so long as the desired gel is created. Moreover, the amounts can be increased or decreased proportionally so that larger or smaller amounts of swollen stimulus sensitive gel can be created. The ingredients include:

i) 1.0 grams of acrylic acid (preferably 98% purity from Aldrich)

ii) 1.0 grams of acrylamide (preferably electrophoresis grade from Aldrich;

iii) 40 milliliters of distilled and deionized water;

iv) 0.0433 grams of N,N′-methylenebisacrylamide (preferably electrophoresis grade from Aldrich);

v) 0.008 grams of ammonium persulfate (preferably 98% purity from Aldrich);

vi) Sodium hydroxide.

It should be noted that as described herein, it is preferred that the stimulus sensitive gel be free from any coloring or colorant, because once the transparent swollen stimulus sensitive gel collapses, it becomes very opaque, and can block the view of the indicator spot just by itself. Accordingly, there is not a need for a colorant. However, if a colorant is desired for the stimulus sensitive gel, the manufacture of the gel can include 0.05 grams of Red 110 M (from LanXess Corporation). This amount in proportion to the other ingredients included in the manufacture of the gel, will be of such a concentration that it allow the swollen stimulus sensitive gel to have a transparent appearance, but when the swollen stimulus sensitive gel expels its fluid and shrinks, the red colorant will concentrate over the indicator spot, thereby providing an indication of exposure to a predetermined stimulus.

In order to manufacture such gel, the following method is preferably followed, although one of ordinary skill in the art will recognize that certain steps can be performed in varying order, and the amounts can be varied as described herein or as known to one of ordinary skill in the art:

i) place 20 milliliters of distilled and deionized water into a scintillation vial and purge that distilled and deionized water with nitrogen gas for 15 to 20 minutes so as to remove all possible amounts of oxygen;

ii) add the 1.0 grams of acrylamide into the scintillation vial, and stir extensively for 5 minutes or until all of the acrylamide is completely dissolved;

iii) add the 0.0267 grams of N,N′-methylenebisacrylamide to the scintillation vial and stir extensively for 5 minutes or until all the components in the scintillation vial are completely dissolved and

iv) add the 0.004 grams of ammonium persulfate to the scintillation vial and stir extensively for 5 minutes or until all the components in the scintillation vial are completely dissolved.

Again, although it is preferred that no colorant be added during the manufacture of the stimulus sensitive gel, if a colorant is used (e.g., 0.05 grams of Red 110 M), it should be added at this point to the scintillation vial and stir extensively for 5 minutes or until all the components in the scintillation vial are completely dissolved. The addition of Red 110 M to the gel allows the shrunken stimulus sensitive gel to be better observed in its shrunken state. As discussed herein and as understood by one of ordinary skill, for all the embodiments disclosed herein, one embodiment may work better with a transparent stimulus sensitive gel, while others will work better with a stimulus sensitive gel that is dyed a given color. One of ordinary skill will also understand that different color dyes can be used to make the stimulus sensitive gel color different from, or the same as, the indicator spot.

The pre-gel mixture of AAm is rapidly transferred from the scintillation vial into molds to allow the polymerization process to occur and/or so as to allow gels to form into the desired shape. The pre-gel mixture is preferably cast between glass plates since the pre-gel does not stick on glass surfaces and hence can be removed from the plates easily. Some of the types of molds employed are described below although one of ordinary skill in the art will recognize that the gels can be case in any shape and size. Glass pipettes can be used which preferably have an inner diameter about 7 mm (7 mm does not work out to be ¼ of an inch; it is actually a little bit less than a ⅓). Similarly, rectangular or round glass capillaries (from Fiber Optic Center, MA for instance) having an inner diameter of 0.4 mm or 1/64 inches could be used as well. In addition, the gel may be cast between glass plates in a protein electrophoresis gel casting unit (Mimi PROTEAN® 3 system from Bio-Rad for instance). The space between two glass plates can be 1.0 mm or 1.5 mm.

As will be appreciated by one of ordinary skill in the art, the molds employed to form the stimulus sensitive gels can vary in length, height and/or width, and as will be appreciated by one of ordinary skill in the art, the desired speed with which the transition of the resulting gel occurs is limited by the smallest dimension of that stimulus sensitive gel. Because there is an inverse relation between the transition speed and the smallest dimension of the gel, a stimulus sensitive gel that has a larger size on any given dimension (e.g., length, height or width) will undergo its phase transition slower than a stimulus sensitive gel that has a larger size on that same given dimension. For example, a stimulus sensitive gel that is 1 cm long, 1.0 mm high, and 0.5 cm wide will take 4 times as long than a stimulus sensitive gel that is 1 cm long, 0.5 mm high, and 0.5 cm wide.

Next the ends of the glass molds are sealed, either by flame sealing or by putting epoxy at the ends. The reason for sealing the pre-gel mixture in the glass molds is to prevent the pre-gel mixture from coming in contact with air during the polymerization process. It is important to prevent the pre-gel mixture from coming into contact with oxygen in the air during the polymerization process, because oxygen retards and may even stop the polymerization reaction. This is the same reason that the distilled and deionized water is purged with nitrogen at the beginning of the manufacture of the gel.

The final step in transforming the pre-gel mixture into a robust stimulus sensitive gel mixture is to immerse the sealed glass molds containing the pre-gel mixture in a water bath at a temperature of 50° C. for at least one hour, but preferably the pre-gel mixture is immersed in the 50° C. water bath for two hours. After this period of two hours, polymerization is complete, and the stimulus sensitive gel can be removed from the glass molds.

An alternative to this final step of transforming the pre-gel mixture into a robust stimulus sensitive gel mixture is to add 50 microliters of N,N,N′N′-tetramethylethylenediamine (abbrieviated TEMED, preferably 98% purity from Aldrich) into the pre-gel mixture and stirring the mixture for 5 minutes or until it completely dissolves in the pre-gel mixture. TEMED catalyzes the polymerization reaction such that the reaction may occur at room temperature or even at lower temperatures although one of ordinary skill in the art will recognize that TEMED may be substituted with another redox polymerization catalyst such as sodium metabisulfite. After the addition of TEMED, the polymerization is allowed to proceed for approximately one hour. One of ordinary skill in the art will recognize, in addition to the two polymerization methods discussed above, the polymerization of the pre-gel mixture can be accomplished in many different ways.

Once polymerization is complete, the polymerized gels are taken out from the glass molds by breaking the glass molds or by removing the glass plates if using a protein electrophoresis gel casting unit. Immersing the polymerized gels in deionized water is a necessary step so as to remove unreacted components because during the process of forming the stimulus sensitive gel, there is always the possibility that some acrylamide and bisacrylamide do not incorporate into the polymer chains that form the stimulus sensitive gel. During the polymerization of the stimulus sensitive gel, there is always the possibility that some polymer chains are formed but which do not incorporate into the polymer chains that form the gel, and as such can be washed from the gel.

In the case that the gel is formed at room temperature via the addition of a catalyst, that catalyst also needs to be removed from the gel. The removal of TEMED and unreacted monomers is achieved, as mentioned above, by simply immersing the gel in distilled and deionized water. The polymerized gels are washed extensively by immersing the gels in distilled and deionized water for at least two days seven days, with the water changed at least every day. Immersing the polymerized gels in deionized water is a necessary step so as to remove the components not being incorporated into the gel.

Moreover, if the polymerization process used TEMED, that TEMED also needs to be removed from the polymerized gel. The removal of TEMED, unbound polymer chains and unreacted monomers is achieved, as mentioned above, by simply immersing the polymerized gel is distilled and deionized water.

After washing the gel in distilled and deionized water, the gels are dried overnight at a temperature of 35° C. When the gels are completely dried, then the gels are inserted into molds identical to those in which they were initially formed. For instance, if the gels were prepared between glass plates in a protein electrophoresis gel casting unit (Mimi PROTEAN® 3 system from Bio-Rad for instance), then the dry gel would be again inserted in the gel casting unit. At this point, it is ready to be swollen in an acrylic acid solution that can be polymerized resulting in an interpenetrating network of PAAm and PAAc.

To prepare the acrylic acid solution the following steps are taken:

i) place the remaining 20 milliliters of distilled and deionized water into a scintillation vial and purge it with nitrogen gas for 15 to 20 minutes so as to remove all possible amounts of oxygen;

ii) add the 1.0 grams of acrylic acid into the scintillation vial, and stir extensively for 5 minutes or until all of the acrylic acid is completely dissolved;

iv) add the remaining 0.0266 grams of N,N′-methylenebisacrylamide to the scintillation vial and stir extensively for 5 minutes or until all the components in the scintillation vial are completely dissolved;

vi) add the remaining 0.004 grams of ammonium persulfate to the scintillation vial and stir extensively for 5 minutes or until all the components in the scintillation vial are completely dissolved;

vii) add the sodium hydroxide. The amount of sodium hydroxide added dictates the degree of ionization of the PAAc chains which in turn dictates the transition temperature of the gel. By increasing the degree of ioinization of the PAAc chains, the transition temperature is lowered. For instance, a degree of ionization of three percent by mole of the PAAc chains corresponds to a transition temperature of 17° C. whereas a six percent by mole ionization corresponds to 12° C. To prepare a gel with a degree of ionization of three percent by mole, the required amount of sodium hydroxide is 0.0167 grams whereas if a six percent by mole degree of ionization is required then 0.0334 grams are needed.

Once all the ingredients are combined, then the solution is added into the mold containing the dry PAAm gel. Next the ends of the glass molds are sealed, either by flame sealing or by putting epoxy at the ends. The reason for sealing the pre-gel mixture in the glass molds is to prevent the pre-gel mixture from coming in contact with air during the polymerization process. It is important to prevent the pre-gel mixture from coming into contact with oxygen in the air during the polymerization process, because oxygen retards and may even stop the polymerization reaction. This is the same reason that the distilled and deionized water is purged with nitrogen at the beginning of the manufacture of the gel.

The dry PAAm gel is allowed to swell completely in the acrylic acid solution. Typically, complete swelling of the PAAm in the acrylic acid solution is achieved in two days. In the final step in the preparation of the interpenetrating network of PAAm and PAAc, the sealed glass molds containing the PAAm gel swollen in an acrylic acid solution are immersed in a water bath at a temperature of 50° C. for at least one hour, but preferably the PAAm gel swollen in an acrylic acid solution is immersed in the 50° C. water bath for two hours. After this period of two hours, polymerization is complete, and the stimulus sensitive gel can be removed from the glass molds.

Once polymerization is complete, the polymerized gels are taken out from the glass molds by breaking the glass molds or by removing the glass plates if using a protein electrophoresis gel casting unit. Immersing the polymerized gels in deionized water is a necessary step so as to remove unreacted components because during the process of forming the stimulus sensitive gel, there is always the possibility that some acrylic acid and bisacrylamide do not incorporate into the polymer chains that form the stimulus sensitive gel. During the polymerization of the stimulus sensitive gel, there is always the possibility that some polymer chains are formed but which do not incorporate into the polymer chains that form the gel, and as such can be washed from the gel.

Performing all the above mentioned steps results in the fOrmation of interpenetrating networks of PAAm and PAAc or IPN-PAAm-PAAc for short.

As the present disclosure may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

We claim:

1. A stimulus indicating device that permanently indicates exposure to a predetermined stimulus comprising:
a single compartment device containing at least
a stimulus sensitive material contained in the single compartment; and
an indicator spot
wherein the stimulus sensitive material permanently changes from a first state to a second state upon exposure to a predetermined stimulus, so as to result in a permanent change in the ability to view the indicator spot due to the permanently changed stimulus sensitive material obstructing the indicator spot.

2. The stimulus indicating device that permanently indicates exposure to a predetermined stimulus as recited in claim 1, wherein the stimulus sensitive material is a metal.

3. The stimulus indicating device that permanently indicates exposure to a predetermined stimulus as recited in claim 1, wherein the stimulus sensitive material is a gel.

4. A stimulus indicating device that permanently indicates exposure to a predetermined stimulus comprising:
a single compartment device containing at least
a stimulus sensitive gel contained in the single compartment; and
an indicator spot;
wherein the stimulus sensitive gel permanently changes from a swollen state to a shrunken state upon exposure to a predetermined stimulus so as to result in a permanent change in the ability to view the indicator spot due to the shrunken stimulus sensitive gel concentrating over the indicator spot.

5. A stimulus indicating device that permanently indicates exposure to a predetermined stimulus comprising:
at least a first and a second compartment device containing at least
a stimulus sensitive gel contained in the first compartment;
an indicator spot located in the first compartment;
a membrane separating the first and second compartments; and
an absorbent material that permanently absorbs the expelled liquid or constituent parts
wherein the stimulus sensitive gel permanently changes from a swollen state to a shrunken state upon exposure to a predetermined stimulus so as to result in a permanent change in the ability to view the indicator spot due to the shrunken stimulus sensitive gel concentrating over the indicator spot and due to the absorption of the expelled liquid or constituent parts by the absorbent material.

6. A stimulus indicating device according to claim 5 wherein the membrane is semi-permeable.

7. A stimulus indicating device that permanently indicates exposure to a predetermined stimulus comprising:
at least a first and a second compartment device containing at least
a stimulus sensitive gel contained in the first compartment and the second compartment;
an indicator spot located in the second compartment;
a neck portion separating the first and second compartments;
wherein the stimulus sensitive gel permanently changes from a first state to a second state upon exposure to a predetermined stimulus and in doing so the majority of the shrunken stimulus sensitive gel permanently moves into the second compartment due to the neck portion trapping the majority of the shrunken stimulus sensitive gel in the second compartment, so that it at least partially obscures the indicator spot.
